(19) United States
(12) Patent Application Publication
(10) Pub. No.: US 2012/0070600 A1
(43) Pub. Date: Mar. 22, 2012

(54) METODS OF PREVENTING OXIDATION

(76) Inventors: Orhun K. Muratoglu, Cambridge, MA (US); Ebru Oral, Newton, MA (US)

(21) Appl. No.: 13/321,107

(22) PCT Filed: May 20, 2010
(86) PCT No.: PCT/US10/35567

§ 371 Date: Nov. 17, 2011

Related U.S. Application Data
(60) Provisional application No. 61/179,944, filed on May 20, 2009.

(51) Int. Cl. C08K 5/1545; B32B 1/08; B29C 35/08

(52) U.S. Cl. 428/36.92; 522/75; 264/496

(57) ABSTRACT

The present invention relates to methods for preventing oxidation of polymeric material. The invention discloses solutions for lipid- and/or cyclic deformation-initiated oxidation, methods of making oxidation and wear resistant polymeric materials, methods of preventing such oxidation and materials used therewith also are provided.

### FIELD OF THE INVENTION

The present invention relates to methods for preventing oxidation of polymeric material. The invention discloses solutions for lipid- and/or cyclic deformation-induced oxidation, methods of making wear and oxidation resistant polymeric materials, methods of preventing such oxidation and materials used therewith also are provided.

### BACKGROUND OF THE INVENTION

Polymeric material, such as ultra-high molecular weight polyethylene (UHMWPE) is the most widely used load bearing material for total hip arthroplasty (THA). The outcomes of THA, while very successful in the first decade of service, are compromised in the second decade of service primarily due to adhesive/abrasive wear of UHMWPE. It is known in the field that polyethylene wear generates particulate debris, eventually resulting in periprosthetic osteolysis, often resulting in massive bone loss or pathologic fracture and loosening of components, necessitating revision surgery.

Radiation crosslinking to a high degree increases the wear resistance of polymeric materials, such as ultra-high molecular weight polyethylene (UHMWPE). Irradiation also generates free radicals that are known pre-cursors of oxidative instability in UHMWPE implants (Collier, et al. J. Arthroplasty, 11(4): 377-389, 1996; Sutula, L. et al. Clin Orthop, (319): 28-40, 1995). Combining irradiation with a thermal treatment like melting or annealing used to quench the residual free radicals improves the oxidation resistance of irradiated UHMWPE (McKellop, et al. J Orthop Res, 17(2): 157-167, 1999; Muratoglu, et al. J Arthroplasty, 16(2): 149-160, 2001; Muratoglu, et al. Biomaterials, 20(16): 1463-1470, 1999). Increasing the radiation dose decreases the wear rate but compromises the mechanical properties (Bistolfi, et al. Transactions of the 51st Annual Meeting of the Orthopaedic Research Society: 240, 2005; Oral, et al. Biomaterials, 27: 917-925, 2006). Annealing is advantageous over melting because it results in better maintenance of the mechanical properties of the irradiated UHMWPE; however, annealing leaves behind residual free radicals, which have been shown to cause oxidation in vivo mostly at the rim of these components (Currier, et al. J Bone and Joint Surg, 89: 2023-2029, 2007; Kurtz, et al. Clin Orthop Relat Res, 453: 47-57, 2006; Wannomae, et al. Journal of Arthroplasty, 21(7): 1005-1011, 2006).

Highly crosslinked UHMWPE has become the most widely used articular surface option for the standard of care in total hip patients (Kelly, et al. Am J Orthop, 38(1): E1-4, 2009) and its use is increasing in total knees. There are a number of ongoing clinical trials comparing highly crosslinked UHMWPE acetabular liners to conventional UHMWPE liners (Bitsch, et al. J Bone Joint Surg Am, 90(7): 1487-91, 2008; Digas, et al. Acta Orthop, 78(6): 746-54, 2007; Engh Jr, et al. The Journal of Arthroplasty, 21(6-Supplement 2): 17-25, 2006; Rohrl, et al. Acta Orthop, 78(6): 739-45, 2007). These studies are showing favorable results with highly crosslinked liners at mid-term follow up periods up to five years (Digas, et al. Acta Orthop, 78(6): 746-54, 2007). The steady state penetration rate of the femoral head into acetabular liners of highly crosslinked UHMWPE, regardless of the method of fabrication, is markedly lower than that with conventional UHMWPE acetabular liners. The lower wear rates are holding true also for the irradiated and annealed liners that contain residual free radicals (Rohrl, et al. Acta Orthop, 78(6): 739-45, 2007).

A preliminary report at seven year follow-up showed an increase in the femoral head penetration rate with an irradiated and melted UHMWPE acetabular liner between years 5 and 7 (Karrholm, et al.: Five to seven years experience with highly crosslinked PE. In SICOT 2008. Hong Kong, August 2008). Therefore, there was a need to more closely analyze the surgically explanted highly crosslinked UHMWPEs that were fabricated by irradiation and thermal treatment to determine the potential cause for this abrupt increase in femoral head penetration. In this case, analysis of both irradiated and melted and irradiated and annealed UHMWPE implants revealed high levels of oxidation and reduction in crosslink density in all of these explants including the irradiated and melted ones. More interestingly, this degradation appears to have started after the irradiated and melted components were surgically explanted and exposed to air.

Costa et al. (Biomaterials, 22(4): 307-315, 2001) have shown that UHMWPE readily absorbs cholesterol, squalene, and esterified fatty acids (e.g. cholesteryl esters of hexadecanoic acid and octadecanoic acid) from the synovial fluid. Lipid peroxidation can be initiated by a reaction with reactive oxygen species, an enzymatic attack, or by elevated temperatures and progresses through a chain reaction (Bourgeois, C. F.: Antioxidant Vitamins and Health: Cardiovascular disease, Cancer, Cataracts and Aging. Edited, 310, Paris, BNB Publishing 2003). However, it was not known until the instant invention that lipids, when present in UHMWPE, could cause oxidation of the host polymer and also it was not known until the instant invention how the lipid peroxidation chain reaction can be prevented in the host polymer. It was also not known until the present invention that cyclic deformation could initiate oxidation, and how this oxidation could be prevented.

### SUMMARY OF THE INVENTION

The present invention relates to methods for preventing oxidation of polymeric materials. More specifically, the invention concerns lipid-initiated and/or cyclic deformation induced oxidation, and provides methods of preventing such oxidation, methods of making wear and oxidation resistant polymeric materials, and materials obtainable thereby, and materials used therewith.

In one embodiment, the invention provides methods of preventing lipid-initiated oxidation of polymeric material by providing an oxidation and wear resistant polymeric material, wherein the polymeric material is made by a process comprising the steps of: a) blending a polymeric material with an antioxidant; b) consolidating the polymeric blend; c) heating the consolidated polymeric blend to an elevated temperature that is above the room temperature and below the melting point of the polymeric material; and d) irradiating the heated consolidated polymeric blend with ionizing radiation at an elevated temperature that is below the melting point of the polymeric material, thereby providing an oxidation and wear resistant polymeric material that can resist lipid-initiated oxidation.

In another embodiment, the invention provides methods of preventing lipid-initiated oxidation of polymeric material by providing an oxidation and wear resistant polymeric material, wherein the polymeric material is made by a process comprising the steps of: a) heating a consolidated blend of polymeric materials containing one or more antioxidants to a temperature that is above the room temperature and below the melting point of the polymeric material; and b) irradiating the heated consolidated polymeric blend with ionizing radiation at an elevated temperature that is below the melting point of the polymeric material, thereby providing an oxidation and wear resistant polymeric material that can resist lipid-initiated oxidation.

In another embodiment, the invention provides methods of preventing lipid-initiated oxidation of polymeric material by providing an oxidation and wear resistant polymeric material, wherein the polymeric material is made by a process comprising the steps of: a) irradiating a consolidated polymeric material by ionizing radiation at an elevated temperature that is above the room temperature and below the melting point of the polymeric material; and b) doping the irradiated consolidated polymeric material with one or more antioxidants by diffusion, thereby providing an oxidation and wear resistant polymeric material that can resist lipid-initiated oxidation. In another embodiment, the consolidated polymeric material is a blend of polymeric material containing one or more antioxidants.

In another embodiment, the invention provides methods of preventing lipid-initiated oxidation of polymeric material by providing an oxidation and wear resistant polymeric material, wherein the polymeric material is made by a process comprising the steps of: a) irradiating a consolidated blend of polymeric materials containing one or more antioxidants by ionizing radiation at an elevated temperature that is above the room temperature and below the melting point of the polymeric material; b) heating a consolidated polymeric blend containing one or more antioxidants to an elevated temperature that is above the room temperature and below the melting point of the polymeric material; and c) annealing the heated consolidated polymeric blend at an elevated temperature that is below the melting point of the polymeric material, thereby providing an oxidation and wear resistant polymeric material that can resist lipid-initiated oxidation.

In another embodiment, the invention provides methods of preventing lipid-initiated oxidation of polymeric material by providing an oxidation and wear resistant polymeric material, wherein the polymeric material is made by a process comprising the steps of: a) irradiating a consolidated polymeric material by ionizing radiation at about room temperature; and b) doping the irradiated consolidated polymeric material with one or more antioxidants by diffusion, thereby providing an oxidation and wear resistant polymeric material that can resist lipid-initiated oxidation.

In another embodiment, the invention provides methods of preventing lipid-initiated oxidation of polymeric material by providing an oxidation and wear resistant polymeric material, wherein the polymeric material is made by a process comprising the steps of: a) irradiating a consolidated blend of polymeric materials containing one or more antioxidants by ionizing radiation at about room temperature; b) heating a consolidated polymeric blend containing one or more antioxidants to an elevated temperature that is above the room temperature and below the melting point of the polymeric material; and c) annealing the heated consolidated polymeric blend at an elevated temperature that is below the melting point of the polymeric material, thereby providing an oxidation and wear resistant polymeric material that can resist lipid-initiated oxidation.

In another embodiment, the invention provides methods of preventing lipid-initiated oxidation of polymeric material by providing an oxidation and wear resistant polymeric material, wherein the polymeric material is made by a process comprising the steps of: a) irradiating a consolidated blend of polymeric materials containing one or more antioxidants by ionizing radiation at about room temperature; b) mechanical annealing the consolidated polymeric blend at an elevated temperature that is below the melting point of the polymeric material, thereby forming a mechanically deformed consolidated polymeric blend; and c) annealing the mechanically deformed consolidated polymeric blend at a temperature that is above or below the melting point of the polymeric material, thereby providing an oxidation and wear resistant polymeric material that can resist lipid-initiated oxidation.

In another embodiment, the invention provides methods of preventing lipid-initiated oxidation of polymeric material by providing an oxidation and wear resistant polymeric material, wherein the polymeric material is made by a process comprising the steps of: a) irradiating a consolidated blend of polymeric materials containing one or more antioxidants by ionizing radiation at above the room temperature and below the melting point; b) mechanical annealing the consolidated polymeric blend at an elevated temperature that is below the melting point of the polymeric material, thereby forming a mechanically deformed consolidated polymeric blend; and c) annealing the mechanically deformed consolidated polymeric blend at a temperature that is above or below the melting point of the polymeric material, thereby providing an oxidation and wear resistant polymeric material that can resist lipid-initiated oxidation.

In another embodiment, the invention provides methods of preventing oxidation initiated by cyclic deformation of polymeric material by providing an oxidation and wear resistant polymeric material, wherein the polymeric material is made by a process comprising the steps of: a) blending a polymeric material with an antioxidant; b) consolidating the polymeric blend; c) heating the consolidated polymeric blend to an elevated temperature that is above the room temperature and below the melting point of the polymeric material; and d) irradiating the heated consolidated polymeric blend with ionizing radiation at an elevated temperature that is below the melting point of the polymeric material, thereby providing an oxidation and wear resistant polymeric material that can resist oxidation due to, caused by, induced by or initiated by cyclic deformation of the polymeric material.

In another embodiment, the invention provides methods of preventing oxidation initiated by cyclic deformation of polymeric material by providing an oxidation and wear resistant polymeric material, wherein the polymeric material is made by a process comprising the steps of: a) heating a consolidated blend of polymeric materials containing one or more antioxidants to a temperature that is above the room temperature and below the melting point of the polymeric material; and b) irradiating the heated consolidated polymeric blend with ionizing radiation at an elevated temperature that is below the melting point of the polymeric material, thereby providing an oxidation and wear resistant polymeric material that can resist oxidation due to, caused by, induced by or initiated by cyclic deformation of the polymeric material.

In another embodiment, the invention provides methods of preventing oxidation initiated by cyclic deformation of polymeric material by providing an oxidation and wear resistant polymeric material, wherein the polymeric material is made by a process comprising the steps of: a) irradiating a consolidated polymeric material by ionizing radiation at an elevated temperature that is above the room temperature and below the melting point of the polymeric material; and b) doping the irradiated consolidated polymeric material with one or more antioxidants by diffusion, thereby providing an oxidation and wear resistant polymeric material that can resist oxidation due to, caused by, induced by or initiated by cyclic deformation of the polymeric material.

In another embodiment, the invention provides methods of preventing oxidation initiated by cyclic deformation of polymeric material by providing an oxidation and wear resistant polymeric material, wherein the polymeric material is made by a process comprising the steps of: a) irradiating a consolidated blend of polymeric materials containing one or more antioxidants by ionizing radiation at an elevated temperature that is above the room temperature and below the melting point of the polymeric material; b) heating a consolidated polymeric blend containing one or more antioxidants to an elevated temperature that is above the room temperature and below the melting point of the polymeric material; and c) annealing the heated consolidated polymeric blend at an elevated temperature that is below the melting point of the polymeric material, thereby providing an oxidation and wear resistant polymeric material that can resist oxidation due to, caused by, induced by or initiated by cyclic deformation of the polymeric material.

In another embodiment, the invention provides methods of preventing oxidation initiated by cyclic deformation of polymeric material by providing an oxidation and wear resistant polymeric material, wherein the polymeric material is made by a process comprising the steps of: a) irradiating a consolidated polymeric material by ionizing radiation at about room temperature; and b) doping the irradiated consolidated polymeric material with one or more antioxidants by diffusion, thereby providing an oxidation and wear resistant polymeric material that can resist oxidation due to, caused by, induced by or initiated by cyclic deformation of the polymeric material.

In another embodiment, the invention provides methods of preventing oxidation initiated by cyclic deformation of polymeric material by providing an oxidation and wear resistant polymeric material, wherein the polymeric material is made by a process comprising the steps of: a) irradiating a consolidated blend of polymeric materials containing one or more antioxidants by ionizing radiation at about room temperature; b) heating a consolidated polymeric blend containing one or more antioxidants to an elevated temperature that is above the room temperature and below the melting point of the polymeric material; and c) annealing the heated consolidated polymeric blend at an elevated temperature that is below the melting point of the polymeric material, thereby providing an oxidation and wear resistant polymeric material that can resist oxidation due to, caused by, induced by or initiated by cyclic deformation of the polymeric material.

In another embodiment, the invention provides methods of preventing oxidation initiated by cyclic deformation of polymeric material by providing an oxidation and wear resistant polymeric material, wherein the polymeric material is made by a process comprising the steps of: a) irradiating a consolidated blend of polymeric materials containing one or more antioxidants by ionizing radiation at about room temperature; and b) mechanically annealing the consolidated polymeric blend, thereby providing an oxidation and wear resistant polymeric material that can resist oxidation due to, caused by, induced by or initiated by cyclic deformation of the polymeric material. According to one embodiment, the mechanical annealing of the consolidated polymeric blend is carried out at an elevated temperature that is below the melting point of the polymeric material.

In another embodiment, the invention provides methods of preventing oxidation initiated by cyclic deformation of polymeric material by providing an oxidation and wear resistant polymeric material, wherein the polymeric material is made by a process comprising the steps of: a) irradiating a consolidated blend of polymeric materials containing one or more antioxidants by ionizing radiation at about room temperature; b) mechanical annealing the consolidated polymeric blend at an elevated temperature that is below the melting point of the polymeric material, thereby forming a mechanically deformed consolidated polymeric blend; and c) annealing the mechanically deformed consolidated polymeric blend at a temperature that is above or below the melting point of the polymeric material, thereby providing an oxidation and wear resistant polymeric material that can resist oxidation due to, caused by, induced by or initiated by cyclic deformation of the polymeric material.

In another embodiment, the invention provides methods of preventing oxidation initiated by cyclic deformation of polymeric material by providing an oxidation and wear resistant polymeric material, wherein the polymeric material is made by a process comprising the steps of: a) irradiating a consolidated blend of polymeric materials containing one or more antioxidants by ionizing radiation at above room temperature and below melting point; b) mechanical annealing the consolidated polymeric blend at an elevated temperature that is below the melting point of the polymeric material, thereby forming a mechanically deformed consolidated polymeric blend; and c) annealing the mechanically deformed consolidated polymeric blend at a temperature that is above or below the melting point of the polymeric material, thereby providing an oxidation and wear resistant polymeric material that can resist oxidation due to, caused by, induced by or initiated by cyclic deformation of the polymeric material.

According to one aspect of the invention, the heating is continued for at least one minute, 10 minutes, 20 minutes, 30 minutes, one hour, two hours, five hours, ten hours, 24 hours, or more. According to another aspect of the invention, the heating is carried out in an inert or sensitizing environment.

According to one embodiment of the invention, the polymeric blend is heated to a temperature between about 20° C. and about 135° C. According to another embodiment of the invention, the polymeric blend is heated to a temperature above the melting point of the polymeric material, annealed and homogenized.

According to another embodiment of the invention, the polymeric material is compression molded to a second surface, thereby making an interlocked hybrid material.

According to one embodiment of the invention, the doping is carried out by soaking the medical implant in the antioxidant for about 0.1 hours to about 72 hours. In another embodiment of the invention, the antioxidant is vitamin E. Yet in another embodiment of the invention, the antioxidant is α-tocopherol. In another embodiment, the polymeric material is soaked in a solution of an antioxidant in another solvent or a mixture of solvents. Such solvents include, but not limited to, a hydrophobic solvent, such as hexane, heptane, or a longer chain alkane; an alcohol such as ethanol, any member of the propanol or butanol family or a longer chain alcohol; or an aqueous solution in which an antioxidant, such as vitamin E is soluble. Such a solvent also can be made by using an emulsifying agent such as Tween 80 and/or ethanol. The solution concentration can be 0.01 wt %, 1 wt %, 10 wt %, 50 wt %, 80 wt %.

According to one embodiment of the invention, the polymeric material is selected from a group consisting of a low-density polyethylene, high-density polyethylene, linear low-density polyethylene, ultra-high molecular weight polyethylene (UHMWPE), or a mixture thereof. In another embodiment, the polymeric material is polymeric resin powder, polymeric flakes, polymeric particles, or the like, or a mixture thereof.

According to one embodiment of the invention, the irradiation is carried out in an atmosphere containing between about 1% and about 22% oxygen. In another embodiment, the irradiation is carried out in an inert atmosphere, and wherein the atmosphere contains gases selected from the group consisting of nitrogen, argon, helium, neon, or the like, and a combination thereof.

According to another embodiment of the invention, the radiation dose is between about 25 and about 1000 kGy, for example, the radiation dose is about 65 kGy, about 75 kGy, about 100 kGy, about 125, about 150, or about 200 kGy.

According to one embodiment of the invention, the polymeric material is cross-linked by gamma irradiation or electron beam irradiation.

According to another embodiment of the invention, the polymeric blend is irradiated at a temperature between about 20° C. and about 135° C.

According to another embodiment of the invention, the consolidated polymeric blend is heated to a temperature between about 20° C. and about 135° C. before or after irradiation.

According to another embodiment of the invention, free radicals in the cross-linked polymeric material is reduced by heating the polymeric material in contact with a non-oxidizing medium, for example, an inert gas, wherein the non-oxidizing medium is an inert fluid.

According to another embodiment of the invention, reduction of free radicals in the cross-linked polymeric material is achieved by heating the polymeric material in contact with a non-oxidizing medium, wherein the non-oxidizing medium is an inert gas, an inert fluid, or a polyunsaturated hydrocarbon selected from the group consisting of acetylenic hydrocarbons such as acetylene; conjugated or unconjugated olefinic hydrocarbons such as butadiene and (meth)acrylate monomers; and sulphur monochloride with chloro-tri-fluoroethylene (CTFE) or acetylene.

According to another embodiment of the invention, the polymeric material is irradiated at a temperature of about 40° C., about 75° C., about 100° C., about 110° C., about 120° C., about 130° C., or about 135° C.

According to another embodiment of the invention, the polymeric material is irradiated at a temperature that is above the melting point of the polymeric material, for example, about 140° C., about 150° C., about 175° C., about 2000° C., about 250° C., about 300° C., or about 400° C. or more.

According to one aspect, the invention provides a medical device comprising an oxidation and wear resistant polymeric material, wherein the polymeric material is not susceptible to lipid-initiated oxidation.

According to another aspect, the invention provides a medical device comprising an oxidation and wear resistant polymeric material, wherein the polymeric material is not susceptible to oxidation due to, caused by, induced by or initiated by cyclic deformation of the polymeric material.

According to one embodiment of the invention, the medical device is selected from the group consisting of acetabular liner, shoulder glenoid, patellar component, finger joint component, ankle joint component, elbow joint component, wrist joint component, toe joint component, bipolar hip replacements, tibial knee insert, tibial knee inserts with reinforcing metallic and polymeric posts, intervertebral discs, interpositional devices for any joint, sutures, tendons, heart valves, stents, and vascular grafts.

According to another embodiment of the invention, the medical device is a non-permanent medical device, wherein the non-permanent medical device is selected from the group consisting of a catheter, a balloon catheter, a tubing, an intravenous tubing, and a suture.

According to another embodiment of the invention, the medical device is packaged and sterilized by ionizing radiation or gas sterilization, thereby forming a sterile, highly cross-linked, oxidatively stable, and highly crystalline medical device.

According to one aspect of the invention, the doping is carried out by soaking the medical implant in the antioxidant, preferably, for about half an hour to about 100 hours or more, more preferably, for about an hour, about 2, 3, 4, 5, 6, 7, 8, 9, 10, 11, 12, 13, 14, 15, or about 16 hours, and/or the antioxidant is heated to about 120° C. and the doping is carried out at about 120° C., and/or the antioxidant is warmed to about room temperature and the doping is carried out at room temperature or at a temperature between room temperature and the peak melting temperature of the polymeric material or less than about 137° C., and/or the cross-linked polymeric material is heated at a temperature below the melt of the cross-linked polymeric material. Depending upon the polymeric material selected, heat treatment, homogenization and other temperatures are determined in view of melting temperatures of the selected polymeric material.

According to another aspect of the invention, the doping is carried out by soaking the medical implant in the antioxidant, preferably, for about half an hour to about 100 hours or more, more preferably, for about an hour, about 2, 3, 4, 5, 6, 7, 8, 9, 10, 11, 12, 13, 14, 15, or about 16 hours, and/or the doping is carried out at a temperature below the melting point of the polymeric material.

According to one aspect of the invention, homogenization of the antioxidant(s) is carried out after doping by annealing the medical implant, preferably, for about half an hour to about 200 hours or more, more preferably, for about 24, 48 or about 72 hours, and the homogenization is carried out at room temperature or at a temperature between room temperature and the peak melting temperature of the polymeric material, typically less than about 137° C., and/or the cross-linked polymeric material is heated at a temperature below the melt of the cross-linked polymeric material.

According to another aspect of the invention, doping is followed by homogenization by annealing the antioxidant-doped consolidated polymeric material at an elevated temperature below or above the melting point of the polymeric material.

According to another aspect of the invention, the oxidation index of the oxidation resistant polymeric material is less than 0.1 after doping with squalene at 120° C. for 2 hours, then subsequently accelerated aging at 5 atm of oxygen at 70° C. for 6 days and then extracting 150 micron-thick sections of the material by boiling hexane for at least 16 hours.

According to another aspect of the invention, the polymeric material is a polypropylene, a polyamide, a polyether ketone, or a mixture thereof, preferably the polyolefin is selected from a group consisting of a low-density polyethylene, high-density polyethylene, linear low-density polyethylene, ultra-high molecular weight polyethylene (UHMWPE), or a mixture thereof; and wherein the polymeric material is polymeric resin, including powder, flakes, particles, or the like, or a mixture thereof or a consolidated resin.

Unless otherwise defined, all technical and scientific terms used herein in their various grammatical forms have the same meaning as commonly understood by one of ordinary skill in the art to which this invention belongs. Although methods and materials similar to those described herein can be used in the practice or testing of the present invention, the preferred methods and materials are described below. In case of conflict, the present specification, including definitions, will control. In addition, the materials, methods, and examples are illustrative only and are not limiting.

Further features, objects, and advantages of the present invention are apparent in the claims and the detailed description that follows. It should be understood, however, that the detailed description and the specific examples, while indicating preferred aspects of the invention, are given by way of illustration only, since various changes and modifications within the spirit and scope of the invention will become apparent to those skilled in the art from this detailed description.

These and other aspects of the invention will become apparent to the skilled artisan in view of the teachings contained herein.

The invention is further disclosed and exemplified by reference to the text and drawings that follow.

### BRIEF DESCRIPTION OF THE DRAWINGS

FIG. 1. Schematic showing the regions of the cups that were analyzed by FTIR, crosslink density measurements, and DSC.

FIG. 2. Oxidation profiles after hexane extraction at the rim and articular surface of two representative explants that were stored ex vivo for (FIG. 2A) a short duration of 15 and 13 months for rim and articular surface analyses, respectively (H-07-041); and (FIG. 2B) a long duration of 58 months for the analysis of both rim and articular surfaces (H-03-066). Note the y-scales are not the same.

FIG. 3. Maximum oxidation at the articular surface of the studied explants as a function of in vivo duration.

FIG. 4. Maximum oxidation index measured at the articular surface as a function of ex vivo duration. The linear regression is with all of the data points included here.

FIG. 5. Maximum oxidation index measured near the rim surface as a function of ex vivo duration. The linear regression is with all of the data points included here.

FIG. 6. Average oxidation index measured in the subsurface Regions 2 (a), 3 (b), and 6(c) as a function of ex vivo duration. The linear regression shown is with all of the data points included here.

FIG. 7. Average oxidation index measured near the backside surface (Region 4) as a function of ex vivo duration. The linear regression is with all of the data points included here.

FIG. 8. Average crosslink density measured at the articular surface as a function of ex vivo duration. The linear regression is with all of the data points include here.

FIG. 9. Average crosslink density measured at the rim surface as a function of ex vivo duration. The linear regression is with all of the data points include here.

FIG. 10. Average crosslink density as a function of average oxidation index measured in all 6 regions of each explanted component.

FIG. 11. (FIG. 11A) FTIR absorbance spectra of 100-kGy irradiated and melted UHMWPE cubes doped with squalene as a function of depth way from the surface; and (FIG. 11B) Squalene concentration profiles as a function of depth.

FIG. 12. Post-hexane extraction oxidation profiles of 100-kGy irradiated and melted UHMWPE cubes after squalene doping and accelerated aging as a function of aging time.

FIG. 13. Cross-link density as a function of oxidation index of 100-kGy irradiated and melted UHMWPE after squalene doping and accelerated aging.

FIG. 14. Oxidation profiles of 0.1 wt % vitamin E-blended, 150 kGy cold irradiated UHMWPE, 0.1 wt %, 150 kGy cold irradiated and melted UHMWPE, 100-kGy irradiated and melted UHMWPE and 100-kGy irradiated, vitamin E-diffused, gamma sterilized UHMWPE after squalene doping and accelerated aging.

FIG. 15. Oxidation profiles of 0.1 wt % vitamin E-blended, 150 kGy cold irradiated UHMWPE, 0.1 wt % vitamin E-blended, 150 kGy warm irradiated UHMWPE, 0.2 wt % vitamin E-blended, 150 kGy cold irradiated UHMWPE, 0.2 wt % vitamin E-blended, 150 kGy warm irradiated UHMWPE after squalene doping and accelerated aging.

FIG. 16. Oxidation profiles of 0.2 wt % vitamin E-blended, 150 kGy cold irradiated UHMWPE, 0.2 wt % vitamin E-blended, 150 kGy warm irradiated UHMWPE, 0.2 wt % vitamin E-blended, 200 kGy warm irradiated UHMWPE after squalene doping and accelerated aging.

FIG. 17. Oxidation profiles of 0.1 wt % vitamin E-blended, 150 kGy cold irradiated UHMWPE, 0.2 wt % vitamin E-blended, 150 kGy cold irradiated UHMWPE, 0.3 wt % vitamin E-blended, 150 kGy cold irradiated UHMWPE and 0.5 wt % vitamin E-blended, 150 kGy cold irradiated UHMWPE after squalene doping and accelerated aging.

FIG. 18. Oxidation profiles of virgin, 0.1 wt % vitamin E-blended and 0.2 wt % vitamin E-blended UHMWPE after squalene doping and aging.

FIG. 19. Oxidation profiles of 0.1 wt % vitamin E-blended/150 kGy cold irradiated UHMWPE and 0.1 wt % vitamin E-blended/150 kGy cold irradiated/mechanically deformed/annealed UHMWPE after squalene doping and aging

FIG. 20. A cyclic deformation sample (FIG. 20A) and cyclic deformation setup (FIG. 20B). Please note that the control samples were aged at the bottom of the same chamber without loading.

FIG. 21. Oxidation profiles of cyclically deformed (5 million cycles under 10 MPa) and aged irradiated and melted UHMWPEs. The profiles of non-loaded aged controls are also shown.

FIG. 22. Oxidation profiles of cyclically deformed (5 million cycles under 10 MPa) and aged 0.1 wt % vitamin E-blended/150 kGy cold irradiated UHMWPE, 0.1 wt % vitamin E-blended/150 kGy warm irradiated UHMWPE and 100-kGy irradiated/vitamin E-diffused/gamma sterilized UHMWPE.

FIG. 23. The oxidation index as a function of depth away from the surface for (FIG. 23A) 100-kGy irradiated, vitamin E diffused UHMWPE; and (FIG. 23B) 0.1 wt % vitamin E-blended, 120-kGy irradiated UHMWPE after squalene doping and accelerated aging at 70° C. at 5 atm. of oxygen at different durations up to 44 days.

### DETAILED DESCRIPTION OF THE INVENTION

Provided herein are findings related to the mechanisms and the initiating causes by which the highly crosslinked polymeric materials are oxidized and de-crosslinked. The invention pertains to methods of preventing lipid- and/or cyclic deformation-initiated oxidation of the polymeric material, methods of making oxidation and wear resistant polymeric materials, and materials obtainable thereby and used therewith also are provided.

This invention provides uses of antioxidants, such as vitamin-E, to increase oxidation resistance of radiation cross-linked polymeric materials. Also, the invention provides various methods of irradiation, diffusion of antioxidants, heating, annealing and/or mechanical annealing of the radiation cross-linked polymeric material, that delays and/or prevents lipid- and/or cyclic deformation-initiated oxidation of the polymeric material, such as ultrahigh molecular weight polyethylene (UHMWPE).

Forty-seven radiation crosslinked acetabular liners (41 melted and 6 annealed) were surgically retrieved after revision surgeries. Oxidation level at the rim was determined after explantation. After shelf storage in air for 5-77 months, oxidation levels, crosslink density and thermal properties were determined at the rim and also the articular surface. An additional component (92 months of in vivo service) was subjected to hip simulator testing immediately after explantation and subsequently its oxidation state and crosslink density were determined. At explantation, all components showed minimal oxidation; however, oxidation levels increased during shelf storage with concomitant decrease in crosslink density and an increase in crystallinity. Increasing oxidation, increasing crystallinity and decreasing crosslink density correlated with the duration of ex vivo shelf storage. The component subjected to hip simulator testing showed no measurable wear and showed no detectable oxidation or marked decrease in crosslink density. Oxidation and loss of crosslink density was observed in highly crosslinked UHMWPE explants. The deterioration only occurred after the components were surgically removed during ex vivo storage in air. Two mechanisms of increased oxidation and related decrease in crosslink density are postulated and further investigated.

Explants: Forty seven highly crosslinked acetabular liners that were retrieved at revision surgery were analyzed. The explants were soaked in 100% ethanol for at least 16 hours and then cleaned with water prior to storage and/or analysis. The reason for removal and in vivo duration of each explant are listed in Table 1. The reason for removal for six of the components and the in vivo duration of two of the components were not known; the rest are listed in Table 1. Thirty four of these were Longevity (Zimmer, Warsaw, Ind.), three were Durasul (Zimmer, Warsaw, Ind.), one was Marathon (Depuy, Warsaw, Ind.), three were XLPE (Smith & Nephew, Memphis, Tenn.), three were X3 (Stryker, Mahwah, N.J.), and three were Crossfire (Stryker, Mahwah, N.J.). The following are the manufacturing methods of each explant type according to their respective manufacturers:

Longevity from Zimmer (Warsaw, Ind.) is UHMWPE that was 100 kGy e-beam irradiated at 40° C., melted, machined, and gas plasma sterilized. Durasul from Zimmer (Warsaw, Ind.) is UHMWPE that was 95 kGy e-beam irradiated at 120° C., melted, machined, and ethylene oxide sterilized. XLPE from Smith and Nephew (Memphis, Tenn.) is UHMWPE that was 100 kGy gamma irradiated, melted, machined, and ethylene oxide sterilized. Marathon from Depuy (Warsaw, Ind.) is UHMWPE that was 50 kGy gamma irradiated, melted, machined, and gas plasma sterilized. X3 from Stryker is UHMWPE that was sequentially irradiated three times with gamma to about 33 kGy with an annealing step after each irradiation step, machined, and gas plasma sterilized. Crossfire from Stryker is UHMWPE that was 75 kGy gamma irradiated, annealed below the melting point, machined, and gamma sterilized in inert gas.

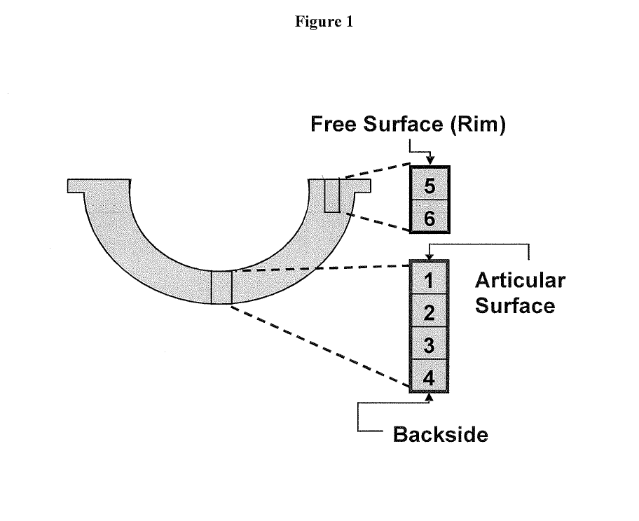

All 47 explants were analyzed using infra-red spectroscopy at the rim region for oxidation after less than two months of ex vivo storage. They were then stored in air and analyzed after varying ex vivo durations for oxidation, crosslink density, and thermal properties at the load bearing articular surfaces and the rim regions (FIG. 1).

In addition to the 47 explants, one Durasul acetabular liner that was recently explanted due to multiple dislocations with the longest in vivo duration (92 months) of the series presented here was tested on a Boston Hip Simulator along with a fresh Durasul acetabular liner as control. The components were subjected to simulated gait at a rate of 1 Hz to a total of five million cycles in 100% bovine serum stabilized with 10.7 millimoles of ethylenediamine tetraacetate and 33 mL of penicillin-streptomycin solution per 500 mL of serum. The kinematics used was a standard walking gait cycle with the peak load of 3000N. The simulator was interrupted 10 times in 500,000 cycle intervals for gravimetric assessment of wear per ISO 14242-2. The liners were cleaned and subsequently weighed using a balance (Mettler-Toledo XP205DR, Columbus Ohio) with a 0.01 mg resolution, and a linear wear rate was calculated using linear regression between 0.5×10⁶ and 5×10⁶ cycles. The articular surfaces were photographed at the dome and at 4 quadrants at about 3 to 4 mm from the dome using a Zeiss Stereo Discovery v8 optical microscope and a Zeiss AxioCam ICc1 camera at every gravimetric measurement. The explant was subsequently characterized to determine the level of oxidation and changes in crosslink density with the same protocols as applied to the other explanted components.

Infra-red Spectroscopy: Sections of each liner in the articular region and near the rim were removed and microtomed (LKG Sledge; Sweden) into 150 μm thin films. The thin films were then refluxed in boiling hexanes for 16 hours to extract absorbed esterified fatty acids and other lipids (see James, et al., Biomaterials, 14(9): 643-7, 1993). Following this extraction step, the sections were dried in vacuum for at least 3 hours. The thin films were then analyzed using Fourier Transform Infrared spectroscopy (FTIR, Bio-Rad FTS2000, Natick Mass.) as a function of depth across the entire cross-section of the liner in the articular region; FTIR was also done at the rim, which was a non-articulating surface in the component. Oxidation index values were calculated by normalizing the carbonyl absorbance over 1680 cm⁻¹-1780 cm⁻¹ to the internal reference absorbance over 1370 cm⁻¹-1390 cm⁻¹, after subtracting the corresponding baselines. The maximum oxidation index at Region 1 (articular surface) and the average oxidation index values are reported in six distinct regions in each explanted component (FIG. 1). The initial FTIR analysis was performed after less than two months of ex vivo storage only in the rim regions. After the long-term ex vivo storage the components were microtomed and FTIR analysis was performed at the rim and articular regions as outlined in FIG. 1.

Crosslink Density Determination: Cubic samples were cut from six distinct regions of each explanted acetabular liner (FIG. 1). Each sample was weighed on a balance with a resolution of 0.01 mg (Mettler-Toledo XP205DR, Columbus Ohio) and then immersed in 25 mL of xylene at 130° C. for 2 hours. After two hours, the sample was removed from the xylene, blotted dry, and sealed in a glass jar with a rubber septum in the cap to prevent loss of absorbed xylene. The final weight of the sample was calculated by weighing the sample and the jar together and subtracting out the weight of just the glass jar and cap, which had been weighed previously. The weight of the absorbed xylene was calculated by subtracting the final weight of the sample from its initial weight; the volumes of the absorbed xylene and the initial cube of polyethylene were calculated assuming densities of 0.99 g/cm³ for UHMWPE at room temperature and 0.75 g/cm³ for xylene at 130° C. The swell ratio of each sample was calculated and used to calculate the crosslink density using the equations provided in ASTM F2214. The crosslink density measurements were performed only after the long-term ex vivo storage at the six distinct regions as outlined in FIG. 1.

Differential Scanning calorimetry (DSC): Samples were cut from six distinct regions of each explanted acetabular liner (FIG. 1) and analyzed via Differential Scanning calorimetry (DSC, TA Instruments Q1000, New Castle Del.). The samples were subjected to a standard heat/cool/heat cycle between −20° C. and 180° C. with a ramp rate of 10° C./minute. The peak melting/recrystallization point was recorded, and the crystallinity was quantified by integrating the thermogram from 20° C. to 160° C. and assuming a melting enthalpy of 291 J/g for 100% crystalline UHMWPE. The DSC measurements were performed only after the long-term ex vivo storage.

Statistical Analysis: Pearson correlation coefficients (r) and linear regression were used to determine the relationships between in vivo and ex vivo duration and oxidation and crosslink density measurements. A repeated measures mixed model approach was used to account for the multiple regions from the same UHMWPEs. Regression equations of the form y=mx+b were used to describe linear fit to the data with x denoting duration in months, m the slope of the fitted line, and b the y-intercept. Statistical analysis was performed using the SPSS software package (version 17.0, SPSS Inc., Chicago, Ill.). Two-tailed values of p<0.05 were considered statistically significant.

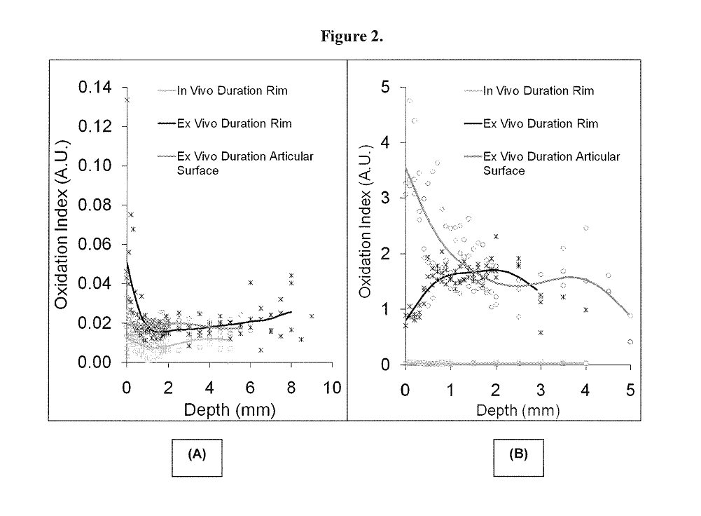

The infrared analysis of all of the 47 explants after surgical removal showed minimal oxidation at the rim regions (Table 1). The same explants when analyzed after ex vivo storage showed increased levels of oxidation at the rim; and their articular surfaces also showed oxidation after ex vivo storage (Table 2). Representative oxidation profiles for two of the liners (H-07-041 with lower oxidation and H-03-066 with higher oxidation) are shown in FIG. 2.

TABLE 1
Reason for removal and in vivo duration of the explanted liners.

| | | | In vivo |
|---|---|---|---|
| Sample ID | Reason for Revision | Type | duration (mos.) |
| H-07-020 | Acetabular loosening, dislocation | Longevity | 0.5 |
| H-04-005 | Acetabular loosening, femoral | Longevity | 1 |
| | loosening | | |
| H-05-046 | Femoral loosening, dislocation | Longevity | 1 |
| H-05-047 | Femoral loosening, dislocation | Longevity | 1 |
| H-06-050 | Sepsis | Longevity | 1 |
| H-03-066 | Sepsis | Longevity | 2 |
| H-05-009 | Dislocation | Longevity | 3 |
| H-05-033 | Acetabular loosening | Longevity | 5 |
| H-07-032 | Acetabular loosening | Longevity | 6 |
| H-05-006 | Dislocation | Longevity | 8 |
| H-07-005 | Pain | Longevity | 11 |
| H-06-001 | Hematoma, wound dehiscence | Longevity | 13 |
| H-07-004 | Sepsis | Longevity | 14 |
| H-07-024 | Fracture of femoral neck | Longevity | 14 |
| H-05-054 | N/A | Longevity | 17 |
| H-07-041 | Acetabular loosening | Longevity | 17 |
| H-02-084 | Sepsis | Longevity | 20 |
| H-02-071 | Sepsis | Longevity | 24 |
| H-04-009 | Dislocation | Longevity | 24 |
| H-04-028 | Liner fracture, femoral loosening | Longevity | 24 |
| H-04-017 | N/A | Longevity | 26 |
| H-04-055 | Dislocation | Longevity | 32 |
| H-07-022 | Sepsis | Longevity | 34 |
| H-07-040 | Femoral loosening | Longevity | 39 |
| H-07-049 | Femoral loosening | Longevity | 41 |
| H-07-006 | Troch bursitis | Longevity | 43 |
| H-05-061 | Sepsis | Longevity | 45 |
| H-06-028 | Dislocation | Longevity | 45 |
| H-05-045 | Sepsis | Longevity | 48 |
| H-06-054 | Femoral loosening | Longevity | 51 |
| H-07-037 | Femoral loosening | Longevity | 51 |
| H-07-008 | Dislocation | Longevity | 54 |
| H-05-027 | N/A | Longevity | 66 |
| H-06-037 | Femoral loosening | Longevity | 84 |
| H-02-042 | Sepsis | Durasul | N/A |
| H-03-036 | N/A | Durasul | N/A |
| H-05-067 | Sepsis | Durasul | 76 |
| H-05-055 | Acetabular loosening | Crossfire | 10 |
| H-06-040 | N/A | Crossfire | 12 |
| H-07-052 | Acetabular loosening | Crossfire | 24 |
| H-07-015 | Sepsis | X3 | 1.5 |
| H-06-019 | N/A | X3 | 5 |
| H-07-048 | Acetabular loosening | X3 | 5 |
| H-05-066 | Distal erythema | XLPE | 1 |
| H-08-001 | Sepsis | XLPE | 10 |
| H-06-044 | Femoral loosening | XLPE | 12 |
| H-06-018 | Liner rim fracture | Marathon | 25 |

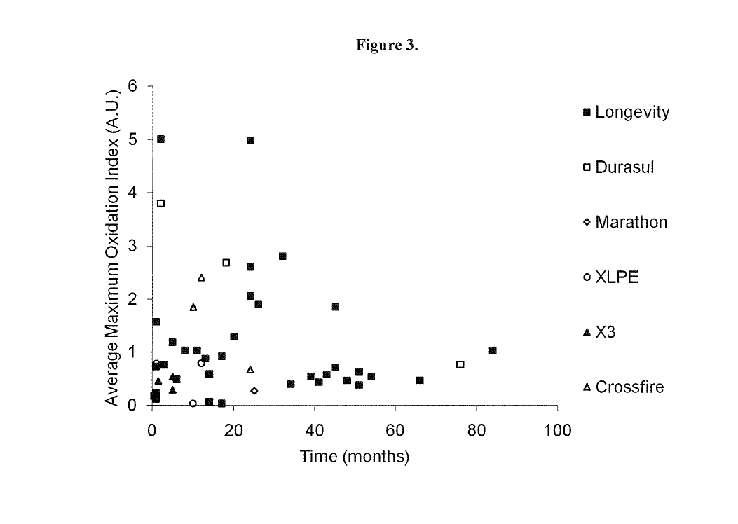

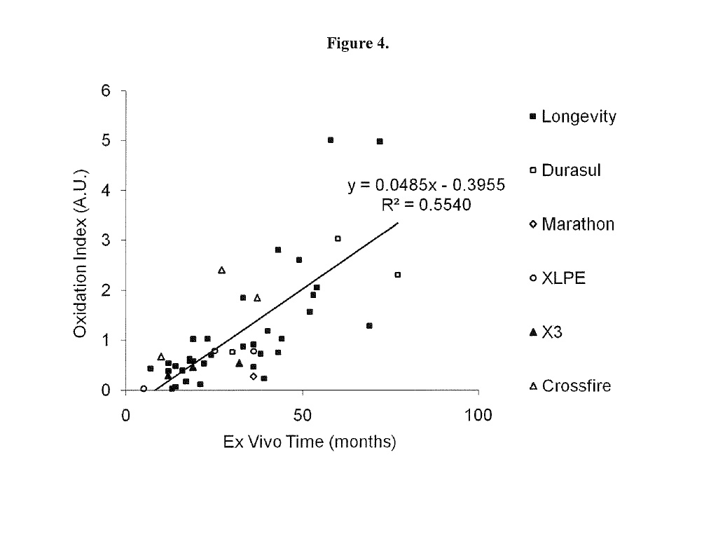

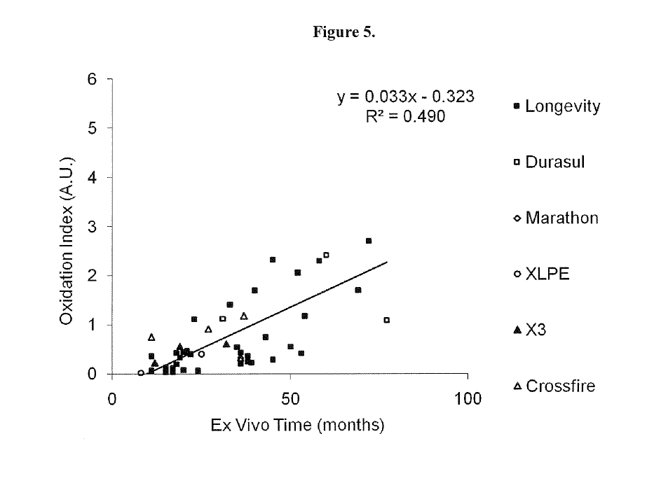

The maximum oxidation level measured at the articular surfaces did not correlate with in vivo duration (FIG. 3). In contrast, there was a significant positive linear correlation between surface oxidation at articular surfaces and ex vivo duration (FIG. 4). Pearson linear correlations were: r=0.67 in Region 1, r=0.63 in Region 2, r=0.58 in Region 3, and r=0.55 in Region 4 (all p<0.001). Similarly, the maximum oxidation level measured at the rim surfaces did not correlate significantly with in vivo duration (r=−0.12, p=0.45 in Region 5; r=−0.26, p=0.08 in Region 6), although showed a significant positive linear correlation with ex vivo duration (r=0.41, p=0.002 in region 5; r=0.65, p<0.001 in region 6; FIG. 5). The slope of the linear regression for maximum surface oxidation vs. ex vivo duration were not statistically different at the articular surface and at the rim surface (p=0.32; FIGS. 4-5).

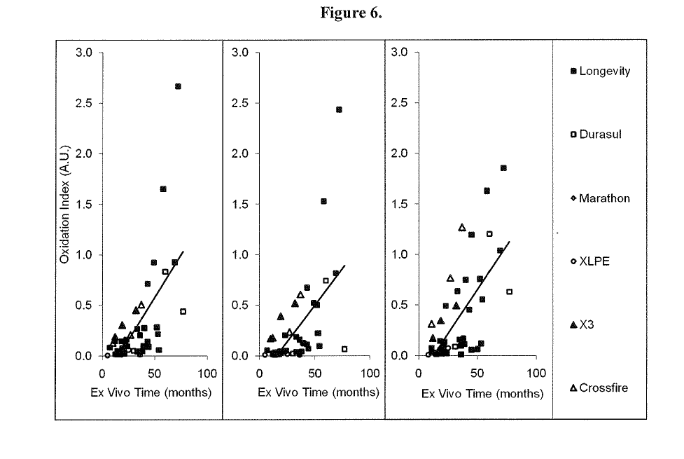

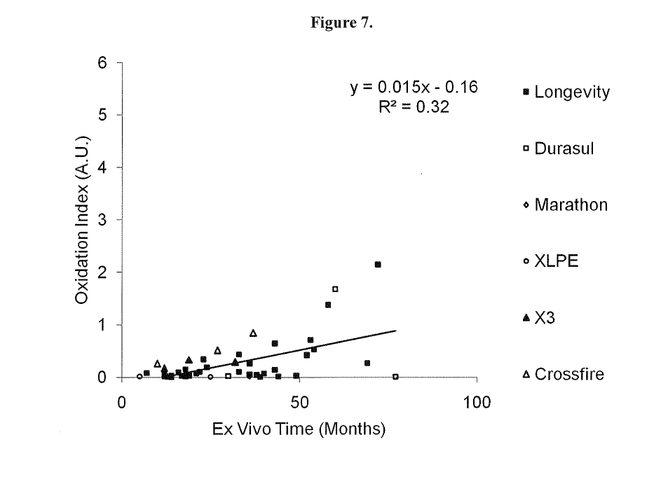

Oxidation levels measured at the subsurface regions showed increases with ex vivo duration but not with in vivo duration (FIG. 6). The linear correlations were all significant (all p<0.001 in Regions 2, 3, and 6, respectively. In Region 4 (backside) the oxidation levels also increased with increasing ex vivo duration (r=0.55, p<0.001, FIG. 7) showing no significant correlation with in vivo duration (r=−0.06, p=0.65). Longer ex vivo duration was a significant predictor of greater oxidation in Region 4, as indicated by the linear equation: y=0.015x−0.16, where x is duration in months (p<0.001, R²=0.32).

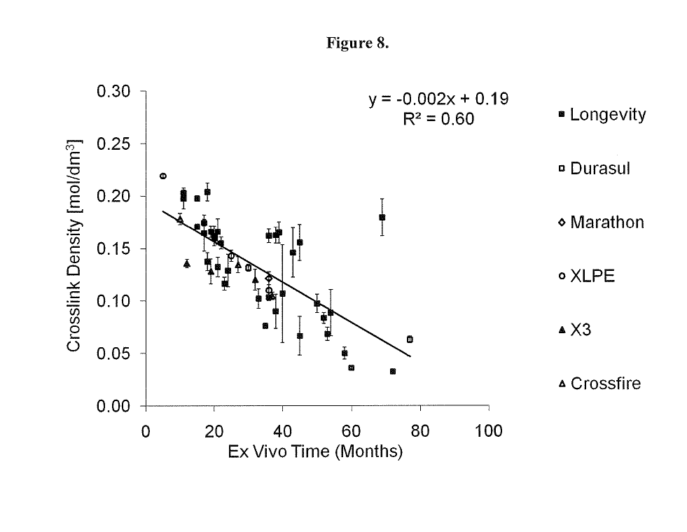

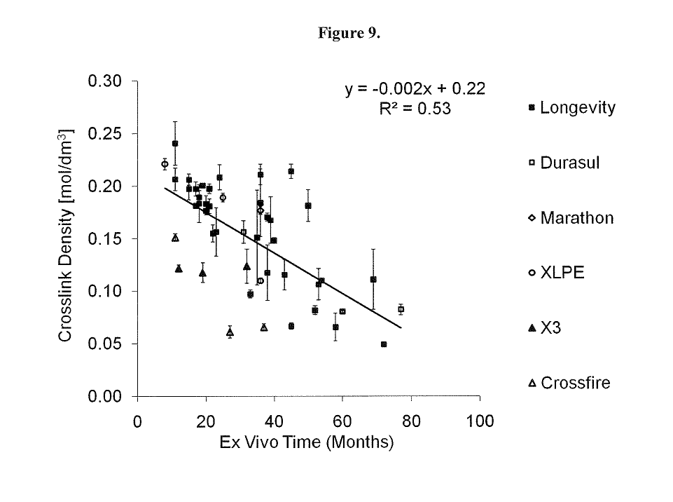

The crosslink density measured at the articular surfaces (Region 1) showed an inverse correlation with increasing ex vivo duration. The correlation was significant and fitted a linear regression with r=−0.73, p<0.001 (FIG. 8). The crosslink density measured at the surface of the rim (Region 5) also showed an inverse correlation with ex vivo duration with a significant fit to linear regression (r=−0.66, p<0.001, FIG. 9). There was less scatter in the crosslink density data collected at Region 1 than that collected at Region 5. The slopes of the regressions were comparable for both regions (no significant slope differences, p=0.70)

The crosslink density measured in the subsurface regions (Regions 2, 3, and 6) of the components also showed a statistically significant decrease in crosslink density with ex vivo storage with (r=−0.69, p<0.001), (r=−0.62, p<0.001), and (r=−0.74, p<0.001), respectively. The crosslink density was higher in the subsurface regions than the articular and rim surfaces. The Region 4 (backside) of the components also showed a statistically significant decrease in crosslink density with ex vivo duration with r=−0.55, p<0.001.

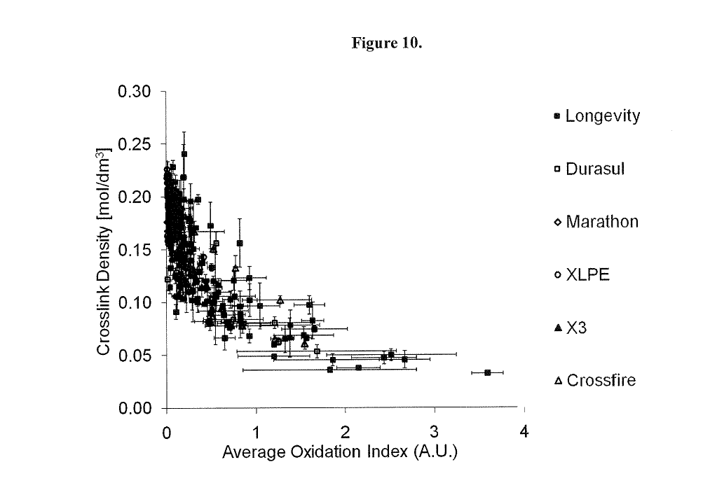

Crosslink densities were inversely correlated with oxidation levels at all six regions: Region 1 (r=−0.76), Region 2 (r=−0.77), Region 3 (r=−0.79), Region 4 (r=−0.76), Region 5 (r=−0.75), Region 6 (r=−0.78) (all p<0.001) (FIG. 10).

The first heat crystallinity of the explants increased significantly with ex vivo duration in Regions 1, 2, 5, and 6 (p<0.01 for all). The second heat and cooling cycles showed statistically significant increase in crystallinity with ex vivo duration in all regions (p<0.01 for all). The peak melting temperature measured during 1^{st} heat cycle showed no statistically significant change with ex vivo duration. The peak melting temperature measured during the second heat showed a significant decrease with ex vivo duration in all regions except Regions 1 and 4. Similarly, the peak crystallization temperature decreased significantly with ex vivo duration for all regions except Region 4 (p<0.01).

The Durasul explant with 92 months of in vivo service and the fresh Durasul implant both showed no detectable wear on the hip simulator. The explant and the fresh implant showed a weight increase as a function of simulated gait cycles. During the first 0.5 million cycles of testing the fresh implant showed a larger increase in weight increase (5.08 mg with the fresh implant vs. 0.87 mg with the explant), thereafter the rate of weight increase was comparable for both the fresh and explanted Durasul liners at about 1.1 mg/million-cycle and 0.8 mg/million-cycle, respectively.

The Durasul explant showed no detectable oxidation at the rim or at the loaded articular regions (both surface and subsurface regions) when it was analyzed with infrared spectroscopy following the five million cycle hip simulator test. The crosslink density in all regions was on average 0.179±0.004 mol/dm³. Thermal properties of the explant were not determined because there was no oxidation and no decrease in the crosslink density.

TABLE 2
Average maximum surface oxidation levels (OXI) of the explants that
were analyzed after surgical removal and after ex vivo storage.

| | | Rim Region | | | Articular Surface Region | |
|---|---|---|---|---|---|---|
| | | Ex Vivo | | OXI after | Ex Vivo | OXI after |
| | | Duration | OXI at | Ex Vivo | Duration | Ex Vivo |
| Sample ID | Type | (mos.) | Post-Op | Storage | (mos.) | Storage |
| H-07-020 | Longevity | 17 | 0.012 | 0.119 | 17 | 0.175 |
| H-04-005 | Longevity | 52 | 0.055 | 2.060 | 52 | 1.570 |
| H-05-046 | Longevity | 38 | 0.094 | 0.251 | 38 | 0.729 |
| H-05-047 | Longevity | 39 | 0.087 | 0.231 | 39 | 0.233 |
| H-06-050 | Longevity | 22 | 0.026 | 0.406 | 21 | 0.121 |
| H-03-066 | Longevity | 58 | 0.071 | 2.299 | 58 | 5.007 |
| H-05-009 | Longevity | 43 | 0.075 | 0.751 | 43 | 0.757 |
| H-05-033 | Longevity | 40 | 0.073 | 1.701 | 40 | 1.187 |
| H-07-032 | Longevity | 17 | 0.047 | 0.044 | 14 | 0.485 |
| H-05-006 | Longevity | 45 | 0.102 | 0.289 | 44 | 1.030 |
| H-07-005 | Longevity | 21 | 0.031 | 0.424 | 19 | 1.029 |
| H-06-001 | Longevity | 33 | 0.173 | 1.410 | 33 | 0.878 |
| H-07-004 | Longevity | 20 | 0.007 | 0.445 | 19 | 0.585 |
| H-07-024 | Longevity | 18 | 0.033 | 0.199 | 14 | 0.070 |
| H-05-054 | Longevity | 38 | 0.048 | 0.362 | 36 | 0.921 |
| H-07-041 | Longevity | 15 | 0.025 | 0.133 | 13 | 0.033 |
| H-02-084 | Longevity | 69 | 0.094 | 1.704 | 69 | 1.290 |
| H-02-071 | Longevity | 72 | 0.119 | 2.703 | 72 | 4.977 |
| H-04-009 | Longevity | 54 | 0.029 | 1.178 | 54 | 2.058 |
| H-04-028 | Longevity | 50 | 0.061 | 0.552 | 49 | 2.610 |
| H-04-017 | Longevity | 53 | 0.026 | 0.417 | 53 | 1.908 |
| H-04-055 | Longevity | 45 | 0.131 | 2.324 | 43 | 2.806 |
| H-07-022 | Longevity | 19 | 0.049 | 0.333 | 16 | 0.397 |
| H-07-040 | Longevity | 15 | 0.020 | 0.043 | 12 | 0.540 |
| H-07-049 | Longevity | 11 | 0.073 | 0.068 | 7 | 0.435 |
| H-07-006 | Longevity | 20 | 0.046 | 0.083 | 18 | 0.584 |
| H-05-061 | Longevity | 35 | 0.048 | 0.542 | 33 | 1.851 |
| H-06-028 | Longevity | 24 | 0.092 | 0.070 | 24 | 0.706 |
| H-05-045 | Longevity | 36 | 0.063 | 0.434 | 36 | 0.466 |
| H-06-054 | Longevity | 18 | 0.046 | 0.424 | 18 | 0.628 |
| H-07-037 | Longevity | 11 | 0.025 | 0.363 | 12 | 0.382 |
| H-07-008 | Longevity | 21 | 0.019 | 0.470 | 22 | 0.537 |
| H-05-027 | Longevity | 36 | 0.029 | 0.211 | 36 | 0.466 |
| H-06-037 | Longevity | 23 | 0.144 | 1.114 | 23 | 1.029 |
| H-02-042 | Durasul | 77 | 0.062 | 1.090 | 77 | 2.310 |
| H-03-036 | Durasul | 60 | 0.049 | 2.420 | 60 | 3.031 |
| H-05-067 | Durasul | 31 | 0.062 | 1.123 | 30 | 0.768 |
| H-05-055 | Crossfire | 37 | 0.239 | 1.181 | 37 | 1.850 |
| H-06-040 | Crossfire | 27 | 0.527 | 0.913 | 27 | 2.410 |
| H-07-052 | Crossfire | 11 | 0.520 | 0.749 | 10 | 0.671 |
| H-07-015 | X3 | 19 | 0.097 | 0.562 | 19 | 0.459 |
| H-06-019 | X3 | 32 | 0.124 | 0.612 | 32 | 0.537 |
| H-07-048 | X3 | 12 | 0.122 | 0.224 | 12 | 0.287 |
| H-05-066 | XLPE | 36 | 0.034 | 0.318 | 36 | 0.781 |
| H-08-001 | XLPE | 8 | 0.089 | 0.022 | 5 | 0.031 |
| H-06-044 | XLPE | 25 | 0.041 | 0.407 | 25 | 0.792 |
| H-06-018 | Marathon | 36 | 0.117 | 0.272 | 36 | 0.272 |

An in-depth analysis of surgically explanted highly crosslinked UHMWPE acetabular liners was carried out in the light of the recent finding of increased in vivo femoral head penetration with one type of highly crosslinked UHMWPE (Karrholm, et al.: Five to seven years experience with highly crosslinked PE. In SICOT 2008. Hong Kong, August 2008). It was found that the irradiated and melted UHMWPEs were undergoing chemical changes, which resulted in high levels of oxidation and loss of crosslinking not while in vivo but unexpectedly during ex vivo storage. These chemical and structural changes are unique, surprising, and unexpected. Understanding the oxidation mechanisms is useful in determining if similar loss of stability could occur in vivo in the longer term and how that might affect the device performance in the second and third decade of in vivo service.

Oxidation can be free radical initiated and is expected to result in chain scission; hence the concomitant decrease in crosslink density (which could occur through chain scission) observed here would be expected in areas of oxidation. What is surprising, however, is the occurrence of oxidation in irradiated and melted UHMWPEs (Longevity, Durasul, XLPE, and Marathon), which are known to have no detectable free radicals as determined by state-of-the art electron spin resonance (ESR) equipment with a detection limit of about 10¹⁴ spins/gram. One possible explanation of the ex vivo oxidation of irradiated and melted UHMWPE is the presence of free radicals below that detection limit. Real-time aging in an aqueous environment at body temperature resulted in no detectable oxidation up to about 3 years in irradiated and melted UHMWPE (Wannomae, et al. Biomaterials. 27(9):1980-1987 (2006)). The study subsequently extended the analysis of these real time aged samples up to six years and are still showing no detectable oxidation in irradiated and melted UHMWPE. Therefore, the support for the presence of residual free radicals below the ESR detection limit in irradiated and melted UHMWPE is not very strong. Likely, other mechanisms were responsible for the ex vivo degradation of irradiated and melted UHMWPE.

In the irradiated and annealed UHMWPE samples (X3 and Crossfire) the oxidation and loss of crosslinking was expected because these samples contain residual free radicals. Previous studies showed that while irradiated and annealed UHMWPE oxidized in vivo, irradiated and melted UHMWPE showed no detectable oxidation. Out of the 47 explants in this study, there were 3 Crossfire explants (irradiated and annealed) two of which showed in vivo oxidation above an index of 0.5 measured at the rim shortly after explantation—the highest of all explants reported here—corroborating the observations with the previous studies. There were also three X3 explants (sequentially irradiated and annealed), which showed minimal oxidation at the rim at the time of explantation. At this point there is not enough information to conclusively determine if the subsequent oxidation that occurred in both of the Crossfire and X3 components during ex vivo storage was due to the residual free radicals from the initial fabrication method and/or other mechanisms that are active in vivo and ex vivo.

The two potential mechanisms are identified herein that could play a role in inducing changes in vivo which had a delayed reduction in oxidation resistance of highly crosslinked UHMWPE, especially irradiated and melted UHMWPE, after explantation. One mechanism is based on the formation of free radicals in the material under cyclic loading and the other is based on an oxidation cascade that is initiated by absorbed lipids from the synovial fluid.

Only one published report on the effects of cyclic loading on the free radical concentration of UHMWPE was found (Jahan, et al., J Biomed Mater Res, 25(8): 1005-1017, 1991). In that work Jahan and co-workers subjected conventional UHMWPE acetabular liners to cyclic loading at 5 Hz for 10 million cycles after gamma sterilization and found a reduction in free radical concentration. They attributed the decreases in free radical concentration to the heating by the cyclic loading and also increased reaction rate of the free radicals with oxygen. Unfortunately, in that work the UHMWPE was gamma sterilized prior to cyclic loading; therefore it already contained free radicals. Also at 5 Hz the heating in the polyethylene would have been quite appreciable, especially for 10 million cycles. In addition, the base material was not highly crosslinked. In this application, it is postulated that increasing crosslink density would increase the constraint on the molecular chain segments and under strain make the UHMWPE more vulnerable to the generation of free radicals.

With the second mechanism, it is postulated that lipids absorbed from the synovial fluid start to oxidize on the shelf after removal from the patients and that the free radicals on the lipid molecules attack the polyethylene molecules and initiate degradation of the host polymer. It is possible that oxidation is not initiated or the rate of oxidation is low at the very low oxygen concentrations in the synovial fluid and only after exposure to air subsequent to explantation do the oxidation reactions become substantial. To protect against this mechanism, the lipids absorbed in polyethylene would need to be somehow stabilized and not oxidize in vivo. Costa et al. (Biomaterials, 22(4): 307-315, 2001) have shown that UHMWPE readily absorbs cholesterol, squalene (lipid), and esterified fatty acids (e.g. cholesteryl esters of hexadecanoic acid and octadecanoic acid) from the synovial fluid. Lipid peroxidation can be initiated by a reaction with reactive oxygen species, an enzymatic attack, or by elevated temperatures and progresses through a chain reaction. In this study, it was investigated if only in the presence of an antioxidant could the lipid peroxidation chain reaction be interrupted. It is possible that antioxidants from the synovial fluid are absorbed in polyethylene and the latter protects the lipids from oxidation. After removal from the body, the absorbed antioxidants would protect the lipids for some duration after which the antioxidants would be depleted and the oxidation of the lipids would start and that oxidation would also attack the polyethylene molecules. According to this mechanism the lipids may not degrade the polyethylene in vivo as long as the antioxidants are continuously absorbed from the synovial fluid.

One interesting observation was that even with oxidation levels above an index of 1, which typically would be associated with embrittlement of the material and ‘white banding,’ there was no manifestation of embrittlement in the microtomed thin sections of the explanted highly crosslinked liners. It follows then that the oxidation occurred without causing a substantial increase in crystallinity and without resulting in the embrittlement of the polymer. In fact, very small increases (although statistically significant) were recorded in the crystallinity of the explants by DSC. This would mean that oxidation did not cause marked chain scission, yet the crosslink density was reduced. It is possible that chain scission occurred, which reduced the crosslink density, but the polymer molecules still remained covalently bound to each other through a loose network and thus not allowed recrystallization and embrittlement of the polymer. Given longer durations ex vivo on the shelf, the loose network might get dissipated, allowing recrystallization and embrittlement. It was noted that the embrittlement and “white banding” phenomena occur in gamma sterilized conventional UHMWPE with much lower crosslink density than the highly crosslinked UHMWPEs of this study. Therefore, additional chain scissioning is needed to undo the crosslinks to the base level of conventional UHMWPE before further scissioning can embrittle the polymer and cause “white banding.”

Another interesting observation was that even with very short in vivo durations, when allowed a longer ex vivo storage, the irradiated and melted UHMWPE developed high levels of oxidation (FIG. 2b). For example H-03-066 was in vivo for 2 months and was stored on the shelf for 58 months and during that time period it developed unusually high levels of oxidation. Somehow, 2 months of service in vivo turned this irradiated and melted UHMWPE from being oxidatively very stable to unstable. With a short 2-month in vivo duration the development of such a high level of oxidation during the ensuing 58 months on the shelf is very surprising.

It was also observed that a decrease in the peak melting point measured during the second heating cycle of the explants, especially with longer ex vivo durations. During the first melting cycle it likely released the smaller molecules formed by the oxidative chain scission from the crystals and allowed them to crystallize to thinner lamellae, which then melted at lower temperatures reducing the overall melting point of the implants during the second heating cycle of the DSC measurement.

In another study, a number of highly crosslinked UHMWPE acetabular components (both melted and annealed subsequent to irradiation) were subjected to more than 5 million cycles of simulated normal gait in bovine serum on a hip simulator. The test components were then shelf stored in air for more than 5 years. Analysis shows a similar phenomenon, that is, increased oxidation and decreased crosslink density, even with the irradiated and melted components. One difference with the explants was the extensive embrittlement of the simulator tested and shelf stored components. The ingredients for both of the proposed mechanisms (i.e. cyclic loading and lipids) are present in the hip simulator. There is cyclic loading and there is lipid uptake from the bovine serum by the UHMWPE components.

This investigation reveals that deterioration of the physical properties of surgically retrieved components appears to have been initiated in vivo; but the manifestation of this instability in the form of increased oxidation and loss of crosslinking occurred after the implants were stored on the shelf for some duration. Therefore, it is not clear at what time point, they would be manifested in vivo.

Preventing Oxidation, and Making of Oxidation and Wear Resistant Polymeric Materials:

Radiation crosslinking reduces wear of UHMWPE, but residual free radicals remain in UHMWPE, resulting in long-term oxidation. The incorporation of an antioxidant such as vitamin E in UHMWPE can stabilize these residual free radicals and render the cross-linked UHMWPE oxidatively stable without the need for quenching the free radicals. According to one aspect of the invention, the antioxidant is blended in UHMWPE or the antioxidant is diffused into consolidated radiation crosslinked UHMWPE.

One approach to reduce free radicals in radiation cross-linked UHMWPE is to anneal below the melting point. Annealing below the melting point is desirable because melting the crystals completely in the presence of the cross-links reduces the mechanical strength of the material through a decrease in crystallinity. Annealing below the melting point can be done at an elevated temperature more effectively by increasing the pressure. This is because the melting point of cross-linked UHMWPE increases with increasing pressure. For example, it is observed that 100-kGy irradiated UHMWPE is not completely molten at 150° C. under 10,000 psi of hydrostatic pressure, whereas its melting point at ambient pressure is approximately 140° C.

Another approach to prevent lipid- or cyclic deformation-initiated oxidation of polymeric material is by providing an oxidation and wear resistant polymeric material.

In one aspect, the invention provides methods of preventing lipid-initiated oxidation of polymeric material by providing an oxidation and wear resistant polymeric material, wherein the polymeric material is made by a process comprising the steps of: a) blending a polymeric material with an antioxidant; b) consolidating the polymeric blend; c) heating the consolidated polymeric blend to an elevated temperature that is above the room temperature and below the melting point of the polymeric material; and d) irradiating the heated consolidated polymeric blend with ionizing radiation at an elevated temperature that is below the melting point of the polymeric material, thereby providing an oxidation and wear resistant polymeric material that can resist lipid-initiated oxidation.

In another aspect, the invention provides methods of preventing lipid-initiated oxidation of polymeric material by providing an oxidation and wear resistant polymeric material, wherein the polymeric material is made by a process comprising the steps of: a) heating a consolidated blend of polymeric materials containing one or more antioxidants to a temperature that is above the room temperature and below the melting point of the polymeric material; and b) irradiating the heated consolidated polymeric blend with ionizing radiation at an elevated temperature that is below the melting point of the polymeric material, thereby providing an oxidation and wear resistant polymeric material that can resist lipid-initiated oxidation.

In another aspect, the invention provides methods of preventing lipid-initiated oxidation of polymeric material by providing an oxidation and wear resistant polymeric material, wherein the polymeric material is made by a process comprising the steps of: a) irradiating a consolidated polymeric material by ionizing radiation at an elevated temperature that is above the room temperature and below the melting point of the polymeric material; and b) doping the irradiated consolidated polymeric material with one or more antioxidants by diffusion, thereby providing an oxidation and wear resistant polymeric material that can resist lipid-initiated oxidation.

In another aspect, the invention provides methods of preventing lipid-initiated oxidation of polymeric material by providing an oxidation and wear resistant polymeric material, wherein the polymeric material is made by a process comprising the steps of: a) irradiating a consolidated blend of polymeric materials containing one or more antioxidants by ionizing radiation at an elevated temperature that is above the room temperature and below the melting point of the polymeric material; b) heating the irradiated consolidated polymeric blend containing one or more antioxidants to an elevated temperature that is above the room temperature and below the melting point of the polymeric material; and c) annealing the heated consolidated polymeric blend at an elevated temperature that is below the melting point of the polymeric material, thereby providing an oxidation and wear resistant polymeric material that can resist lipid-initiated oxidation.

In another aspect, the invention provides methods of preventing lipid-initiated oxidation of polymeric material by providing an oxidation and wear resistant polymeric material, wherein the polymeric material is made by a process comprising the steps of: a) irradiating a consolidated polymeric material by ionizing radiation at about room temperature; and b) doping the irradiated consolidated polymeric material with one or more antioxidants by diffusion, thereby providing an oxidation and wear resistant polymeric material that can resist lipid-initiated oxidation.

In another aspect, the invention provides methods of preventing lipid-initiated oxidation of polymeric material by providing an oxidation and wear resistant polymeric material, wherein the polymeric material is made by a process comprising the steps of: a) irradiating a consolidated blend of polymeric materials containing one or more antioxidants by ionizing radiation at about room temperature; b) heating the irradiated consolidated polymeric blend containing one or more antioxidants to an elevated temperature that is above the room temperature and below the melting point of the polymeric material; and c) annealing the heated and cross-linked consolidated polymeric blend at an elevated temperature that is below the melting point of the polymeric material, thereby providing an oxidation and wear resistant polymeric material that can resist lipid-initiated oxidation.

In one aspect, the invention provides methods of preventing oxidation initiated by cyclic deformation of polymeric material by providing an oxidation and wear resistant polymeric material, wherein the polymeric material is made by a process comprising the steps of: a) blending a polymeric material with one or more antioxidants; b) consolidating the polymeric blend; c) heating the consolidated polymeric blend to an elevated temperature that is above the room temperature and below the melting point of the polymeric material; and d) irradiating the heated consolidated polymeric blend with ionizing radiation at an elevated temperature that is below the melting point of the polymeric material, thereby providing an oxidation and wear resistant polymeric material that can resist oxidation due to, caused by, induced by or initiated by cyclic deformation of the polymeric material.

In another aspect, the invention provides methods of preventing oxidation initiated by cyclic deformation of polymeric material by providing an oxidation and wear resistant polymeric material, wherein the polymeric material is made by a process comprising the steps of: a) heating a consolidated blend of polymeric materials containing one or more antioxidants to a temperature that is above the room temperature and below the melting point of the polymeric material; and b) irradiating the heated consolidated polymeric blend with ionizing radiation at an elevated temperature that is below the melting point of the polymeric material, thereby providing an oxidation and wear resistant polymeric material that can resist oxidation due to, caused by, induced by or initiated by cyclic deformation of the polymeric material.

In another aspect, the invention provides methods of preventing oxidation initiated by cyclic deformation of polymeric material by providing an oxidation and wear resistant polymeric material, wherein the polymeric material is made by a process comprising the steps of: a) irradiating a consolidated polymeric material by ionizing radiation at an elevated temperature that is above the room temperature and below the melting point of the polymeric material; and b) doping the irradiated consolidated polymeric material with one or more antioxidants by diffusion, thereby providing an oxidation and wear resistant polymeric material that can resist oxidation due to, caused by, induced by or initiated by cyclic deformation of the polymeric material.

In the description above, the polymeric material in (a) can be a blend of virgin polymers and one or more antioxidants.

In another aspect, the invention provides methods of preventing oxidation initiated by cyclic deformation of polymeric material by providing an oxidation and wear resistant polymeric material, wherein the polymeric material is made by a process comprising the steps of: a) irradiating a consolidated blend of polymeric materials containing one or more antioxidants by ionizing radiation at an elevated temperature that is above the room temperature and below the melting point of the polymeric material; b) heating a consolidated polymeric blend containing one or more antioxidants to an elevated temperature that is above the room temperature and below the melting point of the polymeric material; and c) annealing the heated consolidated polymeric blend at an elevated temperature that is below the melting point of the polymeric material, thereby providing an oxidation and wear resistant polymeric material that can resist oxidation due to, caused by, induced by or initiated by cyclic deformation of the polymeric material.

In another aspect, the invention provides methods of preventing oxidation initiated by cyclic deformation of polymeric material by providing an oxidation and wear resistant polymeric material, wherein the polymeric material is made by a process comprising the steps of: a) irradiating a consolidated polymeric material by ionizing radiation at about room temperature; and b) doping the irradiated consolidated polymeric material with one or more antioxidants by diffusion, thereby providing an oxidation and wear resistant polymeric material that can resist oxidation due to, caused by, induced by or initiated by cyclic deformation of the polymeric material.

In the description above, the polymeric material in (a) can be a blend of virgin polymers and one or more antioxidants.

In another aspect, the invention provides methods of preventing oxidation initiated by cyclic deformation of polymeric material by providing an oxidation and wear resistant polymeric material, wherein the polymeric material is made by a process comprising the steps of: a) irradiating a consolidated blend of polymeric materials containing one or more antioxidants by ionizing radiation at about room temperature; b) heating a consolidated polymeric blend containing one or more antioxidants to an elevated temperature that is above the room temperature and below the melting point of the polymeric material; and c) annealing the heated consolidated polymeric blend at an elevated temperature that is below the melting point of the polymeric material, thereby providing an oxidation and wear resistant polymeric material that can resist oxidation due to, caused by, induced by or initiated by cyclic deformation of the polymeric material.

In another aspect, the invention provides methods of preventing oxidation initiated by cyclic deformation of polymeric material by providing an oxidation and wear resistant polymeric material, wherein the polymeric material is made by a process comprising the steps of: a) irradiating a consolidated blend of polymeric materials containing one or more antioxidants by ionizing radiation at about room temperature; and b) mechanically annealing the consolidated polymeric blend, thereby providing an oxidation and wear resistant polymeric material that can resist oxidation due to, caused by, induced by or initiated by cyclic deformation of the polymeric material.

In one embodiment, virgin polymeric material or a blend of the polymeric material with an antioxidant such as vitamin E is consolidated and heated to an elevated temperature below the melting point of the polymeric material.

In another embodiment, virgin polymeric material or a blend of the polymeric material with an antioxidant such as vitamin E is consolidated and heated to an elevated temperature below the melting point of the polymeric material and subsequently radiation cross-linked.

In another embodiment, virgin polymeric material or a blend of the polymeric material is consolidated and heated to an elevated temperature below the melting point of the polymeric material and subsequently radiation cross-linked. The radiation crosslinked consolidated polymeric blend is then diffused with one or more antioxidant, such as vitamin E, by doping or doping and homogenization.

The oxidation resistance of radiation cross-linked UHMWPE is crucial in its performance as a bearing surface as oxidation deteriorates its mechanical and wear properties in vivo over a long period of time. Oxidation is largely thought to be related to residual free radicals trapped in the crystalline regions of the polymer, their migration to the crystalline/amorphous interface and their reaction with diffused oxygen. Oxidation may also be related to other free radical generating mechanisms such as the material coming into contact with a free radical inducing medium or chains scission through static, dynamic or cyclic deformation. The safest way of protecting against these free radicals is the introduction of an antioxidant such as vitamin E into UHMWPE before or after cross-linking.

An antioxidant with a lipophilic structure can also act as a plasticizing agent in addition to protecting the material against oxidation. Then, it would be advantageous to incorporate the antioxidant in the polymer to improve mechanical properties as well.

Antioxidants/free radical scavengers can be chosen from but not limited to glutathione, lipoic acid, vitamins such as ascorbic acid (vitamin C), vitamin B, vitamin D, vitamin-E, tocopherols (synthetic or natural, alpha-, gamma-, delta-), acetate vitamin esters, water soluble tocopherol derivatives, tocotrienols, water soluble tocotrienol derivatives; melatonin, carotenoids including various carotenes, lutein, pycnogenol, glycosides, trehalose, polyphenols and flavonoids, quercetin, lycopene, lutein, selenium, nitric oxide, curcuminoids, 2-hydroxytetronic acid; cannabinoids, synthetic antioxidants such as tertiary butyl hydroquinone, 6-amino-3-pyrodinoles, butylated hydroxyanisole, butylated hydroxytoluene, ethoxyquin, tannins, propyl gallate, other gallates, Aquanox family; IrganoxÒ and IrganoxÒ B families including Irganox 1010, Irganox 1076, Irganox 1330; phenolic compounds with different chain lengths, and different number of OH groups; enzymes with antioxidant properties such as superoxide dismutase, herbal or plant extracts with antioxidant properties such as St. John's Wort, green tea extract, grape seed extract, rosemary, oregano extract, mixtures, derivatives, analogues or conjugated forms of these. They can be primary antioxidants with reactive OH or NH groups such as hindered phenols or secondary aromatic amines, they can be secondary antioxidants such as organophosphorus compounds or thiosynergists, they can be multifunctional antioxidants, hydroxylamines, or carbon centered radical scavengers such as lactones or acrylated bis-phenols. The antioxidants can be selected individually or used in any combination. Further, antioxidants can be used in combination with other compounds to help increase their rate of interaction with the polymer, such as hydroperoxide decomposers.

In an embodiment, the polymeric blend is irradiated at a dose rate of about 1 to 1000 kGy per pass. The irradiation dose rates that can be reached with electron beam are much higher than those with gamma irradiation. Electron beam dose rate are typically on the order of 1 to several hundred kGy per pass with each pass taking anywhere between a few seconds to a few minutes. The polymer blend is brought to a certain initial temperature and irradiated. The dose rate is high enough to cause radiation generated heating (including adiabatic and partially adiabatic) of the polymer. The temperature of the sample during irradiation depends on the starting temperature and the radiation dose level used. Following equation, which assume purely radiation generated heating (including adiabatic and partially adiabatic) conditions, can be used to estimate the temperature:

D=ΔH_{m,i}(T)+cₚΔT, EQ1

where D is the radiation dose level absorbed by the sample, Tᵢ is the instantaneous temperature of the sample, ΔT (=Tᵢ−Tₒ) is the difference between the instantaneous temperature (Tᵢ) of the sample and the initial temperature (Tₒ) of the sample, ΔH_{m,i}(Tᵢ) is the melting enthalpy of the crystals that melt below the instantaneous temperature of the sample, and cₚ is the specific heat of the polymer. This equation assumes purely radiation generated heating (including adiabatic and partially adiabatic) conditions; while there will be some heat loss to the surroundings near the surface of the irradiated sample, the bulk of the sample will more closely follow the temperature predicted by this equation, especially at high dose rates, and thus is a practical approximation. If a certain temperature is desired during irradiation, the equation is used to determine the irradiation parameters. In this embodiment the radiation dose level can be above 1 kGy. More preferably it can be 25 kGy, 50 kGy, 100 kGy, 150 kGy, 200 kGy or above. The dose rate can be about 1, 10, 25, 75, 100, 150, 200, or more kGy per pass or any dose rate in-between. The initial temperature can be below room temperature (RT), RT, above RT, about 40, 50, 75, 100, 110, 125, 130, 135° C. or more or any temperature thereabout or therebetween. The irradiation can be carried out with e-beam, gamma, or x-rays. The latter two has lower dose rates than e-beam; therefore e-beam is more practical to reach high dose rates.

In another embodiment, the polymeric blend is irradiated with gamma or e-beam followed by annealing or heating to recombine the free radicals trapped in the crystalline domains. When the irradiation is carried out at low temperatures and/or low dose rates, the cross-link density is lower than it is after the irradiated polymeric blend is annealed below the melting point or melted.

In certain embodiments, it is not desired to completely melt the polymer blend during the irradiation step. For example, with a required high dose level (higher than 100 kGy) to reach a desired cross-link density, the polymer blend could be subjected to radiation generated (including adiabatic and partially adiabatic) melting and result in complete melting of the blend. Post-irradiation melting reduces the crystallinity of the sample, which in turn reduces mechanical properties of the blend. One can prevent complete melting of the blend during irradiation by keeping the dose rate low to minimize radiation generated heating (including adiabatic and partially adiabatic), reduce the initial temperature, and/or reduce the radiation dose. In certain embodiments the polymer blend may require a higher initial temperature; in such cases one can use low radiation dose rate to reduce the extent of melting by radiation generated heating.

In another embodiment, irradiation is carried out in multiple steps so as to reduce the extent of radiation generated heating (including adiabatic and partially adiabatic) of the polymer blend. For instance, the polymer blend is irradiated in multiple passes under or near the radiation source (such as e-beam, gamma, or x-rays). The time between the passes can be adjusted to allow the polymer blend to cool down to the desired irradiation temperature. In some embodiments it is desirable to heat the sample between irradiation passes.

In another embodiment, the initial temperature of the polymer sample is adjusted such that the temperature of the polymer blend is increased to its peak melting point during irradiation.

DSC testing of warm irradiated blends typically exhibit three melting peaks on their first heat and two melting peaks on their second heat. The area under the highest melting peak of the first heat can be used to determine the extent of melting in the polymer during warm irradiation.

In another embodiment, crystallinity of a blend is increased through, for example high pressure crystallization. The highly crystalline blend is then irradiated. To allow the recombination of the free radicals in the crystalline domains the blend is irradiated with a high enough dose rate to partially melt the polymer. Alternatively, the irradiation is carried out at an elevated temperature to partially melt the polymer. Another approach is to post-irradiation anneal or melt the polymer to allow the free radicals in the crystalline domains to recombine with each other. These approaches result in an improved cross-linking efficiency for the blend.

In another embodiment, a polymer/antioxidant blend is mixed with virgin polymer flakes and consolidated. The consolidation cycle is kept as short as possible and at the lowest possible temperature to minimize bleeding of the antioxidant from the antioxidant blended flakes into virgin flakes. The consolidated polymer is then irradiated and subsequently homogenized to allow diffusion of antioxidant from antioxidant-rich regions to antioxidant-poor regions. Also, the antioxidant doped flakes could be subjected to an annealing cycle to diffuse the antioxidant to deeper into individual flakes and minimize its presence as a surface coating. This also reduces the extent of antioxidant bleeding across from the doped flakes to virgin flakes during consolidation and/or irradiation.

In one aspect, the invention provides methods to improve the oxidative stability of polymers against lipid-initiated oxidation. In one embodiment, the polymer is blended with one or more antioxidants and heated to a temperature between room temperature and the melting point of the polymer, then irradiated at an elevated temperature below the melting point.

The invention provides various methods to improve the oxidative stability of irradiated antioxidant-containing polymers. In an embodiment, the invention provides methods to improve oxidative stability of polymers by heat treatment (such as annealing) of irradiated polymer-antioxidant blend to reduce the concentration of the residual free radicals through recombination reactions resulting in cross-linking and/or through reaction of the residual free radicals with the antioxidant. The latter is likely to take place by the abstraction of a hydrogen atom from the antioxidant molecules to the polymer, thus eliminating the residual free radical on the polymer backbone. Hence heat treatment (such as annealing) of an irradiated polymer in the presence of an antioxidant is more effective in reducing the concentration of residual free radicals than heat treatment (such as annealing) of an irradiated polymer in the absence of an antioxidant. It is likely that annealing below the melting point also preserves more of the antioxidant compared to melting at elevated temperature.

In another embodiment, invention provides methods to improve oxidative stability of polymers by diffusing more antioxidant into the irradiated polymer-antioxidant blend. The antioxidant diffusion methods have been described by Muratoglu et al. (see, e.g., US 2004/0156879; U.S. application Ser. No. 11/465,544, filed Aug. 18, 2006; PCT/US2006/032329 Published as WO 2007/024689, which are incorporated herein by reference).

In another embodiment, invention provides methods to improve oxidative stability of polymers by extracting antioxidants and creating a gradient of antioxidant concentration. The antioxidant extraction methods have been described in WO 2008/092047, the methodologies of which are hereby incorporated by reference.

In another embodiment, invention provides methods to improve oxidative stability of polymers by mechanically deforming the irradiated antioxidant-containing polymers to reduce or eliminate the residual free radicals. Mechanical deformation methods have been described by Muratoglu et al. (see, e.g., US 2004/0156879; US 2005/0124718; and PCT/US05/003305 published as WO 2005/074619), which are incorporated herein by reference.

The present invention also describes methods that allow reduction in the concentration of residual free radical in irradiated polymer, even to undetectable levels, without heating the material above its melting point. This method involves subjecting an irradiated sample to a mechanical deformation that is below the melting point of the polymer. The deformation temperature could be as high as about 135° C., for example, for UHMWPE. The deformation causes motion in the crystalline lattice, which permits recombination of free radicals previously trapped in the lattice through cross-linking with adjacent chains or formation of trans-vinylene unsaturations along the back-bone of the same chain. If the deformation is of sufficiently small amplitude, plastic flow can be avoided. The percent crystallinity should not be compromised as a result. Additionally, it is possible to perform the mechanical deformation on machined components without loss in mechanical tolerance. The material resulting from the present invention is a cross-linked polymeric material that has reduced concentration of residuals free radical, and preferably substantially no detectable free radicals, while not substantially compromising the crystallinity and modulus.

The present invention further describes that the deformation can be of large magnitude, for example, a compression ratio of 2 in a channel die. The deformation can provide enough plastic deformation to mobilize the residual free radicals that are trapped in the crystalline phase. It also can induce orientation in the polymer that can provide anisotropic mechanical properties, which can be useful in implant fabrication. If not desired, the polymer orientation can be removed with an additional step of heating at an increased temperature below or above the melting point.

According to another aspect of the invention, a high strain deformation can be imposed on the irradiated component. In this fashion, free radicals trapped in the crystalline domains likely can react with free radicals in adjacent crystalline planes as the planes pass by each other during the deformation-induced flow. High frequency oscillation, such as ultrasonic frequencies, can be used to cause motion in the crystalline lattice. This deformation can be performed at elevated temperatures that is below the melting point of the polymeric material, and with or without the presence of a sensitizing gas. The energy introduced by the ultrasound yields crystalline plasticity without an increase in overall temperature.

The present invention also provides methods of further heating following free radical elimination below melting point of the polymeric material. According to the invention, elimination of free radicals below the melt is achieved either by the sensitizing gas methods and/or the mechanical deformation methods. Further heating of cross-linked polymer containing reduced or no detectable residual free radicals is done for various reasons, for example:

1. Mechanical deformation, if sufficiently large in magnitude (for example, a compression ratio of two during channel die deformation), will induce molecular orientation, which may not be desirable for certain applications, for example, acetabular liners. Accordingly, for mechanical deformation:
a) Thermal treatment below the melting point (for example, less than about 137° C. for UHMWPE) is utilized to reduce the amount of orientation and also to reduce some of the thermal stresses that can persist following the mechanical deformation at an elevated temperature and cooling down. Following heating, it is desirable to cool down the polymer at slow enough cooling rate (for example, at about 10° C./hour) so as to minimize thermal stresses. If under a given circumstance, annealing below the melting point is not sufficient to achieve reduction in orientation and/or removal of thermal stresses, one can heat the polymeric material to above its melting point.
b) Thermal treatment above the melting point (for example, more than about 137° C. for UHMWPE) can be utilized to eliminate the crystalline matter and allow the polymeric chains to relax to a low energy, high entropy state. This relaxation leads to the reduction of orientation in the polymer and substantially reduces thermal stresses. Cooling down to room temperature is then carried out at a slow enough cooling rate (for example, at about 10° C./hour) so as to minimize thermal stresses.

2. The contact before, during, and/or after irradiation with a sensitizing environment to yield a polymeric material with no substantial reduction in its crystallinity when compared to the reduction in crystallinity that otherwise occurs following irradiation and subsequent or concurrent melting. The crystallinity of polymeric material contacted with a sensitizing environment and the crystallinity of radiation treated polymeric material is reduced by heating the polymer above the melting point (for example, more than about 137° C. for UHMWPE). Cooling down to room temperature is then carried out at a slow enough cooling rate (for example, at about 10° C./hour) so as to minimize thermal stresses.

As described herein, it is demonstrated that mechanical deformation can eliminate residual free radicals in a radiation cross-linked UHMWPE. The invention also provides that one can first deform UHMWPE to a new shape either at solid- or at molten-state, for example, by compression. According to a process of the invention, mechanical deformation of UHMWPE when conducted at a molten-state, the polymer is crystallized under load to maintain the new deformed shape. Following the deformation step, the deformed UHMWPE sample is irradiated below the melting point to cross-link, which generates residual free radicals. To eliminate these free radicals, the irradiated polymer specimen is heated to a temperature below the melting point of the deformed and irradiated polymeric material (for example, up to about 135° C. for UHMWPE) to allow for the shape memory to partially recover the original shape. Generally, it is expected to recover about 80-90% of the original shape. During this recovery, the crystals undergo motion, which can help the free radical recombination and elimination. The above process is termed as a ‘reverse-IBMA’. The reverse-IBMA (reverse-irradiation below the melt and mechanical annealing) technology can be a suitable process in terms of bringing the technology to large-scale production of UHMWPE-based medical devices.

The consolidated polymeric materials according to any of the methods described herein can be irradiated at room temperature or at an elevated temperature below or above the melting point of the polymeric material.

In certain embodiments of the present invention any of the method steps disclosed herein, including blending, mixing, consolidating, quenching, irradiating, annealing, mechanically deforming, doping, homogenizing, heating, melting, and packaging of the finished product, such as a medical implant, can be carried out in presence of a sensitizing gas and/or liquid or a mixture thereof, inert gas, air, vacuum, and/or a supercritical fluid.

The consolidated and irradiation cross-linked polymeric materials according to any of the methods described herein can be further doped with an antioxidant.

The consolidated and irradiation cross-linked polymeric materials according to any of the methods described herein can be further doped with one or more antioxidant(s) and homogenized at a temperature below or above the melting point of the polymeric material.

In another embodiment, the invention provides a highly cross-linked, oxidatively stable highly crystalline medical device, made by any of the above methods.

In another embodiment, the invention provides a highly cross-linked, oxidatively stable highly crystalline medical device, wherein the polymeric material is machined subsequently after the consolidation, irradiation, heating and/or annealing or the quenching step.

In another embodiment, the invention provides a highly cross-linked, oxidatively stable highly crystalline medical device.

Irradiation of UHMWPE with α-tocopherol reduces the cross-linking efficiency of polymeric material and also reduces the antioxidant potency of α-tocopherol. Still, in some embodiments, there is enough α-tocopherol such that after the irradiation step(s) there is still enough antioxidant potency to prevent oxidation in the bulk of the polymeric material.

In some embodiments, polymeric material is prepared with varying concentrations of antioxidant in the bulk and in the surface. In one embodiment, the polymeric article is prepared with a gradient of α-tocopherol concentration (by elution, for example) where the surface (exterior regions) has less α-tocopherol than the bulk (interior regions). Thus, after irradiation, the polymeric article is oxidation-resistant in the bulk and is highly cross-linked on the surface. However, the surface may still contain unstabilized free radicals that can oxidize and reduce the mechanical properties of the article. Alternatively, even if a gradient vitamin E/antioxidant concentration is not present, some antioxidant may be used up during the processing steps such as heating or irradiation and oxidative stability may be decreased or compromised. To prevent oxidation on the α-tocopherol poor surface region, the irradiated article can be treated by using one or more of the following methods:

(1) doping with α-tocopherol through diffusion at an elevated temperature below the melting point of the irradiated polymeric material;

(2) mechanically deforming of the UHMWPE followed by heating below or above the melting point of the article;

(3) high pressure crystallization or high pressure annealing of the article; and

(4) further heat treating the article.

After one or more of these treatments, the free radicals are stabilized or practically eliminated everywhere in the article.

Another added benefit of this invention is that the α-tocopherol doping can be carried out at elevated temperatures to shorten the diffusion time.

All of the embodiments are described with α-tocopherol as the antioxidant but any other antioxidant/free radical scavenger or mixtures of antioxidants/free radical scavengers also can be used.

According to one embodiment, the polymeric material is an article having a shape of an implant, a preform that can be machined to an implant shape, or any other shape.

In one embodiment, the polymeric article is prepared with α-tocopherol-rich and α-tocopherol-poor regions where the α-tocopherol-poor regions are located at one or more of the surface (exterior regions) and the α-tocopherol-rich regions are in the bulk (generally the interior regions).

An advantage of starting with α-tocopherol-rich and α-tocopherol-poor regions in the polymeric article is that the radiation cross-linking is primarily limited to the α-tocopherol poor regions (in most embodiments the articular surfaces) and therefore the reduction in the mechanical properties of the implant due to cross-linking is minimized.

In another embodiment, the consolidated polymeric material is fabricated through direct compression molding (DCM). The DCM mold is filled with a combination of polyethylene resin, powder, or flake containing α-tocopherol and with virgin polyethylene resin, powder, or flake, that is without α-tocopherol. The mold is then heated and pressurized to complete the DCM process. The concentration of α-tocopherol in the initial α-tocopherol-containing resin, powder, or flake may be sufficiently high to retain its α-tocopherol efficiency throughout the DCM process, and any subsequent irradiation and cleaning steps. This concentration is between about 0.0005 wt % and about 20 wt % or higher, preferably between about 0.005 wt % and about 5.0 wt %, preferably about 0.3 wt %, or preferably about 0.5 wt %. The DCM mold is filled with either or both of the resins, powders, or flakes to tailor the distribution of the α-tocopherol in the consolidated polymeric article. One issue is the diffusion of α-tocopherol from the blended resin, powder, or flake regions to the virgin resin, powder, or flake regions, especially during consolidation where high temperatures and durations are typical. Any such diffusion would reduce the efficiency of subsequent cross-linking in the affected virgin resin, powder, or flake regions. One can control the diffusion process by tailoring the distribution of α-tocopherol, by optimizing the content of α-tocopherol in the blended polymer, by reducing the temperature of consolidation, and/or reducing the time of consolidation.

In some embodiments the α-tocopherol rich region is confined to the core of the polymeric article and the virgin polymeric material is confined to the outer shell whereby the thickness of the α-tocopherol-poor region is between about 0.01 mm and 20 mm, more preferably between about 1 mm and 5 mm, or more preferably about 3 mm.

In some embodiments the outer layer is limited to only one or more faces of the polymeric article. For example a polymeric article is made through DCM process by compression molding two layers of polyethylene resin, powder, or flake, one containing 0.3 or 0.5 wt % α-tocopherol and one virgin with no α-tocopherol. The order in which the two resins, powders, or flakes are placed into the mold determines which faces of the polymeric article are α-tocopherol poor and the thickness of the α-tocopherol-poor region is determined by the amount of virgin resin, powder, or flake used. This polymeric article is subsequently irradiated, doped with α-tocopherol, homogenized, machined on one or more of the faces to shape a polymeric implant, packaged and sterilized.

In some embodiments, the α-tocopherol-rich region is molded from a blend of α-tocopherol-containing resin, powder, or flake and virgin polyethylene resin, powder, or flake.

In some embodiments, the resin, powder, or flake containing α-tocopherol and the virgin polyethylene resin, powder, or flake are dry-mixed prior to molding, thereby creating a distribution of α-tocopherol-rich and α-tocopherol-poor regions throughout the polymeric article.

In some embodiments, the virgin polymeric region is confined to the articular bearing surface of the implant.

In some embodiments, the resin, powder, or flake containing α-tocopherol undergoes partial or complete consolidation prior to the DCM process. This preformed piece of α-tocopherol-containing polymeric material allows more precise control over the spatial distribution of α-tocopherol in the finished part. For example, the partially or completely consolidated resin, powder, or flake is placed in a mold surrounded by virgin resin, powder, or flake and further consolidated, creating a polymeric article with an α-tocopherol-poor region on the outer shell and α-tocopherol-rich region in the bulk of the polymeric article.

In another embodiment a polymeric component is fabricated through DCM as described above with spatially-controlled α-tocopherol-rich and α-tocopherol-poor regions. This component is subsequently treated by e-beam irradiation. E-beam irradiation is known to have a gradient cross-linking effect in the direction of the irradiation, but this is not always optimized in components which have curved surfaces, such as acetabular cups, where the cross-linking is different at different points on the articulating surface. The spatial distribution of α-tocopherol-rich regions is used in conjunction with e-beam irradiation to create uniform surface cross-linking which gradually decreases to minimal cross-linking in the bulk. After irradiation, the polymeric component is doped with α-tocopherol. This component is cross-linked and stabilized at the surface and transitions to the uncross-linked and stabilized material with increasing depth from the surface.

In some embodiments the vitamin-E/polymeric material blended resin, powder, or flake mixture has a very high vitamin-E concentration such that when this resin, powder, or flake mixture is consolidated with neat resin, powder, or flake there is a steep gradient of vitamin-E across the interface. The consolidated piece is then irradiated to cross-link the polymer preferably in the neat α-tocopherol-poor region. Subsequently, the piece is heated to drive diffusion of α-tocopherol from the α-tocopherol-rich bulk region to the α-tocopherol-poor surface region.

In some embodiments, a vitamin-E-polymeric material (for example, UHMWPE) blend and virgin polymeric resin, powder, or flake are molded together to create an interface. The quantities of the blend and/or the virgin resins are tailored to obtain a desired virgin polymeric material thickness. Alternatively, the molded piece/material is machined to obtain the desired thickness of the virgin polymeric layer. The machined-molded piece/material is irradiated followed by:
Either doping with vitamin E and homogenized below the melting point of the polymeric material,
or heated below the melt without doping to eliminate the free radicals (for example, for different durations),
or heated below the melt for long enough duration, to diffuse the bulk vitamin E from the blend layer into the virgin layer (for example, for different durations, different blend compositions are used to accelerate the diffusion from the blend region to the virgin region),
or high pressure crystallized/annealed, thereby forming a medical device. The medical device can be used at this stage or can be machined further to remove any oxidized surface layers to obtain a net shaped implant. The device/implant also can be packaged and sterilized.

In another embodiment, the antioxidant-doped or -blended polymeric material is homogenized at a temperature below the melting point of the polymeric material for a desired period of time, for example, the antioxidant-doped or -blended polymeric material is homogenized for about an hour to several days to one week or more than one week at room temperature to about 135° C. to 137° C. (for example for UHMWPE). Preferably, the homogenization is carried out above room temperature, preferably at about 90° C. to about 135° C., more preferably about 80° C. to about 100° C., more preferably about 120° C. to about 125° C., most preferably about 130° C.

In some embodiments, diffusion of vitamin E can be done by doping in pure antioxidant followed by homogenization. A purpose of homogenization is to make the concentration profile of α-tocopherol throughout the interior of a consolidated polymeric material more spatially uniform. After doping of the polymeric material is completed, the consolidated polymeric material is removed from the bath of α-tocopherol and wiped thoroughly to remove excess α-tocopherol from the surfaces of the polymeric material. The polymeric material is kept in an inert atmosphere (nitrogen, argon, and/or the like) or in air during the homogenization process. The homogenization also can be performed in a chamber with supercritical fluids, such as carbon dioxide or the like.

In another embodiment, the DCM process is conducted with a metal piece that becomes an integral part of the consolidated polymeric article. For example, a combination of α-tocopherol-containing polyethylene resin, powder, or flake and virgin polyethylene resin, powder, or flake is direct compression molded into a metallic acetabular cup or a tibial base plate. The porous tibial metal base plate is placed in the mold, α-tocopherol blended polymeric resin, powder, or flake is added on top and then virgin polymeric resin, powder, or flake is added last, for example. In another embodiment, doping of the article with α-tocopherol carried out after irradiation to stabilize against oxidation. Prior to the DCM consolidation, the pores of the metal piece can be filled with a waxy or plaster substance through half the thickness to achieve polyethylene interlocking through the other unfilled half of the metallic piece. The pore filler is maintained through the irradiation and subsequent α-tocopherol doping steps to prevent infusion of α-tocopherol in to the pores of the metal. In some embodiments, the article is machined after doping to shape an implant.

In another embodiment, there are more than one metal piece integral to the polymeric article.

In another embodiment, one or some or all of the metal pieces integral to the polymeric article is a porous metal piece that allows bone in-growth when implanted into the human body.

In some embodiments, one or some or all of the metal pieces integral to the polymeric article is a non-porous metal piece.

In one embodiment, the consolidated polymeric article is irradiated using ionizing radiation such as gamma, electron-beam, or x-ray to a dose level between about 1 and about 10,000 kGy, preferably about 25 to about 250 kGy, preferably about 50 to about 150 kGy, preferably about 65 kGy, preferably about 85 kGy, or preferably about 100 kGy.

In another embodiment, the irradiated polymeric article is doped with α-tocopherol by placing the article in an α-tocopherol bath at room temperature or at an elevated temperature for a given amount of time.

In another embodiment, the doped polymeric article is heated below the melting point of the polymeric article.

In one embodiment, the metal mesh of the implant is sealed using a sealant to prevent or reduce the infusion of α-tocopherol into the pores of the mesh during the selective doping of the implant. Preferably, the sealant is water soluble. But other sealants are also used. The final cleaning step that the implant is subjected to also removes the sealant. Alternatively, an additional sealant removal step is used. Such sealants as water, saline, aqueous solutions of water soluble polymers such as poly-vinyl alcohol, water soluble waxes, plaster of Paris, or others are used. In addition, a photoresist like SU-8, or other, may be cured within the pores of the porous metal component. Following processing, the sealant may be removed via an acid etch or a plasma etch.

In another embodiment, the polyethylene-porous metal mono-block is doped so that the polymeric material is fully immersed in α-tocopherol but the porous metal is either completely above the α-tocopherol surface or only partially immersed during doping. This reduces infusion of α-tocopherol into the pores of the metal mesh.

In yet another embodiment, the doped polymeric article is machined to form a medical implant. In some embodiments, the machining is carried out on sides with no metallic piece if at least one is present.

In many embodiments, the medical devices are packaged and sterilized.

In another aspect of the invention, the medical device is cleaned before packaging and sterilization.

In other embodiments, the antioxidant, such as vitamin E, concentration profiles in implant components can be controlled in several different ways, following various processing steps and in different orders, for example:
I. Blending the antioxidant and polyethylene resin, powder, or flakes, consolidating the blend, machining of implants, radiation cross-linking (at a temperature below the melting point of the polymeric material), and doping with the antioxidant;
II. Blending the antioxidant and polyethylene resin, powder, or flakes, consolidating the blend, machining of implants, radiation cross-linking (at a temperature below the melting point of the polymeric material), doping with the antioxidant and homogenizing;
III. Blending the antioxidant and polyethylene resin, powder, or flakes, consolidating the blend, machining of implants, radiation cross-linking (at a temperature below the melting point of the polymeric material), doping with the antioxidant and homogenizing, extracting/eluting out the excess antioxidant or at least a portion of the antioxidant;
IV. Blending the antioxidant and polyethylene resin, powder, or flakes, consolidating the blend, machining of preforms, radiation cross-linking (at a temperature below the melting point of the polymeric material), doping with the antioxidant, machining of implants;
V. Blending the antioxidant and polyethylene resin, powder, or flakes, consolidating the blend, machining of preforms, radiation cross-linking (at a temperature below the melting point of the polymeric material), doping with the antioxidant and homogenizing, machining of implants;
VI. Blending the antioxidant and polyethylene resin, powder, or flakes, consolidating the blend, machining of preforms, radiation cross-linking (at a temperature below the melting point of the polymeric material), doping with the antioxidant and homogenizing, machining of implants, extraction of the antioxidant;
VII. Radiation cross-linking of consolidated polymeric material (at a temperature below the melting point of the polymeric material), machining implant, doping with the antioxidant, extracting/eluting out the excess antioxidant or at least a portion of the antioxidant;
VIII. Radiation cross-linking of consolidated polymeric material (at a temperature below the melting point of the polymeric material), machining implants, doping with the antioxidant and homogenizing, extracting/eluting out the excess antioxidant or at least a portion of the antioxidant;
IX. Radiation cross-linking of consolidated polymeric material (at a temperature below the melting point of the polymeric material), machining prefoms, doping with the antioxidant, extraction of the antioxidant, machining of implants;
X. Radiation cross-linking of consolidated polymeric material (at a temperature below the melting point of the polymeric material), machining prefoms, doping with the antioxidant and homogenizing, extracting/eluting out the excess antioxidant or at least a portion of the antioxidant, machining of implants;
XI. Radiation cross-linking of consolidated polymeric material (at a temperature below the melting point of the polymeric material), machining prefoms, doping with the antioxidant, machining of implants, extracting/eluting out the excess antioxidant or at least a portion of the antioxidant; and/or
XII. Radiation cross-linking of consolidated polymeric material (at a temperature below the melting point of the polymeric material), machining prefoms, doping with the antioxidant and homogenizing, machining of implants, homogenizing, extracting/eluting out the excess antioxidant or at least a portion of the antioxidant.

In another embodiment, all of the above processes are further followed by cleaning, packaging and sterilization (gamma irradiation, e-beam irradiation, ethylene oxide or gas plasma sterilization).

Methods and Sequence of Irradiation:

The selective, controlled manipulation of polymers and polymer alloys using radiation chemistry can, in another aspect, be achieved by the selection of the method by which the polymer is irradiated. The particular method of irradiation employed, either alone or in combination with other aspects of the invention, such as the polymer or polymer alloy chosen, contribute to the overall properties of the irradiated polymer.

Gamma irradiation or electron radiation may be used. In general, gamma irradiation results in a higher radiation penetration depth than electron irradiation. Gamma irradiation, however, generally provides low radiation dose rate and requires a longer duration of time, which can result in more in-depth and extensive oxidation, particularly if the gamma irradiation is carried out in air. Oxidation can be reduced or prevented by carrying out the gamma irradiation in an inert gas, such as nitrogen, argon, neon, or helium, or under vacuum. Electron irradiation, in general, results in more limited dose penetration depth, but requires less time and, therefore, reduces the risk of extensive oxidation if the irradiation is carried out in air. In addition if the desired dose levels are high, for instance 20 Mrad, the irradiation with gamma may take place over one day, leading to impractical production times. On the other hand, the dose rate of the electron beam can be adjusted by varying the irradiation parameters, such as conveyor speed, scan width, and/or beam power. With the appropriate parameters, a 20 Mrad melt-irradiation can be completed in for instance less than 10 minutes. The penetration of the electron beam depends on the beam energy measured by million electron-volts (MeV). Most polymers exhibit a density of about 1 g/cm³, which leads to the penetration of about 1 cm with a beam energy of 2-3 MeV and about 4 cm with a beam energy of 10 MeV. If electron irradiation is preferred, the desired depth of penetration can be adjusted based on the beam energy. Accordingly, gamma irradiation or electron irradiation may be used based upon the depth of penetration preferred, time limitations and tolerable oxidation levels.

According to certain embodiments, the cross-linked polymeric material can have a melt history, meaning that the polymeric material is melted concurrently with or subsequent to irradiation for cross-linking. According to other embodiments, the cross-linked polymeric material has no such melt history.

Various irradiation methods including IMS, CIR, CISM, WIR, and WIAM are defined and described in greater detail below for cross-linked polymeric materials with a melt history, that is irradiated with concurrent or subsequent melting:

(i) Irradiation in the Molten State (IMS):

Melt-irradiation (MIR), or irradiation in the molten state (“IMS”), is described in detail in U.S. Pat. No. 5,879,400. In the IMS process, the polymer to be irradiated is heated to at or above its melting point. Then, the polymer is irradiated. Following irradiation, the polymer is cooled.

Prior to irradiation, the polymer is heated to at or above its melting temperature and maintained at this temperature for a time sufficient to allow the polymer chains to achieve an entangled state. A sufficient time period may range, for example, from about 5 minutes to about 3 hours.

Gamma irradiation or electron radiation may be used. In general, gamma irradiation results in a higher radiation penetration depth than electron irradiation. Gamma irradiation, however, generally provides low radiation dose rate and requires a longer duration of time, which can result in more in-depth oxidation, particularly if the gamma irradiation is carried out in air. Oxidation can be reduced or prevented by carrying out the gamma irradiation in an inert gas, such as nitrogen, argon, neon, or helium, or under vacuum. Electron irradiation, in general, results in more limited dose penetration depth, but requires less time and, therefore, reduces the risk of extensive oxidation if the irradiation is carried out in air. In addition if the desired dose levels are high, for instance 20 Mrad, the irradiation with gamma may take place over one day, leading to impractical production times. On the other hand, the dose rate of the electron beam can be adjusted by varying the irradiation parameters, such as conveyor speed, scan width, and/or beam power. With the appropriate parameters, a 20 Mrad melt-irradiation can be completed in for instance in less than 10 minutes. The penetration of the electron beam depends on the beam energy measured by million electron-volts (MeV). Most polymers exhibit a density of about 1 g/cm³, which leads to the penetration of about 1 cm with a beam energy of 2-3 MeV and about 4 cm with a beam energy of 10 MeV. The penetration of e-beam is known to increase slightly with increased irradiation temperatures. If electron irradiation is preferred, the desired depth of penetration can be adjusted based on the beam energy. Accordingly, gamma irradiation or electron irradiation may be used based upon the depth of penetration preferred, time limitations and tolerable oxidation levels.

The temperature of melt-irradiation for a given polymer depends on the DSC (measured at a heating rate of 10° C./min during the first heating cycle) peak melting temperature (“PMT”) for that polymer. In general, the irradiation temperature in the IMS process is at least about 2° C. higher than the PMT, more preferably between about 2° C. and about 20° C. higher than the PMT, and most preferably between about 5° C. and about 10° C. higher than the PMT.

Exemplary ranges of acceptable total dosages are disclosed in greater detail in U.S. Pat. Nos. 5,879,400, and 6,641,617, and International Application WO 97/29793. For example, preferably a total dose of about or greater than 1 MRad is used. More preferably, a total dose of greater than about 20 Mrad is used.

In electron beam IMS, some energy deposited by the electrons is converted to heat. This primarily depends on how well the sample is thermally insulated during the irradiation. With good thermal insulation, most of the heat generated is not lost to the surroundings and leads to the radiation generated heating (including adiabatic and partially adiabatic) of the polymer to a higher temperature than the irradiation temperature. The heating could also be induced by using a high enough dose rate to minimize the heat loss to the surroundings. In some circumstance, heating may be detrimental to the sample that is being irradiated. Gaseous by-products, such as hydrogen gas when the polymer is irradiated, are formed during the irradiation. During irradiation, if the heating is rapid and high enough to cause rapid expansion of the gaseous by-products, and thereby not allowing them to diffuse out of the polymer, the polymer may cavitate. The cavitation is not desirable in that it leads to the formation of defects (such as air pockets, cracks) in the structure that could in turn adversely affect the mechanical properties of the polymer and in vivo performance of the device made thereof.

The temperature rise depends on the dose level, level of insulation, and/or dose rate. The dose level used in the irradiation stage is determined based on the desired properties. In general, the thermal insulation is used to avoid cooling of the polymer and maintaining the temperature of the polymer at the desired irradiation temperature. Therefore, the temperature rise can be controlled by determining an upper dose rate for the irradiation.

In embodiments of the present invention in which electron radiation is utilized, the energy of the electrons can be varied to alter the depth of penetration of the electrons, thereby controlling the degree of cross-linking following irradiation. The range of suitable electron energies is disclosed in greater detail in U.S. Pat. Nos. 5,879,400, 6,641,617, and International Application WO 97/29793. In one embodiment, the energy is about 0.5 MeV to about 12 MeV. In another embodiment the energy is about 1 MeV to 10 MeV. In another embodiment, the energy is about 10 MeV.

(ii) Cold Irradiation (CIR):

Cold irradiation is described in detail in U.S. Pat. No. 6,641,617, U.S. Pat. No. 6,852,772, and WO 97/29793. In the cold irradiation process, a polymer is provided at room temperature or below room temperature. Preferably, the temperature of the polymer is about 20° C. Then, the polymer is irradiated. In one embodiment of cold irradiation, the polymer may be irradiated at a high enough total dose and/or at a fast enough dose rate to generate enough heat in the polymer to result in at least a partial melting of the crystals of the polymer.

Gamma irradiation or electron radiation may be used. In general, gamma irradiation results in a higher dose penetration depth than electron irradiation. Gamma irradiation, however, generally requires a longer duration of time, which can result in more in-depth oxidation, particularly if the gamma irradiation is carried out in air. Oxidation can be reduced or prevented by carrying out the gamma irradiation in an inert gas, such as nitrogen, argon, neon, or helium, or under vacuum. Electron irradiation, in general, results in more limited dose penetration depths, but requires less time and, therefore, reduces the risk of extensive oxidation. Accordingly, gamma irradiation or electron irradiation may be used based upon the depth of penetration preferred, time limitations and tolerable oxidation levels.

The total dose of irradiation may be selected as a parameter in controlling the properties of the irradiated polymer. In particular, the dose of irradiation can be varied to control the degree of cross-linking in the irradiated polymer. The preferred dose level depends on the molecular weight of the polymer and the desired properties that can be achieved following irradiation. In general, increasing the dose level with CIR leads to an increase in wear resistance.

Exemplary ranges of acceptable total dosages are disclosed in greater detail in U.S. Pat. Nos. 6,641,617 and 6,852,772, International Application WO 97/29793, and in the embodiments below. In one embodiment, the total dose is about 0.5 MRad to about 1,000 Mrad. In another embodiment, the total dose is about 1 MRad to about 100 MRad. In yet another embodiment, the total dose is about 4 MRad to about 30 MRad. In still other embodiments, the total dose is about 20 MRad or about 15 MRad.

If electron radiation is utilized, the energy of the electrons also is a parameter that can be varied to tailor the properties of the irradiated polymer. In particular, differing electron energies results in different depths of penetration of the electrons into the polymer. The practical electron energies range from about 0.1 MeV to 16 MeV giving approximate iso-dose penetration levels of 0.5 mm to 8 cm, respectively. A preferred electron energy for maximum penetration is about 10 MeV, which is commercially available through vendors such as Studer (Daniken, Switzerland) or E-Beam Services (New Jersey, USA). The lower electron energies may be preferred for embodiments where a surface layer of the polymer is preferentially cross-linked with gradient in cross-link density as a function of distance away from the surface.

(iii) Warm Irradiation (WIR):

Warm irradiation is described in detail in U.S. Pat. No. 6,641,617 and WO 97/29793. In the warm irradiation process, a polymer is provided at a temperature above room temperature and below the melting temperature of the polymer. Then, the polymer is irradiated. In one embodiment of warm irradiation, which has been termed “warm irradiation adiabatic melting” or “WIAM.” In a theoretical sense, adiabatic means an absence of heat transfer to the surroundings. In a practical sense, such heating can be achieved by the combination of insulation, irradiation dose rates and irradiation time periods, as disclosed herein and in the documents cited herein. However, there are situations where irradiation causes heating, but there is still a loss of energy to the surroundings. Also, not all warm irradiation refers to an adiabatic. Warm irradiation also can have non-adiabatic or partially (such as about 10-75% of the heat generated is lost to the surroundings) adiabatic heating. In all embodiments of WIR, the polymer may be irradiated at a high enough total dose and/or a high enough dose rate to generate enough heat in the polymer to result in at least a partial melting of the crystals of the polymer, meaning some but not all molecules transition from the crystalline to the amorphous state.

The polymer may be provided at any temperature below its melting point but preferably above room temperature. The temperature selection depends on the specific heat and the enthalpy of melting of the polymer and the total dose level used. The equation provided in U.S. Pat. No. 6,641,617 and International Application WO 97/29793 may be used to calculate the preferred temperature range with the criterion that the final temperature of polymer maybe below or above the melting point. Preheating of the polymer to the desired temperature may be done in an inert (such as under nitrogen, argon, neon, or helium, or the like, or a combination thereof) or non-inert environment (such as air).

In general terms, the pre-irradiation heating temperature of the polymer can be adjusted based on the peak melting temperature (PMT) measure on the DSC at a heating rate of 10° C./min during the first heat. In one embodiment the polymer is heated to about 20° C. to about PMT. In another embodiment, the polymer is pre-heated to about 90° C. In another embodiment, the polymer is heated to about 100° C. In another embodiment, the polymer is pre-heated to about 30° C. below PMT and 2° C. below PMT. In another embodiment, the polymer is pre-heated to about 12° C. below PMT.

In the WIAM embodiment of WIR, the temperature of the polymer following irradiation is at or above the melting temperature of the polymer. Exemplary ranges of acceptable temperatures following irradiation are disclosed in greater detail in U.S. Pat. No. 6,641,617 and International Application WO 97/29793. In one embodiment, the temperature following irradiation is about room temperature to PMT, or about 40° C. to PMT, or about 100° C. to PMT, or about 110° C. to PMT, or about 120° C. to PMT, or about PMT to about 200° C. These temperature ranges depend on the polymer's PMT and is much higher with reduced level of hydration. In another embodiment, the temperature following irradiation is about 145° C. to about 190° C. In yet another embodiment, the temperature following irradiation is about 145° C. to about 190° C. In still another embodiment, the temperature following irradiation is about 150° C.

In WIR, gamma irradiation or electron radiation may be used. In general, gamma irradiation results in a higher dose penetration depth than electron irradiation. Gamma irradiation, however, generally requires a longer duration of time, which can result in more in-depth oxidation, particularly if the gamma irradiation is carried out in air. Oxidation can be reduced or prevented by carrying out the gamma irradiation in an inert gas, such as nitrogen, argon, neon, or helium, or under vacuum. Electron irradiation, in general, results in more limited dose penetration depths, but requires less time and, therefore, reduces the risk of extensive oxidation. Accordingly, gamma irradiation or electron irradiation may be used based upon the depth of penetration preferred, time limitations and tolerable oxidation levels. In the WIAM embodiment of WIR, electron radiation is used.

The total dose of irradiation may also be selected as a parameter in controlling the properties of the irradiated polymer. In particular, the dose of irradiation can be varied to control the degree of cross-linking in the irradiated polymer. Exemplary ranges of acceptable total dosages are disclosed in greater detail in U.S. Pat. No. 6,641,617 and International Application WO 97/29793.

The dose rate of irradiation also may be varied to achieve a desired result. The dose rate is a prominent variable in the WIAM process. The preferred dose rate of irradiation would be to administer the total desired dose level in one pass under the electron-beam. One also can deliver the total dose level with multiple passes under the beam, delivering a (equal or unequal) portion of the total dose at each time. This would lead to a lower effective dose rate.

Ranges of acceptable dose rates are exemplified in greater detail in U.S. Pat. No. 6,641,617 and International Application WO 97/29793. In general, the dose rates vary between 0.5 Mrad/pass and 50 Mrad/pass. The upper limit of the dose rate depends on the resistance of the polymer to cavitation/cracking induced by the irradiation.

If electron radiation is utilized, the energy of the electrons also is a parameter that can be varied to tailor the properties of the irradiated polymer. In particular, differing electron energies result in different depths of penetration of the electrons into the polymer. The practical electron energies range from about 0.1 MeV to 16 MeV giving approximate iso-dose penetration levels of 0.5 mm to 8 cm, respectively. The preferred electron energy for maximum penetration is about 10 MeV, which is commercially available through vendors such as Studer (Daniken, Switzerland) or E-Beam Services New Jersey, USA). The lower electron energies may be preferred for embodiments where a surface layer of the polymer is preferentially cross-linked with gradient in cross-link density as a function of distance away from the surface.

(iv) Subsequent Melting (SM)—Substantial Elimination of Detectable Residual Free Radicals:

Depending on the polymer or polymer alloy used, and whether the polymer was irradiated below its melting point, there may be residual free radicals left in the material following the irradiation process. A polymer irradiated below its melting point with ionizing radiation contains cross-links as well as long-lived trapped free radicals. Some of the free radicals generated during irradiation become trapped in the crystalline regions and/or at crystalline lamellae surfaces leading to oxidation-induced instabilities in the long-term (see Kashiwabara, H. S. Shimada, and Y. Hori, Radiat. Phys. Chem., 1991, 37(1): p. 43-46; Jahan, M. S. and C. Wang, Journal of Biomedical Materials Research, 1991, 25: p. 1005-1017; Sutula, L. C., et al., Clinical Orthopedic Related Research, 1995, 3129: p. 1681-1689.). The elimination of these residual, trapped free radicals through heating can be, therefore, desirable in precluding long-term oxidative instability of the polymer. Jahan M. S. and C. Wang, Journal of Biomedical Materials Research, 1991, 25: p. 1005-1017; Sutula, L. C., et al., Clinical Orthopedic Related Research, 1995, 319: p. 28-4.

Residual free radicals may be reduced by heating the polymer above the melting point of the polymer used. The heating allows the residual free radicals to recombine with each other. If for a given system the preform does not have substantially any detectable residual free radicals following irradiation, then a later heating step may be omitted. Also, if for a given system the concentration of the residual free radicals is low enough to not lead to degradation of device performance, the heating step may be omitted.

The reduction of free radicals to the point where there are substantially no detectable free radicals can be achieved by heating the polymer to above the melting point. The heating provides the molecules with sufficient mobility so as to eliminate the constraints derived from the crystals of the polymer, thereby allowing essentially all of the residual free radicals to recombine. Preferably, the polymer is heated to a temperature between the peak melting temperature (PMT) and degradation temperature (T_{d}) of the polymer, more preferably between about 3° C. above PMT and T_{d}, more preferably between about 10° C. above PMT and 50° C. above PMT, more preferably between about 10° C. and 12° C. above PMT and most preferably about 15° C. above PMT.

In certain embodiments, there may be an acceptable level of residual free radicals in which case, the post-irradiation annealing also can be carried out below the melting point of the polymer, the effects of such free radicals can be minimized or eliminated by an antioxidant.

(v) Sequential Irradiation:

The polymer is irradiated with either gamma or e-beam radiation in a sequential manner. With e-beam the irradiation is carried out with multiple passes under the beam and with gamma radiation the irradiation is carried out in multiple passes through the gamma source. Optionally, the polymer is thermally treated in between each or some of the irradiation passes. The thermal treatment can be heating below the melting point or at the melting point of the polymer. The irradiation at any of the steps can be warm irradiation, cold irradiation, or melt irradiation, or any combination thereof. For example the polymer is irradiated with 30 kGy at each step of the cross-linking and it is first heated to about 120° C. and then annealed at about 120° C. for about 5 hours after each irradiation cycle.

(vi) Blending and Doping:

As stated above, the cross-liked polymeric material can optionally have a melt history, meaning it is melted concurrent with or subsequent to irradiation. The polymeric material can be blended with an antioxidant prior to consolidation and irradiation. Also, the consolidated polymeric material can be doped with an antioxidant prior to or after irradiation, and optionally can have been melted concurrent with or subsequent to irradiation. Furthermore, a polymeric material can both be blended with an antioxidant prior to consolidation and doped with an antioxidant after consolidation (before or after irradiation and optional melting). The polymeric material can be subjected to extraction at different times during the process, and can be extracted multiple times as well.

The polymeric material can be blended with any of the antioxidants, including alpha-tocopherol (such as vitamin E), delta-tocopherol; propyl, octyl, or dedocyl gallates; lactic, citric, ascorbic, tartaric acids, and organic acids, and their salts; orthophosphates; tocopherol acetate; lycopene; or a combination thereof.

### Definitions and Other Embodiments

The term “toughness” of a material refers to its ability to distribute an applied stress such that failure does not occur until very high stresses. It is quantified by the area under the stress-strain curve of a material. For example, a higher work-to-failure, which is the area under the engineering stress-strain curve obtained from tensile mechanical testing is attributed directly to increased toughness.

“Ductility” refers to the ability of a material to plastically deform under stress. Ductility can be quantified as the total energy absorbed by plastic deformation; i.e. the area under the curve of the plastic segment of the engineering stress-strain curve. In the examples, increased elongation to break is attributed to increased ductility since the yield strength of these materials are relatively similar.

“Antioxidant” refers to what is known in the art as (see, for example, WO 01/80778, U.S. Pat. No. 6,448,315). Alpha- and delta-tocopherol; propyl, octyl, or dedocyl gallates; lactic, citric, ascorbic, tartaric acids, and organic acids, and their salts; orthophosphates, lycopene, tocopherol acetate are generally known form of antioxidants. Antioxidants are also referred as free radical scavengers, include: glutathione, lipoic acid, vitamins such as ascorbic acid (vitamin C), vitamin B, vitamin D, vitamin-E, tocopherols (synthetic or natural, alpha-, gamma-, delta-), acetate vitamin esters, water soluble tocopherol derivatives, tocotrienols, water soluble tocotrienol derivatives; melatonin, carotenoids, including various carotenes, lutein, pycnogenol, glycosides, trehalose, polyphenols and flavonoids, quercetin, lycopene, lutein, selenium, nitric oxide, curcuminoids, 2-hydroxytetronic acid; cannabinoids, synthetic antioxidants such as tertiary butyl hydroquinone, 6-amino-3-pyrodinoles, butylated hydroxyanisole, butylated hydroxytoluene, ethoxyquin, tannins, propyl gallate, other gallates, Aquanox family; IRGANOX® and IRGANOX® B families including IRGANOX® 1010, IRGANOX® 1076, IRGANOX® 1330; phenolic compounds with different chain lengths, and different number of OH groups; enzymes with antioxidant properties such as superoxide dismutase, herbal or plant extracts with antioxidant properties such as St. John's Wort, green tea extract, grape seed extract, rosemary, oregano extract, mixtures, derivatives, analogues or conjugated forms of these. Antioxidants/free radical scavengers can be primary antioxidants with reactive OH or NH groups such as hindered phenols or secondary aromatic amines, they can be secondary antioxidants such as organophosphorus compounds or thiosynergists, they can be multifunctional antioxidants, hydroxylamines, or carbon centered radical scavengers such as lactones or acrylated bis-phenols. The antioxidants can be selected individually or used in any combination.

“Supercritical fluid” refers to what is known in the art, for example, supercritical propane, acetylene, carbon dioxide (CO₂). In this connection the critical temperature is that temperature above which a gas cannot be liquefied by pressure alone. The pressure under which a substance may exist as a gas in equilibrium with the liquid at the critical temperature is the critical pressure. Supercritical fluid condition generally means that the fluid is subjected to such a temperature and such a pressure that a supercritical fluid and thereby a supercritical fluid mixture is obtained, the temperature being above the supercritical temperature, which for CO₂ is 31.3° C., and the pressure being above the supercritical pressure, which for CO, is 73.8 bar. More specifically, supercritical condition refers to a condition of a mixture, for example, UHMWPE with an antioxidant, at an elevated temperature and pressure, when a supercritical fluid mixture is formed; and then evaporate CO₂ from the mixture, UHMWPE doped with an antioxidant is obtained (see, for example, U.S. Pat. No. 6,448,315 and WO 02/26464). Other supercritical fluids can be chosen from the group of water, chloroform, nitric oxide, elementary gasses such as argon, nitrogen, organic compounds such as acetic acid, benzene, ethanol, ethylene oxide, methanol, methyl ethyl ketone, monolefins such as ethylene, propylene, or paraffins such as ethane, methane, propane, n-butane, n-heptane. A co-solvent or a mixture of fluids can be used. Some supercritical fluids are used to diffuse or extract antioxidants in subcritical conditions.

The term “compression molding” as referred herein related generally to what is known in the art and specifically relates to molding polymeric material wherein polymeric material is in any physical state, including resin, powder, or flake form, is compressed into a slab form or mold of a medical implant, for example, a tibial insert, an acetabular liner, a glenoid liner, a patella, or an unicompartmental insert, an interpositional device for any joint can be machined.

The term “direct compression molding” (DCM) as referred herein related generally to what is known in the art and specifically relates to molding applicable in polyethylene-based devices, for example, medical implants wherein polyethylene in any physical state, including resin, powder, or flake form, is compressed to solid support, for example, a metallic back, metallic mesh, or metal surface containing grooves, undercuts, or cutouts. The compression molding also includes compression molding of polyethylene at various states, including resin, powder, flakes and particles, to make a component of a medical implant, for example, a tibial insert, an acetabular liner, a glenoid liner, a patella, an interpositional device for any joint or an unicompartmental insert.

The term “Mechanical deformation” refers to a deformation taking place below the melting point of the material, essentially ‘cold-working’ the material. The deformation modes include uniaxial, channel flow, uniaxial compression, biaxial compression, oscillatory compression, tension, uniaxial tension, biaxial tension, ultra-sonic oscillation, bending, plane stress compression (channel die), torsion or a combination of any of the above. The deformation could be static or dynamic. The dynamic deformation can be a combination of the deformation modes in small or large amplitude oscillatory fashion. Ultrasonic frequencies can be used. All deformations can be performed in the presence of sensitizing gases and/or at elevated temperatures.

The term “mechanical annealing” refers to a process that results in the mechanical deformation. Mechanical annealing can be carried out in various ways, including but not limited to, holding a polymeric material or a polymeric blend at a deformed state, holding the polymeric material at the deformed state then releasing the load, mechanically deforming and then releasing the load.

The term “deformed state” refers to a state of the polymeric material following a deformation process, such as a mechanical deformation, as described herein, at solid or at melt. Following the deformation process, deformed polymeric material at a solid state or at melt is be allowed to cool down. In some cases if the polymeric material or polymeric blend is completely or partially molten it is allowed to solidify/crystallize while still maintains the deformed shape or the newly acquired deformed state. In other cases the polymeric material or polymeric blend is heated and deformed and allowed to cool down in the deformed shape or the newly acquired deformed state, including all types of deformed states of the polymeric material following a deformation process, as described herein.

The term “cyclic deformation” refers to what is known in the field, as polymers undergo cyclic or dynamic deformation under various, and often repetitive, environmental and induced conditions, stresses, pressures, and forces. Cyclic deformation of a polymer also is influenced by the physical and structural characteristics of the polymer, such as viscoelasticity of the polymer. In this context, during cyclic deformation, due to or as a result of the cyclic deformation, polymeric materials become susceptible to oxidation.

“IBMA” refers to irradiation below the melt and mechanical annealing. “IBMA” was formerly referred to as “CIMA” (Cold Irradiation and Mechanically Annealed).

The term “mechanically interlocked” refers generally to interlocking of polymeric material and the counterface, that are produced by various methods, including compression molding, heat and irradiation, thereby forming an interlocking interface, resulting into a ‘shape memory’ of the interlocked polymeric material. Components of a device having such an interlocking interface can be referred to as a “hybrid material”. Medical implants having such a hybrid material contain a substantially sterile interface.

The term “substantially sterile” refers to a condition of an object, for example, an interface or a hybrid material or a medical implant containing interface(s), wherein the interface is sufficiently sterile to be medically acceptable, i.e., will not cause an infection or require revision surgery.

“Metallic mesh” refers to a porous metallic surface of various pore sizes, for example, 0.1-3 mm. The porous surface can be obtained through several different methods, for example, sintering of metallic powder with a binder that is subsequently removed to leave behind a porous surface; sintering of short metallic fibers of diameter 0.1-3 mm; or sintering of different size metallic meshes on top of each other to provide an open continuous pore structure.

“Bone cement” refers to what is known in the art as an adhesive used in bonding medical devices to bone. Typically, bone cement is made out of polymethylmethacrylate (PMMA). Bone cement can also be made out of calcium phosphate.

“Shape memory” refers to what is known in the art as the property of polymeric material, for example, an UHMWPE, that attains a preferred high entropy shape when melted. The preferred high entropy shape is achieved when the resin, powder, or flake is consolidated through compression molding.

The phrase “substantially no detectable residual free radicals” refers to a state of a polymeric component, wherein enough free radicals are eliminated to avoid oxidative degradation, which can be evaluated by electron spin resonance (ESR). The phrase “detectable residual free radicals” refers to the lowest level of free radicals detectable by ESR or more. The lowest level of free radicals detectable with state-of-the-art instruments is about 10¹⁴ spins/gram and thus the term “detectable” refers to a detection limit of 10¹⁴ spins/gram by ESR.

The terms “about” or “approximately” in the context of numerical values and ranges refers to values or ranges that approximate or are close to the recited values or ranges such that the invention can perform as intended, such as having a desired degree of cross-linking and/or a desired lack of or quenching of free radicals, as is apparent to the skilled person from the teachings contained herein. This is due, at least in part, to the varying properties of polymer compositions. Thus, these terms encompass values beyond those resulting from systematic error. These terms make explicit what is implicit.

All ranges set forth herein in the summary and description of the invention include all numbers or values thereabout or therebetween of the numbers of the range. The ranges of the invention expressly denominate and set forth all integers, decimals and fractional values in the range. For example, the radiation dose can be about 50 kGy, about 65 kGy, about 75 kGy, about 100 kGy, about 200 kGy, about 300 kGy, about 400 kGy, about 500 kGy, about 600 kGy, about 700 kGy, about 800 kGy, about 900 kGy, or about 1000 kGy, or above 1000 kGy, or any integer, decimal or fractional value thereabout or therebetween. The term “about” can be used to describe a range.

The term “initiated”, as used herein, in the context of lipid-initiated or cyclic deformation-initiated oxidation, generally refers to the cause start and/or commencement of an event, effect and/or result.

“Polymeric materials” or “polymer” include polyethylene, for example, Ultra-high molecular weight polyethylene (UHMWPE) refers to linear non-branched chains of ethylene having molecular weights in excess of about 500,000, preferably above about 1,000,000, and more preferably above about 2,000,000. Often the molecular weights can reach about 8,000,000 or more. By initial average molecular weight is meant the average molecular weight of the UHMWPE starting material, prior to any irradiation. See U.S. Pat. No. 5,879,400, PCT/US99/16070, filed on Jul. 16, 1999, and PCT/US97/02220, filed Feb. 11, 1997. The term “polyethylene article” or “polymeric article” or “polymer” generally refers to articles comprising any “polymeric material” disclosed herein.

“Polymeric materials” or “polymer” also include hydrogels, such as poly (vinyl alcohol), poly (acrylamide), poly (acrylic acid), poly(ethylene glycol), blends thereof, or interpenetrating networks thereof, which can absorb water such that water constitutes at least 1 to 10,000% of their original weight, typically 100 wt % of their original weight or 99% or less of their weight after equilibration in water.

“Polymeric material” or “polymer” can be in the form of resin, flakes, powder, consolidated stock, implant, and can contain additives such as antioxidant(s). The “polymeric material” or “polymer” also can be a blend of one or more of different resin, flakes or powder containing different concentrations of an additive such as an antioxidant. The blending of resin, flakes or powder can be achieved by the blending techniques known in the art. The “polymeric material” also can be a consolidated stock of these blends.

“Blending” generally refers to mixing of a polymer in its pre-consolidated form (e.g., flakes, powder, particles, resin) with one or more additive. If both constituents are solid, blending can be done by using a third component such as a liquid to mediate the mixing of the two components, after which the liquid is removed by evaporating. If the additive is liquid, for example α-tocopherol, then the solid can be mixed with large quantities of liquid, then diluted down to desired concentrations with the solid polymer to obtain uniformity in the blend. In the case where an additive is also an antioxidant, for example vitamin E, or α-tocopherol, then blended polymeric material is also antioxidant-doped. Polymeric material, as used herein, also applies to blends of a polyolefin and a plasticizing agent, for example a blend of UHMWPE resin powder blended with α-tocopherol and consolidated. Polymeric material, as used herein, also applies to blends of an additive, a polyolefin and a plasticizing agent, for example UHMWPE soaked in α-tocopherol.

In one embodiment UHMWPE flakes are blended with α-tocopherol; preferably the UHMWPE/α-tocopherol blend is heated to diffuse the α-tocopherol into the flakes. The UHMWPE/α-tocopherol blend is further blended with virgin UHMWPE flakes to obtain a blend of UHMWPE flakes where some flakes are poor in α-tocopherol and others are rich in α-tocopherol. This blend is then consolidated and irradiated. During irradiation the α-tocopherol poor regions are more highly cross-linked than the α-tocopherol poor regions. Following irradiation the blend is homogenized to diffuse α-tocopherol from the α-tocopherol rich to α-tocopherol poor regions and achieve oxidative stability throughout the polymer.

The products and processes of this invention also apply to various types of polymeric materials, for example, any polypropylene, any polyamide, any polyether ketone, polyurethanes, polycarbonate urethanes, polycarbonates, or any polyolefin, including high-density-polyethylene, low-density-polyethylene, linear-low-density-polyethylene, ultra-high molecular weight polyethylene (UHMWPE), copolymers or mixtures thereof. The products and processes of this invention also apply to various types of hydrogels, for example, poly(vinyl alcohol), poly(ethylene glycol), poly(ethylene oxide), poly(acrylic acid), poly(methacrylic acid), poly(acrylamide), copolymers or mixtures thereof, or copolymers or mixtures of these with any polyolefin. Polymeric materials, as used herein, also applies to polyethylene of various forms, for example, resin, powder, flakes, particles, powder, or a mixture thereof, or a consolidated form derived from any of the above. Polymeric materials, as used herein, also applies to hydrogels of various forms, for example, film, extrudate, flakes, particles, powder, or a mixture thereof, or a consolidated form derived from any of the above.

The term “additive” refers to any material that can be added to a base polymer in less than 50 v/v %. This material can be organic or inorganic material with a molecular weight less than that of the base polymer. An additive can impart different properties to the polymeric material, for example, it can be a plasticizing agent, a nucleating agent, or an antioxidant.

The term “plasticizing agent” refers to what is known in the art, a material with a molecular weight less than that of the base polymer, for example vitamin E α-tocopherol) in unirradiated or cross-linked ultrahigh molecular weight polyethylene or low molecular weight polyethylene in high molecular weight polyethylene, in both cases ultrahigh molecular weight polyethylene being the base polymer. The plasticizing agent is typically added to the base polymer in less than about 20 weight percent. The plasticizing agent generally increases flexibility and softens the polymeric material.

The term “plasticization” or “plasticizing” refers to the properties that a plasticizing agent imparts on the polymeric material to which it has been contacted with. These properties may include but are not limited to increased elongation at break, reduced stiffness and increased ductility.

A “nucleating agent” refers to an additive known in the art, an organic or inorganic material with a molecular weight less than that of the base polymer, which increases the rate of crystallization in the polymeric material. Typically, organocarboxylic acid salts, for example calcium carbonate, are good nucleation agents for polyolefins. Also, nucleating agents are typically used in small concentrations such as 0.5 wt %.

The term “lipid” refers to a naturally-occurring, synthetic or semi-synthetic (modified natural) compound which is generally fat-soluble. Lipids are broadly defined as hydrophobic or amphiphilic (containing hydrophobic and hydrophilic components) small molecules that originate entirely or in part from ketoacyl and isoprene groups. Exemplary lipids include, for example, fatty acids, neutral fats, phosphatides, fluorinated lipids, oils, fluorinated oils, glycolipids, surface active agents (surfactants and fluorosurfactants), aliphatic alcohols, waxes, terpenes and steroids. Lipids are typically divided into eight categories: fatty acyls, glycerolipids, glycerophospholipids, sphingolipids, saccharolipids, polyketides, sterol lipids and prenol lipids. The phrase semi-synthetic (modified natural) denotes a natural compound that has been chemically modified in some fashion. Exemplary lipids also include squalene, squalene oxidation products such as alcohols or hydroperoxides, cholesterol, and esters of cholesterol. Exemplary lipids also include those which contain one or more unsaturations.

“Cross-linking Polymeric Materials” refers to polymeric materials, for example, UHMWPE can be cross-linked by a variety of approaches, including those employing cross-linking chemicals (such as peroxides and/or silane) and/or irradiation. Preferred approaches for cross-linking employ irradiation. Cross-linked UHMWPE also can be obtained through cold irradiation, warm irradiation, or melt irradiation according to the teachings of U.S. Pat. No. 5,879,400, U.S. Pat. No. 6,641,617, and PCT/US97/02220.

“Consolidated polymeric material refers” to a solid, consolidated bar stock, solid material machined from stock, or semi-solid form of polymeric material derived from any forms as described herein, for example, resin, powder, flakes, particles, or a mixture thereof, that can be consolidated. The consolidated polymeric material also can be in the form of a slab, block, solid bar stock, machined component, film, tube, balloon, preform, implant, finished medical device or unfinished device.

By “crystallinity” is meant the fraction of the polymer that is crystalline. The crystallinity is calculated by knowing the weight of the sample (weight in grams), the heat absorbed by the sample in melting (E, in J/g) and the heat of melting of polyethylene crystals (ΔH=291 J/g), and using the following equation according to ASTM F2625 and the like or their successors:

%Crystallinity=E/w·ΔH

By tensile “elastic modulus” is meant the ratio of the nominal stress to corresponding strain for strains as determined using the standard test ASTM 638 M III and the like or their successors.

The term “non-permanent device” refers to what is known in the art as a device that is intended for implantation in the body for a period of time shorter than several months. Some non-permanent devices could be in the body for a few seconds to several minutes, while other may be implanted for days, weeks, or up to several months. Non-permanent devices include catheters, tubing, intravenous tubing, and sutures, for example.

“Pharmaceutical compound”, as described herein, refers to a drug in the form of a powder, suspension, emulsion, particle, film, cake, or molded form. The drug can be free-standing or incorporated as a component of a medical device.

The term “packaging” refers to the container or containers in which a medical device is packaged and/or shipped. Packaging can include several levels of materials, including bags, blister packs, heat-shrink packaging, boxes, ampoules, bottles, tubes, trays, or the like or a combination thereof. A single component may be shipped in several individual types of package, for example, the component can be placed in a bag, which in turn is placed in a tray, which in turn is placed in a box. The whole assembly can be sterilized and shipped. The packaging materials include, but not limited to, vegetable parchments, multi-layer polyethylene, Nylon 6, polyethylene terephthalate (PET), and polyvinyl chloride-vinyl acetate copolymer films, polypropylene, polystyrene, and ethylene-vinyl acetate (EVA) copolymers.

The term “interface” in this invention is defined as the niche in medical devices formed when an implant is in a configuration where a component is in contact with another piece (such as a metallic or a non-metallic component), which forms an interface between the polymer and the metal or another polymeric material. For example, interfaces of polymer-polymer or polymer-metal are in medical prosthesis, such as orthopedic joints and bone replacement parts, for example, hip, knee, elbow or ankle replacements.

Medical implants containing factory-assembled pieces that are in close contact with the polyethylene form interfaces. In most cases, the interfaces are not readily accessible to ethylene oxide gas or the gas plasma during a gas sterilization process.

“Irradiation”, in one aspect of the invention, the type of radiation, preferably ionizing, is used. According to another aspect of the invention, a dose of ionizing radiation ranging from about 25 kGy to about 1000 kGy is used. The radiation dose can be about 25 kGy, about 50 kGy, about 65 kGy, about 75 kGy, about 100 kGy, about 150, kGy, about 200 kGy, about 300 kGy, about 400 kGy, about 500 kGy, about 600 kGy, about 700 kGy, about 800 kGy, about 900 kGy, or about 1000 kGy, or above 1000 kGy, or any value thereabout or therebetween. Preferably, the radiation dose can be between about 25 kGy and about 150 kGy or between about 50 kGy and about 100 kGy. These types of radiation, including gamma, x-ray, and/or electron beam, kills or inactivates bacteria, viruses, or other microbial agents potentially contaminating medical implants, including the interfaces, thereby achieving product sterility. The irradiation, which may be electron or gamma irradiation, in accordance with the present invention can be carried out in air atmosphere containing oxygen, wherein the oxygen concentration in the atmosphere is at least 1%, 2%, 4%, or up to about 22%, or any value thereabout or therebetween. In another aspect, the irradiation can be carried out in an inert atmosphere, wherein the atmosphere contains gas selected from the group consisting of nitrogen, argon, helium, neon, or the like, or a combination thereof. The irradiation also can be carried out in a sensitizing gas such as acetylene or mixture or a sensitizing gas with an inert gas or inert gases. The irradiation also can be carried out in a vacuum. The irradiation can also be carried out at room temperature, or at between room temperature and the melting point of the polymeric material, or at above the melting point of the polymeric material. The irradiation can be carried out at any temperature or at any dose rate using e-beam, gamma, and/or x-ray. The irradiation temperature can be below or above the melting point of the polymer. The polymer can be first heated and then irradiated. Alternatively, the heat generated by the beam, i.e., radiation generated heating (including adiabatic and partially adiabatic) can increase the temperature of the polymer. Subsequent to the irradiation step the polymer can be heated to melt or heated to a temperature below its melting point for annealing. These post-irradiation thermal treatments can be carried out in air, inert gas and/or in vacuum. Also the irradiation can be carried out in small increments of radiation dose and in some embodiments these sequences of incremental irradiation can be interrupted with a thermal treatment. The sequential irradiation can be carried out with about 1, 10, 20, 30, 40, 50, 100 kGy, or higher radiation dose increments. Between each or some of the increments the polymer can be thermally treated by melting and/or annealing steps. The thermal treatment after irradiation is mostly to reduce or to eliminate the residual free radicals in the polymers created by irradiation, and/or eliminate the crystalline matter, and/or help in the removal of any extractables that may be present in the polymer.

In accordance with a preferred feature of this invention, the irradiation may be carried out in a sensitizing atmosphere. This may comprise a gaseous substance which is of sufficiently small molecular size to diffuse into the polymer and which, on irradiation, acts as a polyfunctional grafting moiety. Examples include substituted or unsubstituted polyunsaturated hydrocarbons; for example, acetylenic hydrocarbons such as acetylene; conjugated or unconjugated olefinic hydrocarbons such as butadiene and (meth)acrylate monomers; sulphur monochloride, with chloro-tri-fluoroethylene (CTFE) or acetylene being particularly preferred. By “gaseous” is meant herein that the sensitizing atmosphere is in the gas phase, either above or below its critical temperature, at the irradiation temperature.

If electron radiation is used, the energy of the electrons also is a parameter that can be varied to tailor the properties of the irradiated polymer. In particular, differing electron energies result in different depths of penetration of the electrons into the polymer. The practical electron energies range from about 0.1 MeV to 16 MeV giving approximate iso-dose penetration levels of 0.5 mm to 8 cm, respectively. The preferred electron energy for maximum penetration is about 10 MeV, which is commercially available through vendors such as Studer (Daniken, Switzerland) or E-Beam Services New Jersey, USA). The lower electron energies may be preferred for embodiments where a surface layer of the polymer is preferentially cross-linked with gradient in cross-link density as a function of distance away from the surface.

The term “dose rate” refers to a rate at which the radiation is carried out. Dose rate can be controlled in a number of ways. One way is by changing the power of the e-beam, scan width, conveyor speed, and/or the distance between the sample and the scan horn. Another way is by carrying out the irradiation in multiple passes with, if desired, cooling or heating steps in-between. With gamma and x-ray radiations the dose rate is controlled by how close the sample is to the radiation source, how intense is the source, the speed at which the sample passes by the source.

Gamma irradiation, however, generally provides low radiation dose rate and requires a longer duration of time, which can result in more in-depth oxidation, particularly if the gamma irradiation is carried out in air. Electron irradiation, in general, results in a more limited dose penetration depth, but requires less time and, therefore, reduces the risk of extensive oxidation if the irradiation is carried out in air. In addition if the desired dose levels are high, for instance 20 Mrad, the irradiation with gamma may take place over one day, leading to impractical production times. On the other hand, the dose rate of the electron beam can be adjusted by varying the irradiation parameters, such as conveyor speed, scan width, and/or beam power. With the appropriate parameters, a 20 Mrad melt-irradiation can be completed in for instance less than 10 minutes. The penetration of the electron beam depends on the beam energy measured by million electron-volts (MeV). Most polymers exhibit a density of about 1 g/cm³, which leads to the penetration of about 1 cm with a beam energy of 2-3 MeV and about 4 cm with a beam energy of 10 MeV. The penetration of e-beam is known to increase slightly with increased irradiation temperatures. If electron irradiation is preferred, the desired depth of penetration can be adjusted based on the beam energy. Accordingly, gamma irradiation or electron irradiation may be used based upon the depth of penetration preferred, time limitations and tolerable oxidation levels.

Ranges of acceptable dose rates are exemplified in International Application WO 97/29793. In general, the dose rates vary between 0.5 Mrad/pass and 50 Mrad/pass. The upper limit of the dose rate depends on the resistance of the polymer to cavitation/cracking induced by the irradiation.

If electron radiation is utilized, the energy of the electrons also is a parameter that can be varied to tailor the properties of the irradiated polymer. In particular, differing electron energies result in different depths of penetration of the electrons into the polymer. The practical electron energies range from about 0.1 MeV to 16 MeV giving approximate iso-dose penetration levels of 0.5 mm to 8 cm, respectively. The preferred electron energy for maximum penetration is about 10 MeV, which is commercially available through vendors such as Studer (Daniken, Switzerland) or E-Beam Services New Jersey, USA). The lower electron energies may be preferred for embodiments where a surface layer of the polymer is preferentially cross-linked with gradient in cross-link density as a function of distance away from the surface.

In accordance with another aspect of the invention, the polymeric preform also has a gradient of cross-link density in a direction perpendicular to the direction of irradiation, wherein a part of the polymeric preform was preferentially shielded to partially block radiation during irradiation in order to provide the gradient of cross-link density, wherein the preferential shielding is used where a gradient of cross-link density is desired and the gradient of cross-link density is in a direction perpendicular to the direction of irradiation on the preferentially shielded polymeric preform, such as is disclosed in allowed U.S. Pat. No. 7,205,339, the methodologies of which are hereby incorporated by reference.

A gradient of cross-link density and a gradient concentration of antioxidant also can be obtained by extraction methods, such as disclosed in WO 2008/092047, the methodologies of which are hereby incorporated by reference.

“Metal Piece”, in accordance with the invention, the piece forming an interface with polymeric material is, for example, a metal. The metal piece in functional relation with polymeric material, according to the present invention, can be made of a cobalt chrome alloy, stainless steel, titanium, titanium alloy or nickel cobalt alloy, for example.

“Non-metallic Piece”, in accordance with the invention, the piece forming an interface with polymeric material is, for example, a non-metal. The non-metal piece in functional relation with polymeric material, according to the present invention, can be made of ceramic material, for example.

The term “inert atmosphere” refers to an environment having no more than 1% oxygen and more preferably, an oxidant-free condition that allows free radicals in polymeric materials to form cross links without oxidation during a process of sterilization. An inert atmosphere is used to avoid O₂, which would otherwise oxidize the medical device comprising a polymeric material, such as UHMWPE. Inert atmospheric conditions such as nitrogen, argon, helium, or neon are used for sterilizing polymeric medical implants by ionizing radiation.

Inert atmospheric conditions such as nitrogen, argon, helium, neon, or vacuum are also used for sterilizing interfaces of polymeric-metallic and/or polymeric-polymeric in medical implants by ionizing radiation.

Inert atmospheric conditions also refer to an inert gas, inert fluid, or inert liquid medium, such as nitrogen gas or silicon oil.

“Anoxic environment” refers to an environment containing gas, such as nitrogen, with less than 21%-22% oxygen, preferably with less than 2% oxygen. The oxygen concentration in an anoxic environment also can be at least about 1%, 2%, 4%, 6%, 8%, 10%, 12% 14%, 16%, 18%, 20%, or up to about 22%, or any value thereabout or therebetween.

The term “vacuum” refers to an environment having no appreciable amount of gas, which otherwise would allow free radicals in polymeric materials to form cross links without oxidation during a process of sterilization. A vacuum is used to avoid O₂, which would otherwise oxidize the medical device comprising a polymeric material, such as UHMWPE. A vacuum condition can be used for sterilizing polymeric medical implants by ionizing radiation.

A vacuum condition can be created using a commercially available vacuum pump. A vacuum condition also can be used when sterilizing interfaces of polymeric-metallic and/or polymeric-polymeric in medical implants by ionizing radiation.

A “sensitizing environment” or “sensitizing atmosphere” refers to a mixture of gases and/or liquids (at room temperature) that contain sensitizing gaseous and/or liquid component(s) that can react with residual free radicals to assist in the recombination of the residual free radicals. The gases maybe acetylene, chloro-trifluoro ethylene (CTFE), ethylene, or like. The gases or the mixtures of gases thereof may contain noble gases such as nitrogen, argon, neon and like. Other gases such as, carbon dioxide or carbon monoxide may also be present in the mixture. In applications where the surface of a treated material is machined away during the device manufacture, the gas blend could also contain oxidizing gases such as oxygen. The sensitizing environment can be dienes with different number of carbons, or mixtures of liquids and/or gases thereof. An example of a sensitizing liquid component is octadiene or other dienes, which can be mixed with other sensitizing liquids and/or non-sensitizing liquids such as a hexane or a heptane. A sensitizing environment can include a sensitizing gas, such as acetylene, ethylene, or a similar gas or mixture of gases, or a sensitizing liquid, for example, a diene. The environment is heated to a temperature ranging from room temperature to a temperature below the melting point of the material.

In certain embodiments of the present invention in which the sensitizing gases and/or liquids or a mixture thereof, inert gas, air, vacuum, and/or a supercritical fluid can be present at any of the method steps disclosed herein, including blending, mixing, consolidating, quenching, irradiating, annealing, mechanically deforming, doping, homogenizing, heating, melting, and packaging of the finished product, such as a medical implant.

“Residual free radicals” refers to free radicals that are generated when a polymer is exposed to ionizing radiation such as gamma or e-beam irradiation. While some of the free radicals recombine with each other to from cross-links, some become trapped in crystalline domains. The trapped free radicals are also known as residual free radicals.

According to one aspect of the invention, the levels of residual free radicals in the polymer generated during an ionizing radiation (such as gamma or electron beam) is preferably determined using electron spin resonance and treated appropriately to reduce the free radicals.

“Sterilization”, one aspect of the present invention discloses a process of sterilization of medical implants containing polymeric material, such as cross-linked UHMWPE. The process comprises sterilizing the medical implants by ionizing sterilization with gamma or electron beam radiation, for example, at a dose level ranging from about 25-70 kGy, or by gas sterilization with ethylene oxide or gas plasma.

Another aspect of the present invention discloses a process of sterilization of medical implants containing polymeric material, such as cross-linked UHMWPE. The process comprises sterilizing the medical implants by ionizing sterilization with gamma or electron beam radiation, for example, at a dose level ranging from 25-200 kGy. The dose level of sterilization is higher than standard levels used in irradiation. This is to allow cross-linking or further cross-linking of the medical implants during sterilization.

One aspect of the present invention discloses a process of increasing the uniformity of the antioxidant following doping in polymeric component of a medical implant during the manufacturing process by heating for a time period depending on the melting temperature of the polymeric material. For example, the preferred temperature is about 137° C. or less. Another aspect of the invention discloses a heating step that can be carried in the air, in an atmosphere, containing oxygen, wherein the oxygen concentration is at least about 1%, 2%, 4%, or up to about 22%, or any value thereabout or therebetween. In another aspect, the invention discloses a heating step that can be carried while the implant is in contact with an inert atmosphere, wherein the inert atmosphere contains gas selected from the group consisting of nitrogen, argon, helium, neon, or the like, or a combination thereof. In another aspect, the invention discloses a heating step that can be carried while the implant is in contact with a non-oxidizing medium, such as an inert fluid medium, wherein the medium contains no more than about 1% oxygen. In another aspect, the invention discloses a heating step that can be carried while the implant is in a vacuum.

The term “radiation generated heat” refers to the heat generated as a result of conversion of some of the energies deposited by the electrons or gamma rays to heat during an irradiation process. Radiation generated heating, which includes adiabatic and partially adiabatic heating, primarily depends on how well the sample is thermally insulated during the irradiation. With good thermal insulation, most of the heat generated is not lost to the surroundings and leads to the radiation generated heating (adiabatic and partially adiabatic) of the polymer to a higher temperature than the irradiation temperature. The heating also could be induced by using a high enough dose rate to minimize the heat loss to the surroundings. The radiation generated heating (including adiabatic and partially adiabatic) depends on a number of processing parameters such as dose rate, initial temperature of the sample, absorbed radiation dose, and the like. Radiation generated heating (including adiabatic and partially adiabatic) is a result of the conversion of the radiation dose to heat in the irradiated sample. If the temperature of the sample is high enough during melting, radiation generated heating (including adiabatic and partially adiabatic) results in melting of the crystals. Even when the initial temperature of the polymer is low, for example, near room temperature or 40° C., the radiation generated heating (including adiabatic and partially adiabatic) can be high enough to increase the temperature of the polymer during irradiation. If the initial temperature and radiation dose are too high, radiation generated heating (including adiabatic and partially adiabatic) may result in complete melting of the polymer.

It should be noted that in theoretical thermodynamics, “adiabatic heating” refers to an absence of heat transfer to the surroundings. In the practice, such as in the creation of new polymeric materials, “adiabatic heating” refers to situations where a sufficient majority of thermal energy is imparted on the starting material and is not transferred to the surroundings. Such can be achieved by the combination of insulation, irradiation dose rates and irradiation time periods, as disclosed herein and in the documents cited herein. Thus, what may approach adiabatic heating in the theoretical sense achieves it in the practical sense. However, not all warm irradiation refers to an “adiabatic heating.” Warm irradiation also can have non-adiabatic or partially (such as 10-75% of the heat generated are lost to the surroundings) adiabatic heating.

In an aspect of this invention, room temperature irradiation refers that the polymeric material is at ambient temperature is not heated by an external heating element before or during irradiation. However, the irradiation itself may heat up the polymeric material. In some cases the radiation dose is lower, which only results in minor rise in temperature in the polymeric material, and in some other cases the radiation dose is higher, which results in large increases in temperature in the polymeric material. Similarly the dose rate also plays an important role in the heating of the polymeric material during irradiation. At low dose rate the temperature rise is smaller while with larger dose rates the radiation imparted heating becomes more adiabatic and leads to larger increases in the temperature of the polymeric material. In any of these cases, as long as there is no other heating source other than radiation itself, the process is considered as room temperature irradiation.

In another aspect of this invention, there is described the heating method of implants to increase the uniformity of the antioxidant. The medical device comprising a polymeric raw material, such as UHMWPE, is generally heated to a temperature of about 137° C. or less following the step of doping with the antioxidant. The medical device is kept heated in the inert medium until the desired uniformity of the antioxidant is reached.

The term “below melting point” or “below the melt” refers to a temperature below the melting point of a polymeric material, for example, polyethylene such as UHMWPE. The term “below melting point” or “below the melt” refers to a temperature less than about 145° C., which may vary depending on the melting temperature of the polymeric material, for example, about 145° C., 140° C. or 135° C., which again depends on the properties of the polymeric material being treated, for example, molecular weight averages and ranges, batch variations, etc. The melting temperature is typically measured using a differential scanning calorimeter (DSC) at a heating rate of 10° C. per minute. The peak melting temperature thus measured is referred to as melting point, also referred as transition range in temperature from crystalline to amorphous phase, and occurs, for example, at approximately 137° C. for some grades of UHMWPE. It may be desirable to conduct a melting study on the starting polymeric material in order to determine the melting temperature and to decide upon an irradiation and annealing temperature. Generally, the melting temperature of polymeric material is increased when the polymeric material is under pressure.

The term “heating” refers to thermal treatment of the polymer at or to a desired heating temperature. In one aspect, heating can be carried out at a rate of about 10° C. per minute to the desired heating temperature. In another aspect, the heating can be carried out at the desired heating temperature for desired period of time. In other words, heated polymers can be continued to heat at the desired temperature, below or above the melt, for a desired period of time. Heating time at or to a desired heating temperature can be at least 1 minute to 48 hours to several weeks long. In one aspect the heating time is about 1 hour to about 24 hours. In another aspect, the heating can be carried out for any time period as set forth herein, before or after irradiation. Heating temperature refers to the thermal condition for heating in accordance with the invention. Heating can be performed at any time in a process, including during, before and/or after irradiation. Heating can be done with a heating element. Other sources of energy include the environment and irradiation.

The term “annealing” refers to heating or a thermal treatment condition of the polymers in accordance with the invention. Annealing generally refers to continued heating the polymers at a desired temperature below its peak melting point for a desired period of time. Annealing time can be at least 1 minute to several weeks long. In one aspect the annealing time is about 4 hours to about 48 hours, preferably 24 to 48 hours and more preferably about 24 hours. “Annealing temperature” refers to the thermal condition for annealing in accordance with the invention. Annealing can be performed at any time in a process, including during, before and/or after irradiation. Annealing also can be performed above the melting point of the polymer, that is, annealing above the melt.

The term annealing also refers to any annealing process known to one of ordinary skill in the art. Preferable processes for annealing include, but are not limited to mechanical annealing, thermal annealing (as described above), or combinations thereof.

In certain embodiments of the present invention in which annealing can be carried out, for example, in an inert gas, e.g., nitrogen, argon or helium, in a vacuum, in air, and/or in a sensitizing atmosphere, for example, acetylene.

The term “contacted” includes physical proximity with or touching such that the sensitizing agent can perform its intended function. Preferably, a polymeric composition or preform is sufficiently contacted such that it is soaked in the sensitizing agent, which ensures that the contact is sufficient. Soaking is defined as placing the sample in a specific environment for a sufficient period of time at an appropriate temperature, for example, soaking the sample in a solution of an antioxidant. The environment is heated to a temperature ranging from room temperature to a temperature below the melting point of the material. The contact period ranges from at least about 1 minute to several weeks and the duration depending on the temperature of the environment.

The term “non-oxidizing” refers to a state of polymeric material having an oxidation index (A. U.) of less than about 0.5, according to ASTM F2102 or equivalent, following aging polymeric materials for 5 weeks in air at 80° C. oven. Thus, a non-oxidizing cross-linked polymeric material generally shows an oxidation index (A. U.) of less than about 0.5 after the aging period.

The term “oxidatively stable” or “oxidative stability” or “oxidation-resistant” refers a state of polymeric material having an oxidation index (A. U.) of less than about 0.1 following aging polymeric materials for 5 weeks in air at 80° C. oven. Thus, a oxidatively stable or oxidation-resistant cross-linked polymeric material generally shows an oxidation index (A. U.) of less than about 0.1 after the aging period.

The term “surface” of a polymeric material refers generally to the exterior region of the material having a thickness of about 1.0 μm to about 2 cm, preferably about 1.0 mm to about 5 mm, more preferably about 2 mm of a polymeric material or a polymeric sample or a medical device comprising polymeric material.

The term “bulk” of a polymeric material refers generally to an interior region of the material having a thickness of about 1.0 μm to about 2 cm, preferably about 1.0 mm to about 5 mm, more preferably about 2 mm, from the surface of the polymeric material to the center of the polymeric material. However, the bulk may include selected sides or faces of the polymeric material including any selected surface, which may be contacted with a higher concentration of antioxidant.

Although the terms “surface” and “bulk” of a polymeric material generally refer to exterior regions and the interior regions, respectively, there generally is no discrete boundary between the two regions. But, rather the regions are more of a gradient-like transition. These can differ based upon the size and shape of the object and the resin used.

The term “doping” refers to a general process known in the art (see, for example, U.S. Pat. Nos. 6,448,315 and 5,827,904). In this connection, doping generally refers to contacting a polymeric material with one or more antioxidants, additive, any agent such as plasticizing agent, any reagent or bio-molecules, such as certain lipids, under certain conditions, as set forth herein, for example, doping UHMWPE with an antioxidant under supercritical conditions.

In certain embodiments of the present invention in which doping of antioxidant is carried out at a temperature above the melting point of the polymeric material, the antioxidant-doped polymeric material can be further heated above the melt or annealed to eliminate residual free radicals after irradiation. Melt-irradiation of polymeric material in the presence of an antioxidant, such as vitamin E, can change the distribution of the vitamin E concentration and also can change the mechanical properties of the polymeric material. These changes can be induced by changes in crystallinity and/or by the plasticization effect of vitamin E at certain concentrations.

According to one embodiment, the surface of the polymeric material is contacted with little or no antioxidant and bulk of the polymeric material is contacted with a higher concentration of antioxidant.

According to another embodiment, the surface of the polymeric material is contacted with no antioxidant and bulk of the polymeric material is contacted with a higher concentration of antioxidant.

According to one embodiment, the bulk of the polymeric material is contacted with little or no antioxidant and surface of the polymeric material is contacted with a higher concentration of antioxidant.

According to another embodiment, the bulk of the polymeric material is contacted with no antioxidant and surface of the polymeric material is contacted with a higher concentration of antioxidant.

According to another embodiment, the surface of the polymeric material and the bulk of the polymeric material are contacted with the same concentration of antioxidant.

According to one embodiment, the surface of the polymeric material may contain from about 0 wt % to about 50 wt % antioxidant, preferably about 0.001 wt % to about 10 wt %, preferably between about 0.01 wt % to about 0.5 wt %, more preferably about 0.2 wt %. According to another embodiment, the bulk of the polymeric material may contain from about 0 wt % to about 50 wt %, preferably about 0.001 wt % to about 10 wt %, preferably between about 0.01 wt % to about 0.5 wt %, more preferably about 0.2 wt %, preferably between about 0.2 wt % and about 1% wt %, preferably about 0.5 wt %.

According to another embodiment, the antioxidant concentration in the polymeric material can be about 1 ppm to about 50,000 ppm, preferably about 100 ppm, about 500 ppm, about 1000 ppm, about 2000 ppm, about 3000 ppm, about 5000 ppm, or to any value thereabout or therebetween.

According to another embodiment, the radiation dose is adjusted depending on the concentration of the antioxidant to achieve a desired cross-link density. At higher antioxidant concentrations, generally a higher dose level is required in order to reach the same cross-link density.

According to another embodiment, the surface of the polymeric material and the bulk of the polymeric material contain the same concentration of antioxidant.

More specifically, consolidated polymeric material can be doped with an antioxidant by soaking the material in a solution of the antioxidant. This allows the antioxidant to diffuse into the polymer. For instance, the material can be soaked in 100% antioxidant. The material also can be soaked in an antioxidant solution where a carrier solvent can be used to dilute the antioxidant concentration. To increase the depth of diffusion of the antioxidant, the material can be doped for longer durations, at higher temperatures, at higher pressures, and/or in presence of a supercritical fluid.

The antioxidant can be diffused to a depth of about 5 mm or more from the surface, for example, to a depth of about 3-5 mm, about 1-3 mm, or to any depth thereabout or therebetween.

The doping process can involve soaking of a polymeric material, medical implant or device with an antioxidant, such as vitamin E, for about half an hour up to several days, preferably for about one hour to 24 hours, more preferably for one hour to 16 hours. The antioxidant can be at room temperature or heated up to about 137° C. and the doping can be carried out at room temperature or at a temperature up to about 137° C. Preferably the antioxidant solution is heated to a temperature between about 100° C. and 135° C. or between about 110° C. and 130° C., and the doping is carried out at a temperature between about 100° C. and 135° C. or between about 110° C. and 130° C. More preferably, the antioxidant solution is heated to about 120° C. and the doping is carried out at about 120° C.

Doping with α-tocopherol through diffusion at a temperature above the melting point of the irradiated polymeric material (for example, at a temperature above 137° C. for UHMWPE) can be carried out under reduced pressure, ambient pressure, elevated pressure, and/or in a sealed chamber, for about 0.1 hours up to several days, preferably for about 0.5 hours to 6 hours or more, more preferably for about 1 hour to 5 hours. The antioxidant can be at a temperature of about 137° C. to about 400° C., more preferably about 137° C. to about 200° C., more preferably about 137° C. to about 160° C.

The doping and/or the irradiation steps can be followed by an additional step of homogenization. The term “homogenization” refers to a heating step in air or in an environment that is completely or partially depleted in oxygen environment to improve the spatial uniformity of the antioxidant concentration within the polymeric material, medical implant or device. Homogenization also can be carried out before and/or after the irradiation step. The heating may be carried out above or below or at the peak melting point. Antioxidant-doped or -blended polymeric material can be homogenized at a temperature below or above or at the peak melting point of the polymeric material for a desired period of time, for example, the antioxidant-doped or -blended polymeric material can be homogenized for about an hour to several days at room temperature to about 400° C. Preferably, the homogenization is carried out at 90° C. to 180° C., more preferably 100° C. to 137° C., more preferably 120° C. to 135° C., most preferably 130° C. Homogenization is preferably carried out for about one hour to several days to two weeks or more, more preferably about 12 hours to 300 hours or more, more preferably about 280 hours, or more preferably about 200 hours. More preferably, the homogenization is carried out at about 130° C. for about 36 hours or at about 120° C. for about 24 hours. The polymeric material, medical implant or device is kept in an inert atmosphere (nitrogen, argon, and/or the like), under vacuum, or in air during the homogenization process. The homogenization also can be performed in a chamber with supercritical fluids such as carbon dioxide or the like. The pressure of the supercritical fluid can be about 1000 to about 3000 psi or more, more preferably about 1500 psi. It is also known that pressurization increases the melting point of UHMWPE. A temperature higher than 137° C. can be used for homogenization below the melting point if applied pressure has increased the melting point of UHMWPE beyond 137° C.

Homogenization enhances the diffusion of the antioxidant from antioxidant-rich regions to antioxidant poor regions. The diffusion is generally faster at higher temperatures. At a temperature above the melting point the hindrance of diffusion from the crystalline domains is eliminated and the homogenization occurs faster. Melt-homogenization and subsequent recrystallization may reduce the mechanical properties mostly due to a decline in the crystallinity of the polymer. This may be acceptable or even desirable for certain applications. For example, applications where the decline in mechanical properties is not desirable the homogenization can be carried out below the melting point. Alternatively, below or above the melt homogenized samples may be subjected to high pressure crystallization to further improve their mechanical properties.

The polymeric material, medical implant or device is kept in an inert atmosphere (nitrogen, argon, neon, and/or the like), under vacuum, or in air during the homogenization process. The homogenization also can be performed in a chamber with supercritical fluids such as carbon dioxide or the like. The pressure of the supercritical fluid can be 1000 to 3000 psi or more, more preferably about 1500 psi. The homogenization can be performed before and/or after and/or during the diffusion of the antioxidant.

In one embodiment, the invention discloses:

1. Starting material can be: Homopolymer, UHMWPE, other polyolefins, copolymers etc.; Blended with vitamin E; Doped with vitamin E; Blended with antioxidants; Doped with antioxidants; Blended of polymers; Gradients of antioxidant etc., and the like.

2. Heating include: Annealing below melt, Melting, and/or Melting at 300° C. (melt above the peak melting point in the respective medium); and all of the above in water, steam, air, inert, sensitizing gas, reduced oxygen environment, in antioxidant, in antioxidant solutions.

3. Post-Irradiation treatments include: Heating (anneal or melt or melt at 300° C.), Doping with antioxidant, High pressure crystallization (HPC), High pressure annealing (HPA), Deformation, and/or Low pressure annealing (LPA), and Low pressure crystallization (LPC).

4. Sterilization by methods including: Gamma, e-beam, x-ray, Gas plasma, and Ethylene oxide.

In another embodiment, the invention discloses:

1. Heating of the Starting Material and Pressurize, cool under pressure.

2. Heating of the Starting Material then HPC, HPA, Deformation, LPA, or LPC followed by Irradiation, and optionally followed by Post-Irradiation Treatments.

3. Irradiation of the Starting Material then heat and optionally followed by post-irradiation treatments (for example, HPC).

4. Heat the Starting Material then Irradiation, and optionally followed by Post-Irradiation Treatments.

Each composition and aspects, and each method and aspects, which are described above can be combined with another in various manners consistent with the teachings contained herein. According to the embodiments and aspects of the inventions, all methods and the steps in each method can be applied in any order and repeated as many times in a manner consistent with the teachings contained herein.

The invention is further described by the following examples, which do not limit the invention in any manner.

### EXAMPLES

VITAMIN E: Vitamin E (Acros™ 99% D-α-Tocopherol, Fisher Brand), was used in the experiments described herein, unless otherwise specified. The vitamin E used is very light yellow in color and is a viscous fluid at room temperature. Its melting point is 2-3° C.

DETERMINATION OF VITAMIN E INDEX (A.U.): Fourier transform infrared spectroscopy (FTIR) is used to quantify the Vitamin E content in the UHMWPE. The FTIR, in other words also known as infra-red microscopy, is used to quantify the Vitamin E content by measuring the vitamin E index, which is a dimensionless parameter.

The absorption peak associated with the alpha-tocopherol is located at 1265 cm-1, which is then normalized with a methylene peak at 1895 cm-1. This ratio is reported as a vitamin E index.

The sample is prepared by microtoming a slice between 100 and 200 micrometers thick through the thickness of the sample. The section must be microtomed orthogonally to the scan direction to prevent spreading the alpha-tocopherol in the through-thickness direction. The slice is mounted on the translating stage of a FTIR microscope, and FTIR spectra are collected at specified intervals from the surface into the bulk of the sample.

The vitamin E index can be converted into an absolute concentration by comparing the index to a calibration curve prepared from UHMWPE sections containing known amounts of Vitamin E.

### Example 1

### Squalene (Lipid) Doping

Slab compression molded GUR1050 UHMWPE was irradiated to 100 kGy (Iotron Inc, Vancouver, BC). Irradiated blocks were melted in air in a convection oven at 150° C. They were kept at temperature for 2 hours and cooled down to room temperature. Cubes (1 cm) were machined from the irradiated and melted blocks. Three blocks each were placed in squalene, which had been pre-heated for 1 hour at the desired temperature. Doping with squalene was carried out for the desired period of time, after which the blocks were immediately removed from squalene, wiped with gauze and allowed to cool down. Cubes were doped with squalene at 55° C. for 4 hours, 100° C. for 4 hours, 120° C. for 1, 2 and 4 hours.

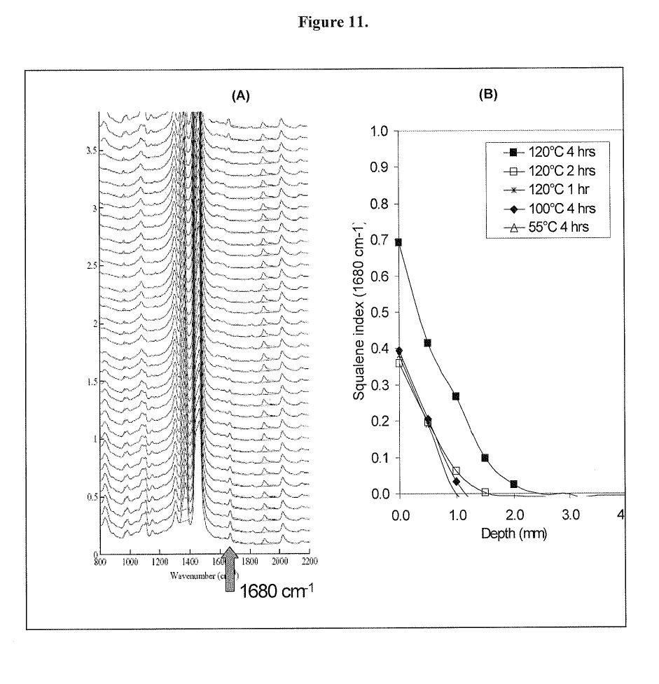

The cubes were cut in half and thin sections (150 μm) were microtomed from the inner surface of the cubes. By using Fourier Transform Infrared Spectrometer equipped with a microscope, the thin sections were analyzed as a function of depth from the surface. A squalene index was calculated by taking the ratio of the area under the absorbance at 1680 cm⁻¹ to the absorbance at 1895 cm⁻¹ (FIG. 11a). Representative squalene concentration profiles are shown in FIG. 11b. With increasing duration and temperature the amount of squalene penetrated into the polymer increased (2.5 mg for 55° C. doping for 4 hours, 44 mg for 100° C. for 4 hours, 21 mg for 120° C. for 1 hour, 53 for 120° C. for 2 hours and 72 mg for 120° C. for 4 hours, respectively).

### Example 2

### Accelerated Aging after Squalene Doping

Accelerated aging is typically performed at 70° C. at 5 atm of oxygen for 2 weeks. However, when the aging was carried for 2 weeks, 100-kGy irradiated and melted UHMWPE doped with squalene was excessively oxidized. Therefore, the samples were aged for shorter durations. Accelerated aging of 100-kGy irradiated and melted UHMWPE cubes doped with squalene for 2 hours at 120° C. (n=3 each) was performed for 2, 4, 6, 8, 10, 12 and 14 days.

The cubes were cut in half and thin sections (150 μm) were microtomed from the inner surface of the cubes. These thin sections were boiled in hexane overnight and subsequently dried in vacuum. By using Fourier Transform Infrared Spectrometer equipped with a microscope, the thin sections were analyzed as a function of depth from the surface. An oxidation index was calculated by taking the ratio of the area under the absorbance at 1700 cm⁻¹ to the absorbance at 1370 cm⁻¹.

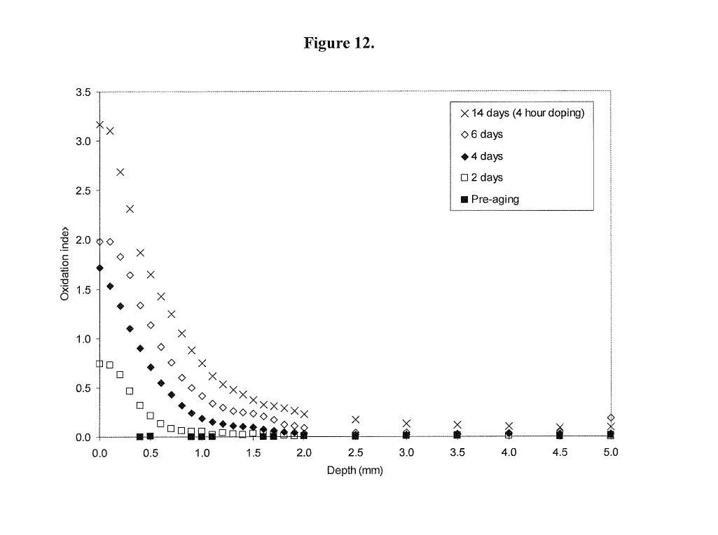

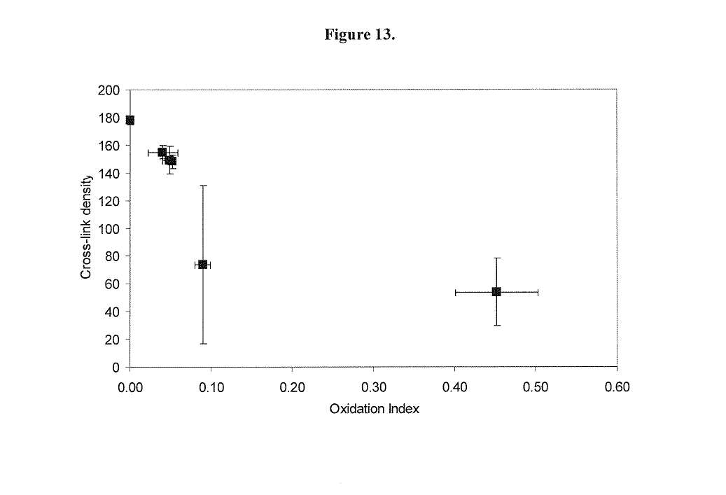

The oxidation profiles of 100-kGy irradiated and melted cubes as a function of aging time is shown in FIG. 12.

FIG. 12 shows that there was severe oxidation in 100-kGy irradiated and melted UHMWPE in 6 days (much shorter time than the standard 14 days for this kind of aging). This UHMWPE does not contain residual free radicals and does not oxidize in the absence of squalene.

### Example 3

### Decrosslinking by Lipid-Initiated Oxidation

The surface region (about 1 mm deep, 1 mm thick and 2 mm wide) was cut by a razor blade from 100-kGy irradiated and melted UHMWPE cubes, which had been doped with squalene and subsequently aged at 70° C. for 6 days at 5 atm. of oxygen. Cross-link density measurements were performed by swelling these samples in xylene at 130° C. Samples were weighed before and after swelling. Gravimetric swelling was measured and converted to volumetric swelling by assuming a density of 0.99 g/cm³ for polyethylene and 0.75 g/cm³ for xylene at 130° C. Then, cross-link density was calculated as described previously (Muratoglu et al., Biomaterials 20:1463 (2001)). The cross-link density of 100-kGy irradiated and melted UHMWPE before doping and aging was also measured.

TABLE 3
The cross-link density (mol/m³) of 100-kGy irradiated and
melted UHMWPE before doping/aging and after aging
as a function of absorbed squalene amount.

| | | Surface | Bulk |
|---|---|---|---|
| Before doping and aging | — | 178 ± 3 | |
| Lipid doped, post-aging | 2.5 mg | 74 ± 57 | 148 ± 5 |
| | 21 mg | 54 ± 24 | 149 ± 10 |
| | 44 mg | 57 ± 2 | 148 ± 11 |

The cross-link density of squalene doped and accelerated aged UHMWPEs were severely reduced. The cross-link density as a function of oxidation showed a similar trend to those observed in surgically explanted irradiated and melted UHMWPE acetabular liners after exposure to air. During the oxidation of squalene, polyethylene molecules were likely attacked by the free radicals residing on squalene; this ultimately resulted in chain scission in polyethylene and a reduction in crosslink density.

### Example 4

### Comparison of the Stability of Vitamin E-Containing UHMWPEs Against Lipid-Initiated Oxidation

Vitamin E-blended GUR1050 UHMWPE with 0.1 wt %, 0.2 wt %, 0.3 wt % and 0.5 wt % vitamin E was used. These blends were irradiated to the desired dose rate at close to room temperature (cold irradiation) or at about 120° C. (warm irradiation). Cubes (1 cm) were machined from irradiated blocks. A list of blended samples that were doped with squalene at 120° C. for 2 hours and subsequently accelerated aged at 70° C. for 6 days at 5 atm. of oxygen are given in Table 4. Also, a 100-kGy irradiated, vitamin E-stabilized (uniform concentration at ˜0.7 wt %) and terminally gamma sterilized UHMWPE was used. This sample was 6 mm-thick.

The cubes were cut in half and thin sections (150 μm) were microtomed from the inner surface of the cubes. These thin sections were boiled in hexane overnight and subsequently dried in vacuum. By using Fourier Transform Infrared Spectrometer equipped with a microscope, the thin sections were analyzed as a function of depth from the surface. An oxidation index was calculated by taking the ratio of the area under the absorbance at 1700 cm⁻¹ to the absorbance at 1370 cm⁻¹.

TABLE 4
A list of squalene doped and accelerated aged irradiated
vitamin E-blends.

| Vitamin E | Radiation | Warm irradiation | |
|---|---|---|---|
| concentration | dose | (WI)/cold | |
| (wt %) | (kGy) | irradiation (CI) | Post-irradiation treatment |
| 0.1 | 150 | CI | — |
| 0.1 | 150 | CI | Melting at 150° C. |
| 0.1 | 150 | CI | Annealing at 130° C. |
| 0.1 | 150 | CI | Mechanical deformation |
| | | | followed by annealing |
| | | | at 130° C. |
| 0.1 | 150 | WI | — |
| 0.2 | 150 | CI | — |
| 0.2 | 150 | WI | — |
| 0.2 | 200 | WI | — |
| 0.3 | 150 | CI | — |
| 0.5 | 150 | CI | — |

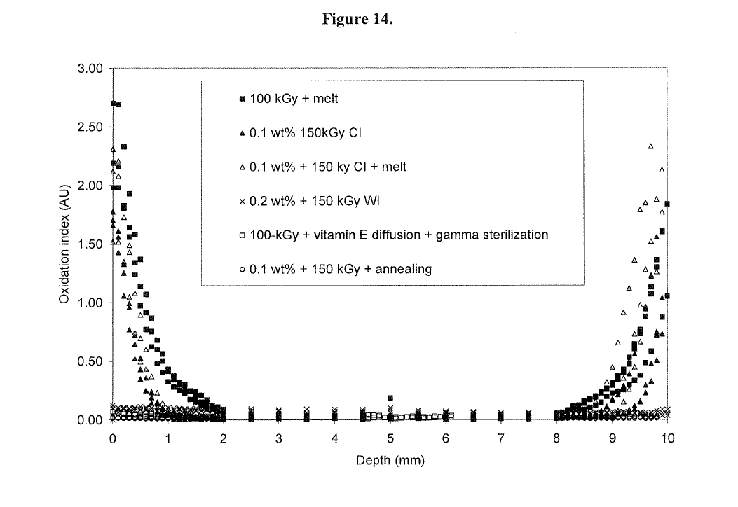

FIG. 14 shows oxidation in 0.1 wt % vitamin E blended and 150 kGy cold-irradiated UHMWPE. This suggested that this material was not protected against lipid-initiated oxidation. Post-irradiation melting and the elimination of free radicals did not improve its stability. In contrast, post-irradiation annealing did render the 0.1 wt % vitamin E blended and 150 kGy cold irradiated UHMWPE stable against lipid-initiated oxidation. Also, irradiated UHMWPE with vitamin E diffused after cross-linking was protected against lipid-initiated oxidation despite exposure to sterilization dose (25-40 kGy) of irradiation.

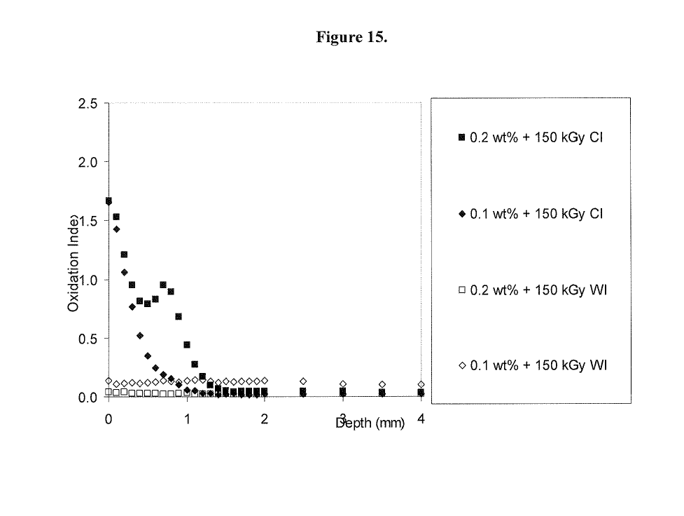

Both 0.1 wt % vitamin E blended and 0.2 wt % vitamin E blended UHMWPE that were subsequently irradiated to 150 kGy cold irradiation oxidized heavily after squalene doping and accelerated aging (FIG. 15). In contrast, these same materials were protected against lipid-initiated oxidation when they were warm irradiated at the same irradiation dose (FIG. 15).

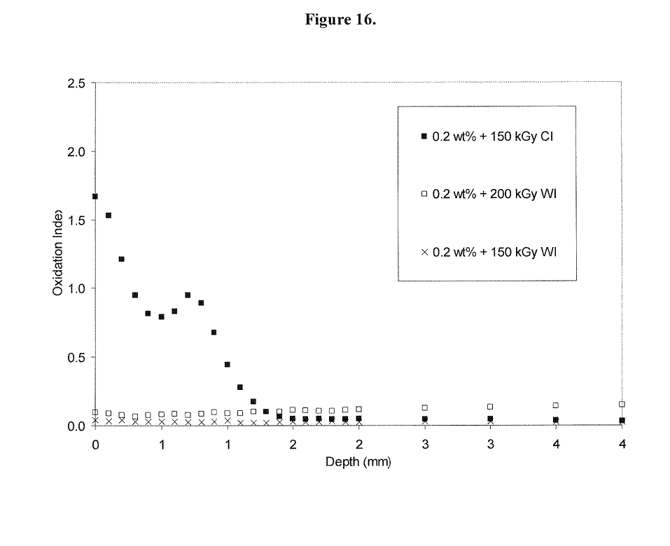

Despite being susceptible to lipid-initiated oxidation when cold irradiated to 150 kGy, 0.2 wt % vitamin E-blended UHMWPE was protected against lipid-initiated oxidation when warm irradiated to 200 kGy (FIG. 16).

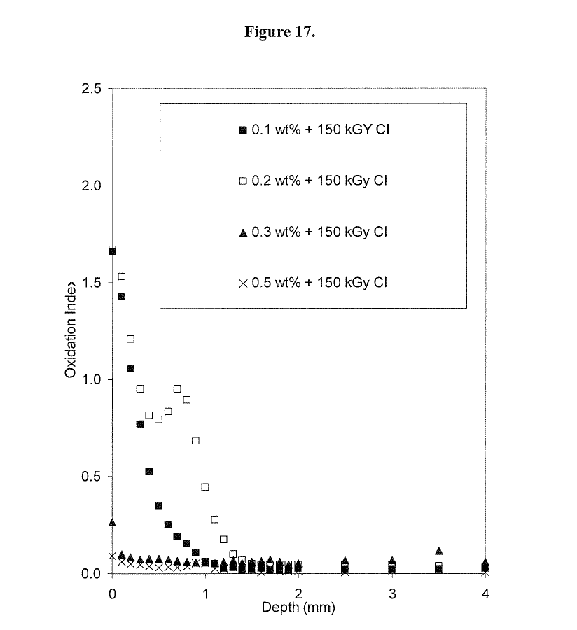

Vitamin E-blended UHMWPE with 0.1 and 0.2 wt % vitamin E subsequently cold irradiated to 150 kGy oxidized after squalene doping and aging whereas Vitamin E-blended UHMWPE with 0.3 and 0.5 wt % UHMWPE did not oxidize (FIG. 17). This suggested that increased vitamin E concentrations could protect vitamin E-blended UHMWPE against lipid-initiated oxidation, but also likely that vitamin E hinders cross-linking in UHMWPE during irradiation. Vitamin E concentrations of 0.3 wt % or above are found to be detrimental for wear resistance (see Oral et al. Biomaterials 29: 3557 (2008); Oral et al. Biomaterials 26: 6657 (2005)). Alternatively, more vitamin E could be diffused into vitamin E-blended and irradiated UHMWPEs after irradiation to protect against lipid-initiated oxidation and avoid loss of crosslinking efficiency during the irradiation step.

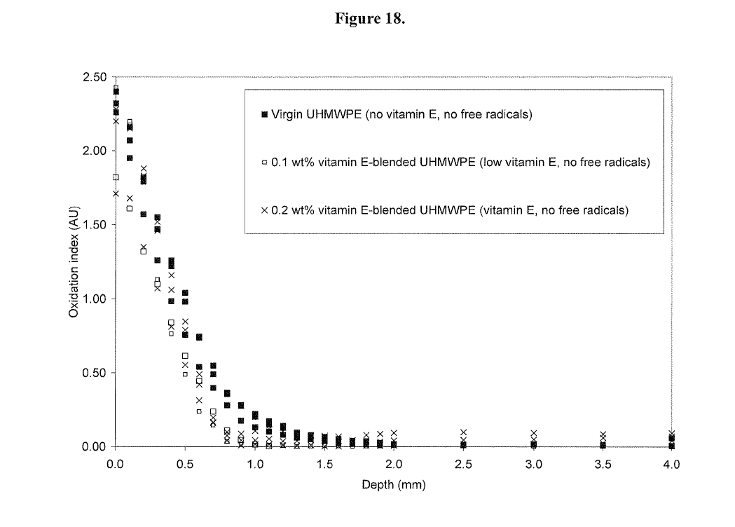

Virgin UHMWPE, 0.1 wt % vitamin E-blended UHMWPE and 0.2 wt % vitamin E-blended UHMWPE all oxidized after squalene doping and accelerated aging (FIG. 18). These UHMWPEs do not contain free radicals and are not susceptible to oxidation in the absence of squalene. Also, the comparison between the stability of 0.1 wt % vitamin E-blended UHMWPE and 0.1 wt % vitamin E blended and subsequently irradiated UHMWPEs (FIG. 15) suggested that warm irradiation itself resulted in protection against lipid-initiated oxidation process. Active vitamin E is likely grafted on polyethylene effectively during warm irradiation or active antioxidant species are produced more effectively during warm irradiation.

### Example 5

### The Effect of Mechanical Deformation and Annealing on the Stability of Vitamin E-Containing UHMWPE Against Lipid-Initiated Oxidation

Vitamin E-blended GUR1020 UHMWPE containing 0.1 wt % vitamin E was heated to 130° C. in a convection oven. Then, it was uniaxially deformed to a compression ratio of 2.5 in between platens pre-heated to 135° C. It was kept under load until the sample cooled under load to about below 100° C. The deformed, cooled sample was placed in a convection oven heated to 135° C. and kept at temperature for at least 5 hours, upon which it recovered about 90% of its original height in the compression direction. Cubes (1 cm) were machined from the 0.1 wt %+150 kGy+mechanically deformed+annealed UHMWPE. These blocks were doped with squalene at 120° C. for 2 hours followed by accelerated aging as described in Example 1.

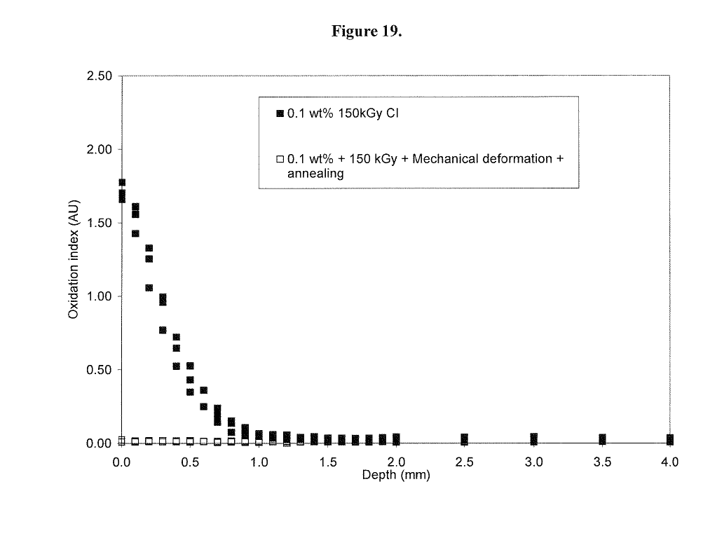

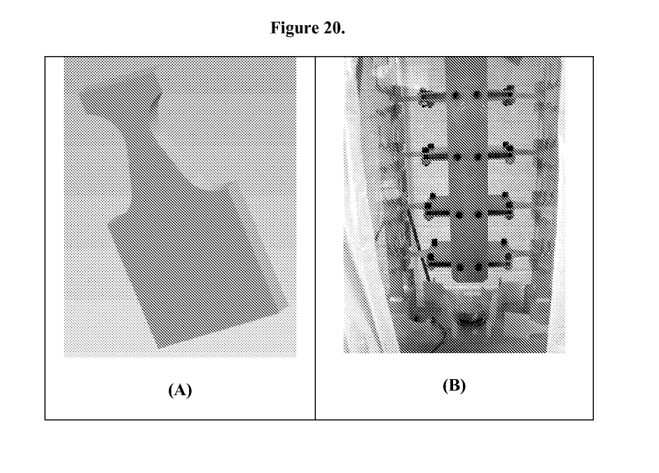

FIG. 19 shows that the 0.1 wt % and 150 kGy irradiated UHMWPE was rendered stable against lipid-initiated oxidation by mechanical deformation and annealing.

### Example 6

### Initiation of Oxidation by Cyclic Deformation and Protection Against Cyclic Deformation-Induced Oxidation by Vitamin E Stabilization

Cyclic deformation samples (FIG. 20a; 6.5 mm thick) were machined from 100-kGy cold irradiated and melted GUR1050 UHMWPE and 95-kGy warm irradiated and melted GUR1050 UHMWPE. The samples were modeled after flexural fatigue samples (Type A) described in ASTM D671. The body (lower half) of the sample was clamped into place, and the head (upper piece) was impinged upon by load applicators due to the upward and downward movement of the actuator (FIG. 20b). The load applicators consisted of rounded edges screwed on a fixture attached to the actuator. The upward stroke of the actuator produced compressive stresses in the upper half of the cross section and tensile stresses in the lower half of the cross section. The stresses alternated for the downward stroke. The flexural sample geometry provided a constant stress (10 MPa) throughout the triangular neck of the specimen.

The sample was centered vertically between the load applicators (FIG. 20b). A distance of 7.0±0.2 mm was maintained between the edges of the load applicators. This provided a clearance of ˜0.25 mm between the top and bottom surfaces of the specimen and the top and bottom load applicator edges, respectively. The testing was done in air in an environmental chamber maintained at 80° C. Load was applied on the post at the apex of the triangular region of constant stress, a distance of 31.8±0.1 mm from the where the base of the specimen was clamped in place. The load was applied as a sinusoidal waveform symmetrical about zero load line. The frequency of the load cycles was 0.5 Hz. The tests were conducted on an MTS (Eden Prairie, Minn.) hydraulic mechanical testing system. The corresponding maximum and minimum loads for the displacement was recorded every 20 minutes. Testing was performed for 5 million cycles. A piece from a control (non-loaded) sample in the same chamber was also removed at that time and analyzed.

The failed samples were analyzed by Fourier Transform Infrared Spectroscopy (FTIR) to quantify the oxidation within the constant stress triangular region. Using a sledge microtome, thin (150 μm) sections were cut from the cross-section of the neck region of the sample. These thin films (n=3 each) first boiled in hexane overnight, cooled under vacuum, then were analyzed using FTIR as a function of depth across the entire specimen thickness. Oxidation levels were quantified as an oxidation index, calculated according to ASTM F2102 by normalizing the carbonyl absorbance over 1680 cm⁻¹-1780 cm⁻¹ to the internal reference absorbance over 1370 cm⁻¹-1390 cm⁻¹.

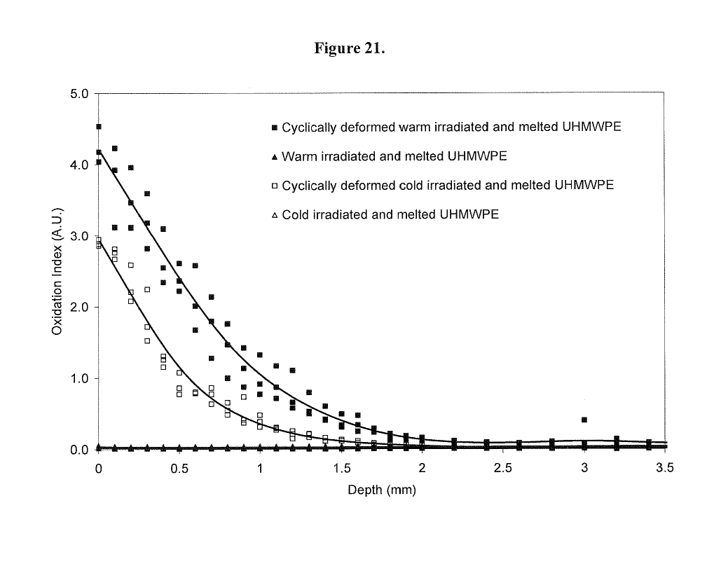

FIG. 21 shows the oxidation profiles of failed warm irradiated/melted and cold irradiated/melted samples tested under cyclic deformation for 5 million cycles. It is clear that irradiated/melted UHMWPE controls, which were accelerated aged in the chamber at 80° C. did not oxidize. In contrast, irradiated/melted UHMWPEs subjected to cyclic deformation in the same chamber at 80° C. oxidized heavily.

Three types of vitamin E containing UHMWPEs were tested in the same setup: (1) 0.1 wt % vitamin E-blended and 150 kGy cold irradiated UHMWPE, (2) 0.1 wt % vitamin E-blended and 150 kGy warm irradiated UHMWPE and (3) 100-kGy irradiated, vitamin E-diffused (˜1 wt %), gamma sterilized UHMWPE.

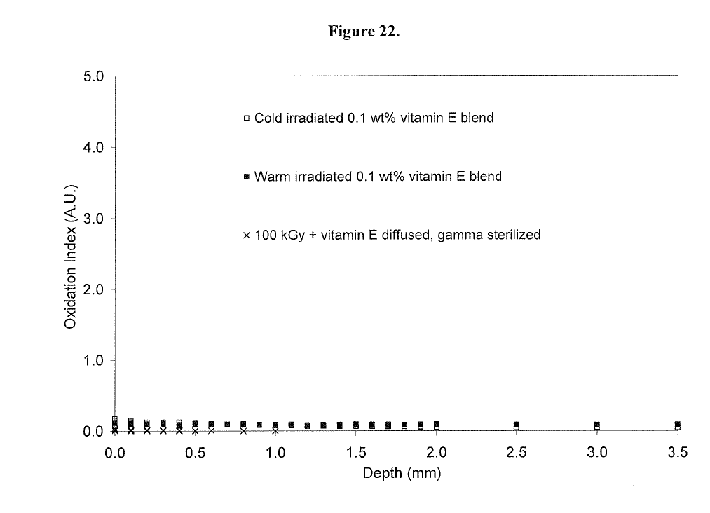

FIG. 22 shows that there was no oxidation in vitamin E-containing UHMWPEs after cyclic deformation for 5 million cycles. Control (non-deformed) samples aged in the same chamber showed similar profiles, they were not shown on the same graph to avoid crowding of the data. This suggested that cold and warm irradiation of vitamin E blends as well as diffusion of vitamin E into irradiated UHMWPE protected against deformation-induced oxidation.

### Example 7

### Wear Rates of Some Blended and Irradiated UHMWPEs

UHMWPE blended with 0.3 wt % vitamin E was cold irradiated (at room temperature) to 150 kGy. Also, UHMWPE blended with 0.2 wt % vitamin E was irradiated to 150 kGy by warm irradiation (preheated to 120° C. and e-beam irradiated).

Cylindrical pins (9 mm diameter, 13 mm length) were machined from the above materials (n=2). They were tested on a bidirectional pin-on-disc wear tester (Bragdon et al. Journal of Arthroplasty 16(5):658-665 (2001)) in undiluted bovine serum for approximately 1.1 million cycles with gravimetric wear measurements at approximately every 160,000 cycles after the first 500,000 cycles. The wear rate was determined by the linear regression of gravimetric wear as a function of the number of cycles from 500,000 cycles to the end of the test.

The wear rate of 0.3 wt % vitamin E-blended and 150 kGy cold irradiated samples was −3.5 mg/million-cycle (MC), and the wear rate of the 0.2 wt % vitamin E-blended and 150 kGy warm irradiated samples was −1.8 mg/MC. These results showed that decreased cross-link density due to increasing concentration of vitamin E during irradiation increased the wear rate substantially.

### Example 8

### The Comparative Stability of Antioxidant-Stabilized UHMWPEs when Challenged with Different Amounts of Squalene

Medical grade GUR1020 UHMWPE resin powder was blended with the antioxidant vitamin E to form a 0.1 wt % vitamin E blend of UHMWPE. The blend was consolidated into blocks and radiation crosslinked by irradiating at 120 kGy. Cubes (1 cm×1 cm×1 cm) were machined from this irradiated blend.

Medical grade GUR1050 UHMWPE was consolidated into blocks and was radiation crosslinked by irradiating at 100 kGy. Vitamin E was incorporated into the preforms machined from the irradiated blocks by diffusion at high temperature below the melting point of UHMWPE followed by homogenization in inert gas at high temperature below the melting point of UHMWPE. The final concentration of the vitamin E in the parts was approximately 0.7 wt %. The parts were terminally gamma sterilized in vacuum. Then they were machined into cubes (1 cm×1 cm×1 cm).

Cubes of blended and diffused UHMWPEs were doped with squalene at 120° C. for 2 hours and 140 hours, resulting in approximately 25 (low) and 135 mg (high) of squalene uptake, respectively. Following doping, the samples (n=3 each for each time point) were accelerated aged at 70° C. at 5 atm. of oxygen for up to 44 days.

After accelerated aging, the cubes were cut in half and the inner surface was microtomed into 150 μm-thick sections. These thin sections were boiled in hexane overnight and subsequently dried in vacuum. By using Fourier Transform Infrared Spectroscopy (FTIR) equipped with a microscope, the thin sections were analyzed as a function of depth from the surface. An oxidation index was calculated by taking the ratio of the area under the carbonyl absorbance at 1700 cm⁻¹ normalized to the methylene absorbance at 1370 cm⁻¹.

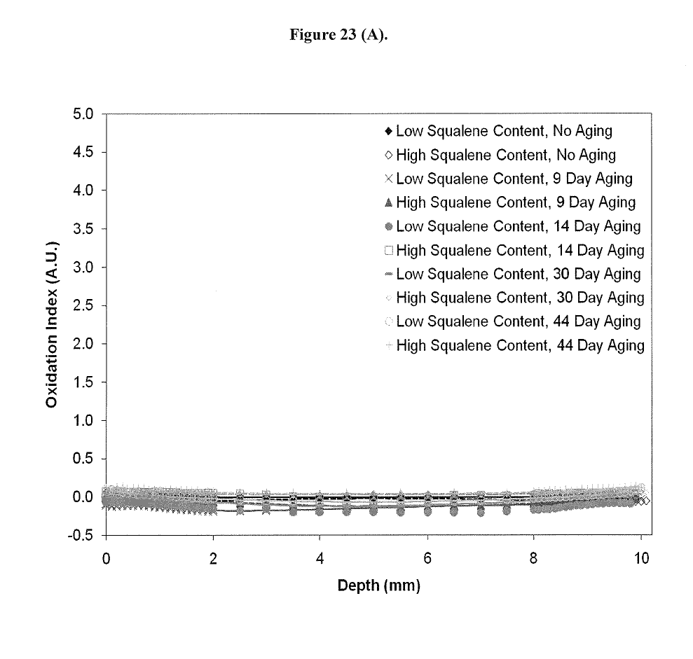

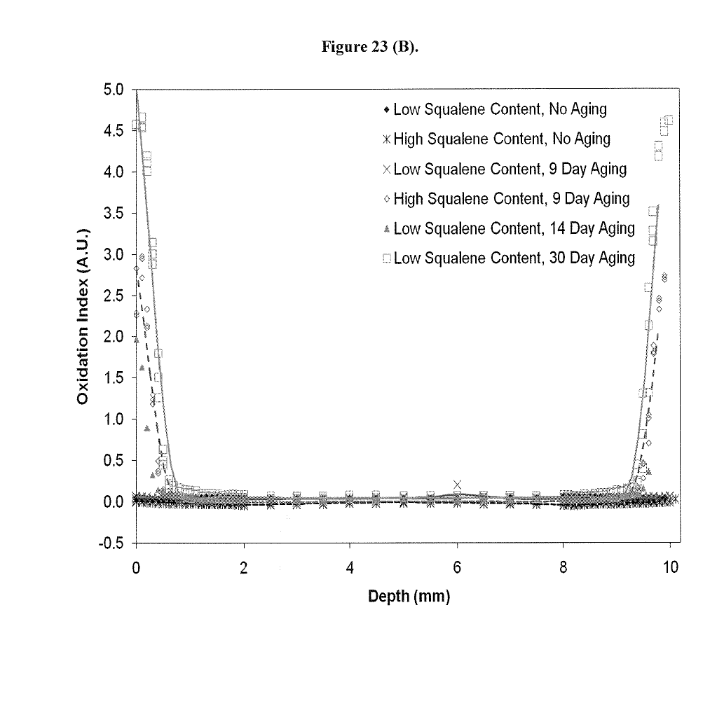

The irradiated and vitamin E diffused UHMWPE did not show increased oxidation compared to non-aged samples either at low or high squalene content even at 44 days of accelerated aging under high oxygen pressure (FIG. 23A). In contrast, 0.1 wt % vitamin E blended and 120-kGy irradiated UHMWPE started oxidizing at 9 days of aging under high squalene content challenge and at 14 days of aging under low squalene content challenge (FIG. 23B).

It is to be understood that the description, specific examples and data, while indicating exemplary embodiments, are given by way of illustration and are not intended to limit the present invention. Various changes and modifications within the present invention will become apparent to the skilled artisan from the discussion, disclosure and data contained herein, and thus are considered part of the invention.

1. A method of preventing lipid-initiated oxidation of polymeric material by providing an oxidation and wear resistant polymeric material, wherein the polymeric material is made by a process comprising the steps of:
a) blending a polymeric material with one or more antioxidants;
b) consolidating the polymeric blend;
c) heating the consolidated polymeric blend to an elevated temperature that is above the room temperature and below the melting point of the polymeric material; and
d) irradiating the heated consolidated polymeric blend with ionizing radiation at an elevated temperature that is below the melting point of the polymeric material, thereby providing an oxidation and wear resistant polymeric material that can resist lipid-initiated oxidation.

2. (canceled)

3. (canceled)

4. (canceled)

5. A method of preventing lipid-initiated oxidation of polymeric material by providing an oxidation and wear resistant polymeric material, wherein the polymeric material is made by a process comprising the steps of:
a) irradiating a consolidated blend of polymeric materials containing one or more antioxidants by ionizing radiation at an elevated temperature that is above the room temperature and below the melting point of the polymeric material;
b) heating a consolidated polymeric blend containing one or more antioxidants to an elevated temperature that is above the room temperature and below the melting point of the polymeric material; and
c) annealing the heated consolidated polymeric blend at an elevated temperature that is below the melting point of the polymeric material, thereby providing an oxidation and wear resistant polymeric material that can resist lipid-initiated oxidation.

6. (canceled)

7. (canceled)

8. (canceled)

9. A method of preventing oxidation initiated by cyclic deformation of polymeric material by providing an oxidation and wear resistant polymeric material, wherein the polymeric material is made by a process comprising the steps of:
a) blending a polymeric material with an antioxidant;
b) consolidating the polymeric blend;
c) heating the consolidated polymeric blend to an elevated temperature that is above the room temperature and below the melting point of the polymeric material; and
d) irradiating the heated consolidated polymeric blend with ionizing radiation at an elevated temperature that is below the melting point of the polymeric material, thereby providing an oxidation and wear resistant polymeric material that can resist oxidation due to, caused by, induced by or initiated by cyclic deformation of the polymeric material.

10. (canceled)

11. (canceled)

12. A method of preventing oxidation initiated by cyclic deformation of polymeric material by providing an oxidation and wear resistant polymeric material, wherein the polymeric material is made by a process comprising the steps of:
a) irradiating a consolidated blend of polymeric materials containing one or more antioxidants by ionizing radiation at an elevated temperature that is above the room temperature and below the melting point of the polymeric material;
b) heating a consolidated polymeric blend containing one or more antioxidants to an elevated temperature that is above the room temperature and below the melting point of the polymeric material; and
c) annealing the heated consolidated polymeric blend at an elevated temperature that is below the melting point of the polymeric material, thereby providing an oxidation and wear resistant polymeric material that can resist oxidation due to, caused by, induced by or initiated by cyclic deformation of the polymeric material.

13. (canceled)

14. (canceled)

15. (canceled)

16. (canceled)

17. (canceled)

18. The method according to claim 1, wherein the heating is continued for at least for one minute, 10 minutes, 20 minutes, 30 minutes, one hour, two hours, five hours, ten hours, 24 hours, or more.

19. The method according to claim 1, wherein the heating is carried out in an inert environment.

20. The method according to claim 1, wherein the consolidated polymeric blend is heated to a temperature between about 20° C. and about 135° C. before or after irradiation.

21. The method according to claim 1, wherein the polymeric material is compression molded to a second surface, thereby making an interlocked hybrid material.

22. (canceled)

23. The method according to claim 1, wherein one of the antioxidants is vitamin E.

24. The method according to claim 1, wherein the one of the antioxidants is α-tocopherol.

25. (canceled)

26. The method according to claim 1, wherein the polymeric material is selected from a group consisting of a low-density polyethylene, high-density polyethylene, linear low-density polyethylene, ultra-high molecular weight polyethylene (UHMWPE), or a mixture thereof.

27. The method according to claim 1, wherein the polymeric material is polymeric resin powder, polymeric flakes, polymeric particles, or the like, or a mixture thereof.

28. The method according to claim 1, wherein the irradiation is carried out in an atmosphere containing between about 1% and about 22% oxygen.

29. The method according to claim 1, wherein the irradiation is carried out in an inert atmosphere, and wherein the atmosphere contains gases selected from the group consisting of nitrogen, argon, helium, neon, or the like, and a combination thereof.

30. The method according to claim 1, wherein the radiation dose is between about 25 and about 1000 kGy.

31. (canceled)

32. The method according to claim 1, wherein the polymeric material is cross-linked by gamma irradiation or electron beam irradiation.

33. (canceled)

34. The method according to claim 1, wherein the polymeric blend is radiated at a temperature between about 20° C. and about 135° C.

35. The method according to claim 1, wherein free radicals in the cross-linked polymeric material is reduced by heating the polymeric material in contact with a non-oxidizing medium.

36. The method according to claim 35, wherein the non-oxidizing medium is an inert gas.

37. The method according to claim 35, wherein the non-oxidizing medium is an inert fluid.

38. (canceled)

39. (canceled)

40. The method according to claim 1, wherein the oxidation index of the oxidation resistant polymeric material is less than 0.1 after doping with squalene at 120° C. for 2 hours, then subsequently accelerated aging at 5 atm of oxygen at 70° C. for 6 days and then extracting 150 micro-thick sections of the material by boiling hexane for at least 16 hours.

41. (canceled)

42. A medical device comprising an oxidation and wear resistant polymeric material made according to claim 1, wherein the polymeric material is not susceptible to lipid-initiated oxidation.

43. (canceled)

44. The medical device of claim 42 wherein the medical device is selected from the group consisting of acetabular liner, shoulder glenoid, patellar component, finger joint component, ankle joint component, elbow joint component, wrist joint component, toe joint component, bipolar hip replacements, tibial knee insert, tibial knee inserts with reinforcing metallic and polymeric posts, intervertebral discs, interpositional devices for any joint, sutures, tendons, heart valves, stents, and vascular grafts.

45. The medical device of claim 42 wherein the medical device is a non-permanent medical device, wherein the non-permanent medical device is selected from the group consisting of a catheter, a balloon catheter, a tubing, an intravenous tubing, and a suture.

46. The medical device of claim 42 wherein the medical device is packaged and sterilized by ionizing radiation or gas sterilization, thereby forming a sterile, highly cross-linked, oxidatively stable, and highly crystalline medical device.

47. The method according to claim 5, wherein the heating is continued for at least for one minute, 10 minutes, 20 minutes, 30 minutes, one hour, two hours, five hours, ten hours, 24 hours, or more.

48. The method according to claim 5, wherein the heating is carried out in an inert environment.

49. The method according to claim 5, wherein the consolidated polymeric blend is heated to a temperature between about 20° C. and about 135° C. before or after irradiation.

50. The method according to claim 5, wherein the polymeric material is compression molded to a second surface, thereby making an interlocked hybrid material.

51. The method according to claim 5, wherein one of the antioxidants is vitamin E.

52. The method according to claim 5, wherein the one of the antioxidants is α-tocopherol.

53. The method according to claim 5, wherein the polymeric material is selected from a group consisting of a low-density polyethylene, high-density polyethylene, linear low-density polyethylene, ultra-high molecular weight polyethylene (UHMWPE), or a mixture thereof.

54. The method according to claim 5, wherein the polymeric material is polymeric resin powder, polymeric flakes, polymeric particles, or the like, or a mixture thereof.

55. The method according to claim 5, wherein the irradiation is carried out in an atmosphere containing between about 1% and about 22% oxygen.

56. The method according to claim 5, wherein the irradiation is carried out in an inert atmosphere, and wherein the atmosphere contains gases selected from the group consisting of nitrogen, argon, helium, neon, or the like, and a combination thereof.

57. The method according to claim 5, wherein the radiation dose is between about 25 and about 1000 kGy.

58. The method according to claim 5, wherein the polymeric material is cross-linked by gamma irradiation or electron beam irradiation.

59. The method according to claim 5, wherein the polymeric blend is radiated at a temperature between about 20° C. and about 135° C.

60. The method according to claim 5, wherein free radicals in the cross-linked polymeric material is reduced by heating the polymeric material in contact with a non-oxidizing medium.

61. The method according to claim 60, wherein the non-oxidizing medium is an inert gas.

62. The method according to claim 60, wherein the non-oxidizing medium is an inert fluid.

63. The method according to claim 5, wherein the oxidation index of the oxidation resistant polymeric material is less than 0.1 after doping with squalene at 120° C. for 2 hours, then subsequently accelerated aging at 5 atm of oxygen at 70° C. for 6 days and then extracting 150 micro-thick sections of the material by boiling hexane for at least 16 hours.

64. A medical device comprising an oxidation and wear resistant polymeric material made according to claim 5, wherein the polymeric material is not susceptible to lipid-initiated oxidation.

65. The medical device of claim 64 wherein the medical device is selected from the group consisting of acetabular liner, shoulder glenoid, patellar component, finger joint component, ankle joint component, elbow joint component, wrist joint component, toe joint component, bipolar hip replacements, tibial knee insert, tibial knee inserts with reinforcing metallic and polymeric posts, intervertebral discs, interpositional devices for any joint, sutures, tendons, heart valves, stents, and vascular grafts.

66. The medical device of claim 64 wherein the medical device is a non-permanent medical device, wherein the non-permanent medical device is selected from the group consisting of a catheter, a balloon catheter, a tubing, an intravenous tubing, and a suture.

67. The medical device of claim 64 wherein the medical device is packaged and sterilized by ionizing radiation or gas sterilization, thereby forming a sterile, highly cross-linked, oxidatively stable, and highly crystalline medical device.

68. The method according to claim 9, wherein the heating is continued for at least for one minute, 10 minutes, 20 minutes, 30 minutes, one hour, two hours, five hours, ten hours, 24 hours, or more.

69. The method according to claim 9, wherein the heating is carried out in an inert environment.

70. The method according to claim 9, wherein the consolidated polymeric blend is heated to a temperature between about 20° C. and about 135° C. before or after irradiation.

71. The method according to claim 9, wherein the polymeric material is compression molded to a second surface, thereby making an interlocked hybrid material.

72. The method according to claim 9, wherein one of the antioxidants is vitamin E.

73. The method according to claim 9, wherein the one of the antioxidants is α-tocopherol.

74. The method according to claim 9, wherein the polymeric material is selected from a group consisting of a low-density polyethylene, high-density polyethylene, linear low-density polyethylene, ultra-high molecular weight polyethylene (UHMWPE), or a mixture thereof.

75. The method according to claim 9, wherein the polymeric material is polymeric resin powder, polymeric flakes, polymeric particles, or the like, or a mixture thereof.

76. The method according to claim 9, wherein the irradiation is carried out in an atmosphere containing between about 1% and about 22% oxygen.

77. The method according to claim 9, wherein the irradiation is carried out in an inert atmosphere, and wherein the atmosphere contains gases selected from the group consisting of nitrogen, argon, helium, neon, or the like, and a combination thereof.

78. The method according to claim 9, wherein the radiation dose is between about 25 and about 1000 kGy.

79. The method according to claim 9, wherein the polymeric material is cross-linked by gamma irradiation or electron beam irradiation.

80. The method according to claim 9, wherein the polymeric blend is radiated at a temperature between about 20° C. and about 135° C.

81. The method according to claim 9, wherein free radicals in the cross-linked polymeric material is reduced by heating the polymeric material in contact with a non-oxidizing medium.

82. The method according to claim 81, wherein the non-oxidizing medium is an inert gas.

83. The method according to claim 81, wherein the non-oxidizing medium is an inert fluid.

84. The method according to claim 9, wherein the oxidation index of the oxidation resistant polymeric material is less than 0.1 after doping with squalene at 120° C. for 2 hours, then subsequently accelerated aging at 5 atm of oxygen at 70° C. for 6 days and then extracting 150 micro-thick sections of the material by boiling hexane for at least 16 hours.

85. A medical device comprising an oxidation and wear resistant polymeric material made according to claim 9, wherein the polymeric material is not susceptible to oxidation due to, caused by, induced by or initiated by cyclic deformation of the polymeric material.

86. The medical device of claim 85 wherein the medical device is selected from the group consisting of acetabular liner, shoulder glenoid, patellar component, finger joint component, ankle joint component, elbow joint component, wrist joint component, toe joint component, bipolar hip replacements, tibial knee insert, tibial knee inserts with reinforcing metallic and polymeric posts, intervertebral discs, interpositional devices for any joint, sutures, tendons, heart valves, stents, and vascular grafts.

87. The medical device of claim 85 wherein the medical device is a non-permanent medical device, wherein the non-permanent medical device is selected from the group consisting of a catheter, a balloon catheter, a tubing, an intravenous tubing, and a suture.

88. The medical device of claim 85 wherein the medical device is packaged and sterilized by ionizing radiation or gas sterilization, thereby forming a sterile, highly cross-linked, oxidatively stable, and highly crystalline medical device.

89. The method according to claim 12, wherein the heating is continued for at least for one minute, 10 minutes, 20 minutes, 30 minutes, one hour, two hours, five hours, ten hours, 24 hours, or more.

90. The method according to claim 12, wherein the heating is carried out in an inert environment.

91. The method according to claim 12, wherein the consolidated polymeric blend is heated to a temperature between about 20° C. and about 135° C. before or after irradiation.

92. The method according to claim 12, wherein the polymeric material is compression molded to a second surface, thereby making an interlocked hybrid material.

93. The method according to claim 12, wherein one of the antioxidants is vitamin E.

94. The method according to claim 12, wherein the one of the antioxidants is α-tocopherol.

95. The method according to claim 12, wherein the polymeric material is selected from a group consisting of a low-density polyethylene, high-density polyethylene, linear low-density polyethylene, ultra-high molecular weight polyethylene (UHMWPE), or a mixture thereof.

96. The method according to claim 12, wherein the polymeric material is polymeric resin powder, polymeric flakes, polymeric particles, or the like, or a mixture thereof.

97. The method according to claim 12, wherein the irradiation is carried out in an atmosphere containing between about 1% and about 22% oxygen.

98. The method according to claim 12, wherein the irradiation is carried out in an inert atmosphere, and wherein the atmosphere contains gases selected from the group consisting of nitrogen, argon, helium, neon, or the like, and a combination thereof.

99. The method according to claim 12, wherein the radiation dose is between about 25 and about 1000 kGy.

100. The method according to claim 12, wherein the polymeric material is cross-linked by gamma irradiation or electron beam irradiation.

101. The method according to claim 12, wherein the polymeric blend is radiated at a temperature between about 20° C. and about 135° C.

102. The method according to claim 12, wherein free radicals in the cross-linked polymeric material is reduced by heating the polymeric material in contact with a non-oxidizing medium.

103. The method according to claim 102, wherein the non-oxidizing medium is an inert gas.

104. The method according to claim 102, wherein the non-oxidizing medium is an inert fluid.

105. The method according to claim 12, wherein the oxidation index of the oxidation resistant polymeric material is less than 0.1 after doping with squalene at 120° C. for 2 hours, then subsequently accelerated aging at 5 atm of oxygen at 70° C. for 6 days and then extracting 150 micro-thick sections of the material by boiling hexane for at least 16 hours.

106. A medical device comprising an oxidation and wear resistant polymeric material made according to claim 12, wherein the polymeric material is not susceptible to oxidation due to, caused by, induced by or initiated by cyclic deformation of the polymeric material.

107. The medical device of claim 106 wherein the medical device is selected from the group consisting of acetabular liner, shoulder glenoid, patellar component, finger joint component, ankle joint component, elbow joint component, wrist joint component, toe joint component, bipolar hip replacements, tibial knee insert, tibial knee inserts with reinforcing metallic and polymeric posts, intervertebral discs, interpositional devices for any joint, sutures, tendons, heart valves, stents, and vascular grafts.

108. The medical device of claim 106 wherein the medical device is a non-permanent medical device, wherein the non-permanent medical device is selected from the group consisting of a catheter, a balloon catheter, a tubing, an intravenous tubing, and a suture.

109. The medical device of claim 106 wherein the medical device is packaged and sterilized by ionizing radiation or gas sterilization, thereby forming a sterile, highly cross-linked, oxidatively stable, and highly crystalline medical device.
